(19) United States
(12) Patent Application Publication
(10) Pub. No.: US 2003/0074342 A1
(43) Pub. Date: Apr. 17, 2003

(54) Customer information management infrastructure and methods

(76) Inventor: Donald S. Curtis, Matthews, NC (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 10/079,017

(22) Filed: Feb. 21, 2002

Related U.S. Application Data
(60) Provisional application No. 60/328,095, filed on Oct. 11, 2001.

(51) Int. Cl. G06F 7/00

(52) U.S. Cl. 707/1

(57) ABSTRACT

A customer information management infrastructure comprising an integrated customer information store having a multiplicity of customer information sets, each corresponding to one of a multiplicity of customers. Responsive to each of a multiplicity of substantially simultaneous service requests, each pertaining to a selected customer, the customer information set corresponding to the selected customer determines a set of interactions between a user and the infrastructure, and a set of interactions among components of the infrastructure. The infrastructure provides a large enterprise, such as a retail bank, with the ability to handle a large number of substantially simultaneous service requests from each of a large number of customers, and to base, for example, the availability of service requests to each customer, the presentation of available service requests to each customer, and the steps used to carry out each service request selected by each customer, on a large amount of information about that particular customer.

### CROSS REFERENCE TO RELATED APPLICATIONS

This application claims priority under 35 U.S.C. §119(e) to U.S. Provisional Application No. 60/328,095, filed Oct. 11, 2001, the entirety of which is incorporated into this specification by reference.

### FIELD OF THE INVENTION

The present invention relates generally to systems and methods for managing customer information. More particularly, the present invention relates to enterprise-wide real-time management and use of customer information by large-scale businesses.

### RELATED ART

Many companies possess large volumes of information about their customers. Large companies, such as large banks and other financial services institutions, obtain information from and about their customers in a variety of different contexts, such as checking and savings account transactions, mortgage account transactions, credit card account transactions, commercial and consumer loan transactions, and investment transactions. Customer information may be obtained through a variety of business channels, including but not limited to in-person meetings, telephone conversations, written forms, and interactions with automated kiosks, automatic teller machines and Internet or intranet websites. Customer information is also typically obtained by a large business in a variety of formats. It is not uncommon, for example, for a large business to maintain several customer information databases, each with its own data storage and input formats.

Many large-scale enterprises find it virtually impossible to access and use the information that they possess about their customers in a timely and consistent manner across all product lines, all business channels, all user interfaces, and all points of contact with each customer. Consequently, such enterprises typically cannot effectively leverage their customer information on behalf of their customers and themselves.

A primary reason companies cannot access and use their customer information in a timely manner is that most of the customer information that companies maintain is widely distributed among disparate business units and disparate application infrastructure environments. In addition, information about customers is all too often stored separately within separate business units and maintained through separate and sometimes incompatible customer information management processes. In a bank, for example, information about customers may be stored separately in different systems used for direct demand accounts (i.e., checking accounts), time demand accounts (i.e., savings accounts), credit card accounts, investment accounts and mortgage accounts, to name a few.

Different devices, such as automatic or automated teller machines (ATMs), specialized teller terminals, personal computer interfaces and telephones, may be used to access information in different systems. Frequently, these systems and their corresponding devices and infrastructures were developed separately as the needs of particular services or product lines grew. Such systems and devices are conventionally referred to as “legacy” systems and devices, in part because they reflect previously developed systems and devices which are frequently difficult to integrate with each other, let alone to replace with new systems or devices. It should be noted that in some contexts, such as when one company with legacy systems acquires another company with its own separate legacy systems, the combined enterprise may end up using more than one legacy system to track transactions for a single product or service, such as a single checking account.

In addition, different legacy systems often contain different information about the same customer because the legacy systems typically have been developed for separate lines of businesses or services. For instance, one legacy system of a bank may be the “official” system or “system of record” for checking transactions, and store a particular address for a customer. Another system of the bank may be the “system of record” for credit card transactions, storing a different address for the same customer of the same bank, but for a different kind of transactions.

Wide distribution of customer information across various systems in large companies often frustrates the customer relationship management objectives of those companies as they attempt to provide personalized products and services to customers and respond to customer requests in a timely manner. Without the ability to retrieve knowledge of customer relationships, profiles and preferences in a timely manner, it can be very difficult for a company to offer the best products, services, advice or counseling during each customer interaction. These difficulties can result in low customer satisfaction, lost opportunities to “cross-sell” products and services, and potentially the loss of the customer's business.

The fragmented nature of systems and data environments for customer information makes retrieving a comprehensive view of customer information difficult. There are at least three reasons for this difficulty: 1) there is no comprehensive customer identification program employed across all of the legacy systems; 2) the legacy systems do not store information attributes for all customers across all systems; and 3) the data integrity for the customer records within each of the legacy systems cannot be verified across and between each of the systems.

Accordingly, there is a need for a customer information management infrastructure that can be shared by a wide variety of geographically dispersed users, and a wide variety of legacy systems existing throughout a large enterprise. There is a further need for an infrastructure that can provide and support consistent information about each of a large number of customers in a timely manner, preferably in real-time, across multiple product lines, multiple business channels, and multiple user interfaces.

### SUMMARY OF THE INVENTION

The present invention provides a customer information management infrastructure (CIMI or infrastructure), in which a customer information store is configured as a service of the infrastructure, not as a separate application as it is typically configured in conventional infrastructures. In embodiments of the present invention, the infrastructure includes several logical layers, including a logical legacy system layer; a logical appserver layer; a logical device server layer; and a device layer; where the legacy system layer includes an integrated customer information store (ICIS), and the appserver layer comprises components for reading, updating, creating and deleting (RUCD) records in the ICIS. The ICIS may include any number of items of information about each customer, including for example personal information such as name and date of birth; demographic information such as addresses, income levels and education; financial information including account balances and assets and liabilities; preferences on how the customer desires to interact with various devices used to communicate with the infrastructure; historical information on the customer's interactions with the enterprise and its infrastructure; predictive information on how the customer is expected to interact with the enterprise and infrastructure in the future; and relationship information on the relationships between the customer and other customers, and between the customer and officers or employees of the enterprise operating the infrastructure.

In one embodiment of the present invention, a customer information system is provided comprising a logical legacy system layer, containing a plurality of legacy systems, including an integrated customer information store; a logical appserver layer which controls the execution of a request for a legacy system transaction; and a logical device server layer configured to receive the request and process it in order to facilitate control by the appserver layer of the execution of the requested legacy system transaction.

For purposes of this specification, the term “appserver” refers to a software program (or suite of software programs) that provides access to one or more application programs. The term “appserver” is to be distinguished from the phrase “application server,” which, in this specification, refers to an arrangement of physical and electronic components (such as a computer system) where the appserver is installed. Under these definitions, for example, Websphere™ (available from International Business Machines Corporation of Armonk, N.Y.), Weblogic™ (available from BEA Systems, Inc., of San Jose, Calif.), and Net (available from Microsoft Corporation of Redmond, Wash.), are all examples of appservers. The term “logical appserver layer” refers to the logical layer in a CIMI infrastructure where the appserver and application server(s) are located.

In one embodiment of the present invention, the CIMI comprises a centralized integrated customer information store that contains a large number of customer information sets (potentially greater than approximately 50,000,000), each of which corresponds to a particular customer and contains information about that customer. In embodiments of the invention, the customer information store is configured as a legacy system of the infrastructure.

The infrastructure of the present invention utilizes a customer information set corresponding to a customer when it receives service requests pertaining to the customer in order to determine 1) a set of user-device interactions between a user and the infrastructure, and 2) a set of infrastructure-component interactions among the components of the infrastructure. Thus, the set of user-device interactions and the set of infrastructure-component interactions are determined—at least to some degree if not exclusively—by the contents of the customer information set for the customer that is the subject of the service request. The user-device interactions and infrastructure-component interactions applicable to any given service request may also depend upon which of the interface channels of the infrastructure carried the service request. In embodiments, the infrastructure is configured to receive a large number of substantially simultaneous service requests (potentially more than approximately 500 per second), each service request pertaining to one of the large number of customers. As used in this specification, the meaning of the term “substantially simultaneous” depends on the context and the nature of the enterprise operating the infrastructure and the expectations of its customers. For example, in some contexts, substantially simultaneous could encompass ten or even fewer transactions per second.

In another embodiment of the present invention, the infrastructure comprises an authentication-and-authorization-entitlement service, which specifies the set of service requests available to any given user.

In another embodiment of the present invention, the infrastructure comprises a services index, which stores information related to legacy-system function calls. A legacy-system function call, comprised of one or more infrastructure-component interactions, may be required to execute a service request.

In another embodiment, the infrastructure comprises a business workflow service, which determines, together with the customer information set for the customer that is the subject of a service request, the infrastructure-component interactions required to execute the service request. The business-workflow service may also orchestrate the execution of the legacy-system function calls that may be required to execute a service request.

In another embodiment, the infrastructure comprises an interaction-monitor service, which monitors the execution of infrastructure-component interactions. The interaction-monitor service also may direct the reversal of a sequence of transactions in a set of infrastructure-component interactions when a failure of one of the interactions in the sequence is detected.

In another embodiment, the infrastructure comprises a system-management service, which directs the execution of infrastructure-component interactions.

In another embodiment of the present invention, the CIMI comprises a customer information store that has a large number of customer information sets, each associated with a customer; a plurality of interface channels; and a business-workflow service. The business-workflow service receives service-requests made using one of the workflow channels. Each of the service requests is associated with a particular customer. The business-workflow service creates a distinct workflow instance in response to the service request. The workflow instance comprises a sequence of interactions with the legacy systems of the infrastructure, and is based on the customer information set associated with the particular customer.

In another aspect of the present invention, a method is provided for processing a multiplicity of substantially simultaneous service requests, each involving customer information in a customer information management infrastructure having a plurality of logical legacy-system-layer services and an integrated customer information store having a multiplicity of customer information sets corresponding to each of a multiplicity of customers. An embodiment of the method comprises the steps of (1) obtaining a user-identifier from a user; (2) based on the user-identifier, retrieving a set of personal display preferences and generating a list of service requests available to the user; (3) displaying the list of available service requests to the user in a format determined by the set of personal display preferences; (4) accepting from the user a service request selected from the list of available service requests, the selected service request being associated with at least one individual customer from the multiplicity of customers; (5) generating, based on the selected service request and a customer information set associated with the individual customer, a distinctive workflow instance comprising a set of interactions, with at least one of the interactions involving one of the plurality of legacy-system-layer services; and (6) invoking a function call to execute each interaction in the workflow instance involving a logical legacy-system layer service.

This method may optionally include the steps of providing an interaction monitor service that monitors the execution of the set of interactions in the distinctive workflow instance and directing a reversal of all previously-executed transactions in the sequence of interactions if one of the interactions in the set of interactions fails to execute in the absence of a predefined exception condition.

For exemplary purposes only, in this specification, a large bank is utilized as an example of an organization with legacy systems and devices, a large number of customers, and multiple and diverse lines of business, products and services. However, the present invention finds applicability to enterprises, both in the financial services industry and in a wide variety of other industries, with similar characteristics and needs relative to information about customers, users, vendors or other individuals, enterprises or parties but that otherwise may be different from a bank or financial institution. Therefore, the use of a large bank and of customers in the specification serve as examples of a type of organization and a relationship (or set of relationships) between an organization and a party that do not limit the scope or applicability of the present invention.

Similarly, the use in this specification of the term “service request” is not meant to limit the types of requests, inquiries, commands, function requests, transaction requests or other interactions that a user may make using or direct to the infrastructure of the present invention. Accordingly, the term “service request” should be understood to encompass any and all such interactions with and services provided and supported by the infrastructure of the present invention.

Features and Advantages of the Present Invention

It is a feature of the present invention that it may be used as a single repository and single resource for customer information in a large company.

An advantage of the present invention is that it provides a way for large companies to leverage their information and knowledge about their customers across a wide range if not virtually all interactions with those customers.

Another advantage of the present invention is that it gives a large company with a large number of customers the ability to retrieve and use information about an individual customer (such as, for example, current accounts, customer profiles, personal preferences, past and pending transactions and services requests, net worth, etc.) in virtually real time from essentially any device in the company's information or transaction management infrastructure, which provides the basis for improved service and better management and analysis of customer information.

Still another advantage of the present invention is that it can provide, in an ICIS functioning as a single repository, information about essentially all the customers of a large company, which can be valuable to the company in developing relationship-based campaigns and strategies. Additional features and advantages of the invention are set forth in part in the description that follows, and in part are apparent from the description, or may be learned by practice of the invention.

### BRIEF DESCRIPTION OF THE FIGURES

The accompanying drawings, which are incorporated in and constitute part of the specification, illustrate examples of conventional information storage and transaction management infrastructures and illustrate examples of embodiments of the present invention. Together with the description, these drawings serve to explain the principles of the present invention. In the drawings, like reference numbers indicate identical or functionally similar elements.

FIG. 1 shows a block diagram of a conventional customer information management infrastructure (CIMI).

FIG. 2 shows a flow diagram illustrating the steps performed in a conventional CIMI when a user attempts to read or update customer information.

FIG. 3 shows a block diagram of a conventional CIMI with a customer relationship management (CRM) package.

FIGS. 4A-4F contain flow diagrams which together illustrate the steps a conventional CRM-based CIMI typically performs in order to read or update customer information.

FIG. 5 is a block diagram illustrating an embodiment of the logical processing layers of a CIMI configured in accordance with the present invention.

FIG. 6 is a block diagram illustrating the relationship between logical, component and structural views of a logical device layer of an embodiment of a CIMI according to the present invention that might be used by a large enterprise, such as a large bank.

FIG. 7 is a block diagram illustrating the relationship between the logical, component and structural views of a logical device-server layer of an embodiment of a CIMI according to the present invention that might be used by a large enterprise, such as a large bank.

FIG. 8 is a block diagram illustrating the relationship between the logical, component and structural views of a logical appserver layer of an embodiment of a CIMI according to the present invention that might be used by a large enterprise, such as a large bank.

FIG. 9 is a block diagram illustrating the relationship between the logical, component and structural views of a logical legacy-system layer of an embodiment of a CIMI according to the present invention that might be used by a large enterprise, such as a large bank.

FIGS. 10A and 10B provide block diagrams illustrating four logical layers of a CIMI according to the present invention, which might be used by an enterprise such as a bank.

FIGS. 10C-10F provide flow and block diagrams illustrating the steps performed by an embodiment of the present invention in order to process a user service request. FIGS. 10C-10F also illustrate the interaction between various components of an embodiment of an infrastructure configured according to the present invention.

FIGS. 10G-10J provide a flow diagram illustrating steps performed by an embodiment of the present invention in order to process a user-intiated service request.

FIG. 11 provides a block diagram of an embodiment of the present invention that includes an interceptor component useful for processing customer data in an environment having both a legacy customer information store and an integrated customer information store.

FIG. 12 is a data flow diagram illustrating steps performed by a CIMI according to an embodiment of the present invention in response to a request to read a customer record.

FIG. 13 is a data flow diagram illustrating the steps performed by a CIMI according to an embodiment of the present invention in response to a request to create, update or delete a customer record.

FIG. 14 depicts an example of a migration table data structure that might be used in an CIMI according to an embodiment of the present invention.

FIG. 15 depicts an example of an embodiment for a retail bank of a logical structure for an ICIS.

FIG. 16 depicts an embodiment of the present invention in which customer information files are distributed among nodes in a network arranged and connected in a ring structure.

FIG. 17 depicts an embodiment of the present investigation of a process for extracting data from disparate legacy systems that possess customer information, and creating a consolidated customer information file under a single customer identifier.

FIGS. 18A and 18B depict exemplary data record structures that could be used to consolidate and migrate customer information to an ICIS configured according to an embodiment of the present invention.

FIG. 19 depicts a block diagram illustrating the physical layout of a CIMI according to an embodiment of the present invention.

FIG. 20 depicts a block diagram illustrating functional components of a CIMI configured according to an embodiment of the present invention, and also illustrates an aspect of the present invention that applies to banking and other contexts.

### DETAILED DESCRIPTION OF THE DRAWINGS

With reference now to the figures, a detailed discussion is presented of conventional customer information and transaction management infrastructures and embodiments of the customer information management infrastructure of the present invention. Notably, the present invention may be implemented using software, hardware or appropriate combinations thereof, and the figures and examples below are not meant to limit the scope of the present invention or its embodiments or equivalents. More specifically, the systems, components, services and interactions of the infrastructure of the present invention may be implemented using software, hardware or appropriate combinations thereof.

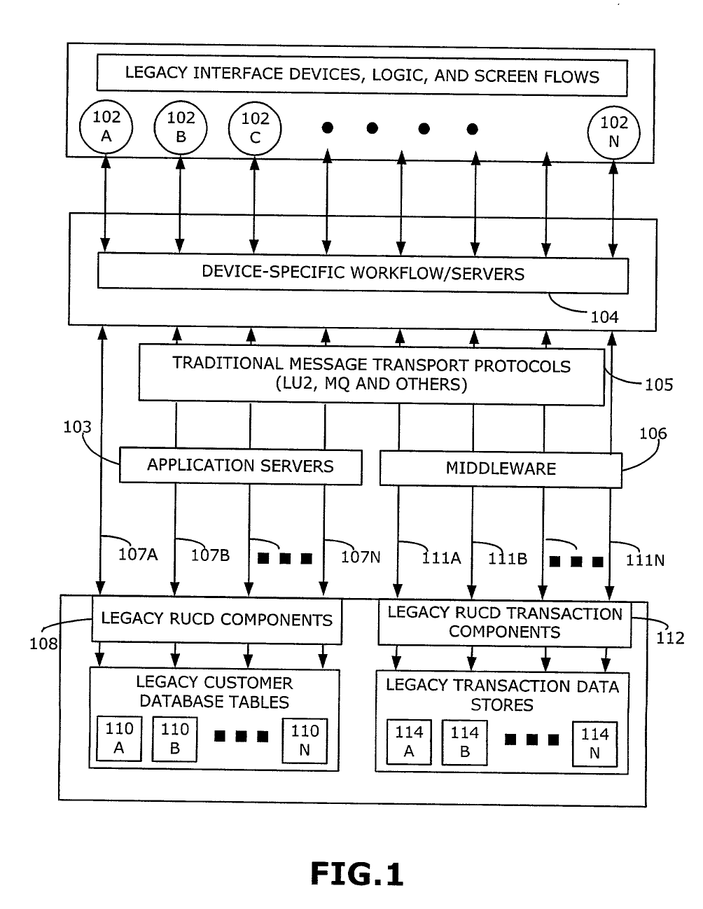

A conventional customer and transaction management infrastructure will first be described in order to assist in illustrating and explaining the aspects and features of the present invention. FIG. 1 shows a block diagram of a conventional customer information and transaction management infrastructure. In conventional infrastructures, Legacy Devices 102A-102N typically include computers, ATM machines, teller machines, telephones and other devices that customers, employees or others might use to interact with a bank. The interactions between users and these devices may be known as user-device interactions, and include such interactions as displaying information or an ATM or computer screen or pressing keys on an ATM, computer or telephone keypad.

Utilizing their individual interfaces (e.g., tones from a touch-tone phone or keystroke signals from a computer), these devices interact with one or more Device Specific Workflow Servers 104. Using traditional message transport protocols, such as LU2 and MQ (indicated in FIG. 1 with reference number 105), Device Workflow Servers 104 send legacy customer information requests to the Legacy Customer Database Tables 110A-110N via Application Servers 103, Links 107A-107N and Legacy RUCD (read/update/create/delete) Components 108. When a Device Specific Workflow Server 104 receives a transaction-related message or request, it sends the message or request to a middleware application (shown in FIG. 1 as Middleware 106), which then forwards it to the Legacy Transaction Data Stores 114A-114N via Links 111A-111N and Legacy RUCD Transaction Components 112.

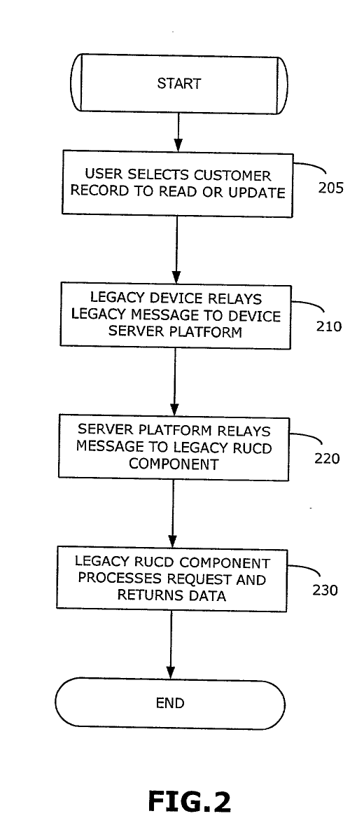

FIG. 2 shows a flow diagram illustrating the steps typically performed in a conventional customer information and transaction management infrastructure when a user attempts to read or update customer data. First, in step 205, the user selects which customer record will be read or updated. Next, in step 210, the legacy device sends a message to a device server platform, which in turn in step 220 sends the message to a legacy RUCD component. In step 230, the legacy RUCD component processes the request and, if necessary, in step 230 returns the requested data. Then processing ends.

Especially for organizations with a number of legacy systems, there are frequently problems with the structure and process depicted in FIGS. 1 and 2. For instance, conventional structures and processes typically require creating and maintaining a large number of user interfaces for customer interactions, including transactions and customer information requests or inquiries, across a variety of device interfaces. Conventional structures and processes also require maintaining a variety of device servers to provide device-specific presentations, even if the same business function is being accomplished by the different devices. Moreover, the application servers are typically configured according to specific device channels, which often limit the ability of the enterprise to provide a consistent approach to business services across different Legacy Interface Devices 102A-102N.

Conventional arrangements also use technical solutions, such as MQ and CORBA, that were designed for asynchronous communications, which may be too slow and inefficient for enterprises engaged in business transactions that require real-time (or synchronized) responses, especially if a larger number of substantially simultaneous responses is required. In a banking or financial services environment, for instance, transactions such as balance inquiries, cash withdrawals, fund transfers, credit card purchases, automatic debits for purchases, and stock purchase or sale transactions, need to be monitored at each stage of processing. Furthermore, these transactions often need to be initiated, approved, executed and confirmed virtually instantaneously. Under these circumstances, asynchronous communication is not likely to provide an effective solution.

Many enterprises recognize that in order to increase customer satisfaction and penetration in their markets, they need to transform their business operations from a product line orientation to one with a customer service focus. They also recognize that, although they already possess the customer information they need to support such a transformation, the customer information they possess may be internally inconsistent and widely dispersed throughout their existing and disparate product-oriented transaction-processing and other systems, which are frequently incompatible with each other.

One solution to these problems is for an enterprise to integrate into its existing infrastructure a single customer information store so that consistent, up-to-date customer information can be obtained. However, the integration of customer information across widely diverse business and application platforms can be extremely challenging, primarily because the legacy information systems, where customer information is housed, were not designed or created with the goal of sharing customer information with other legacy information systems.

Moreover, because many enterprises have invested heavily in legacy systems and devices, they commonly attempt to integrate them by implementing specialized middleware applications to manage the interactions and relationships between customers and users on the one hand, and the legacy systems, on the other hand. These specialized middleware applications are, in the context of customer information processing, commonly known as customer relationship management (CRM) systems.

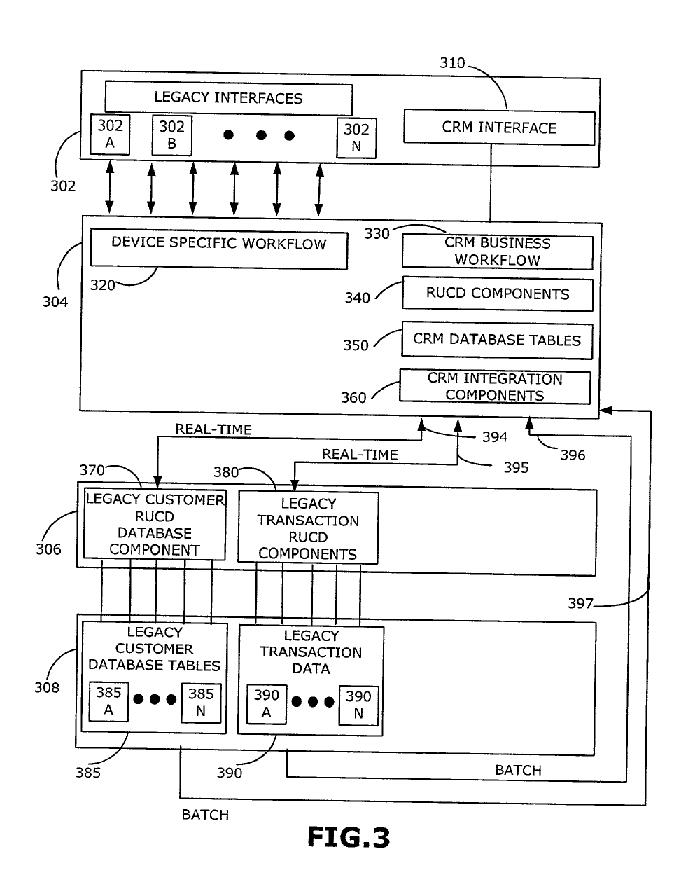

FIG. 3 depicts an example of a CRM-based infrastructure in which the CRM Interface 310 becomes the primary desktop application for reading, updating, creating and deleting customer information. For example, as depicted in FIG. 3, customer information entered on CRM Interface 310 is transferred to legacy customer RUCD Database Component 370 and Legacy Transaction RUCD Components 380 via CRM Business Workflow 330, RUCD Components 340, CRM Database Tables 350 and CRM Integration Components 360.

In the example depicted in FIG. 3, the CRM uses CRM Business Workflow 330, RUCD Components 340, CRM Database Tables 350 and CRM Integration Components 360 to link to disparate customer information distributed throughout the wide variety of legacy systems (represented in FIG. 3 by reference numbers 385A-385N and 390A-390N). Notably, CRM Interface 310 and the components of Logical Device-Server Layer 304 run essentially independently of legacy interfaces 302A-302N and Device-Specific Workflow 320. In many systems having this configuration, the CRM Database Tables 350 are periodically updated with current customer information via real-time or batch processes (indicated in FIG. 3 by reference numbers 394, 395, 396 and 397).

There are, nevertheless, problems associated with using CRMs in the manner depicted in FIG. 3. In conventional CRM systems, CRM Integration Components 360 are accessed every time a transaction using the CRM system is processed. While this requirement may be acceptable for companies processing data for up to thousands of customers at up to hundreds of transactions per second, it is not acceptable for large corporations, such as large banks. In some instances, for example, large banks require database management systems that can store and process detailed information for tens of millions of customers at rates of at least hundreds of inquiries or requests per second, and often exceeding 10,000 inquiries or requests per second. Thus, in large corporations with large data processing requirements, a CRM system such as the one depicted in FIG. 3 can become a major processing bottleneck when used for a large volume of data or for rapid and continuous read, update, create or delete operations.

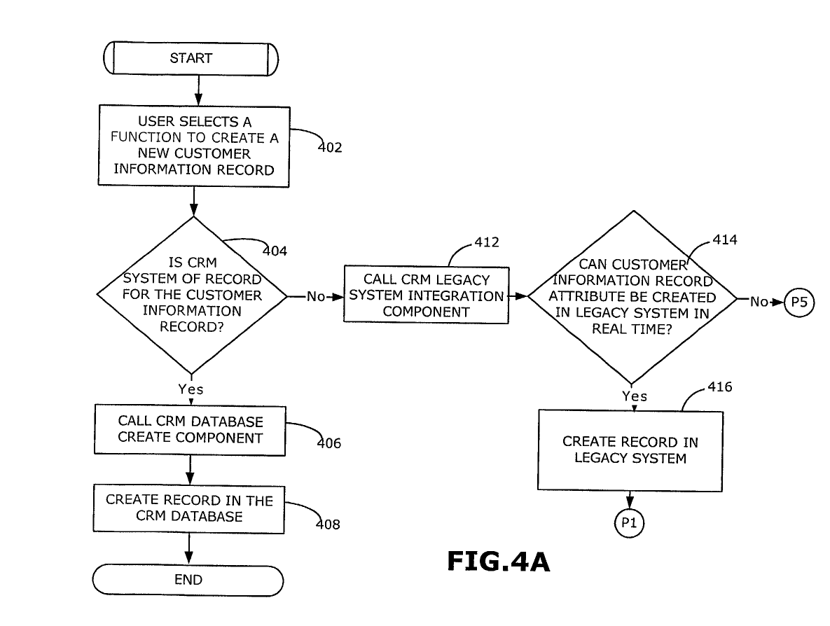

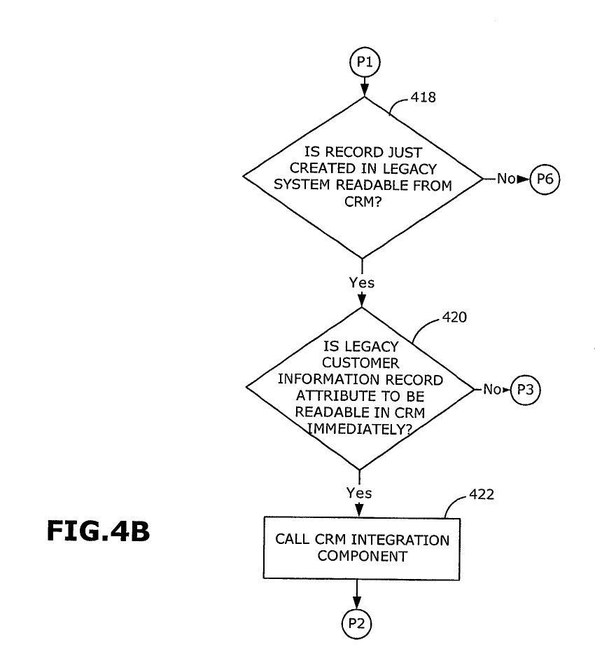

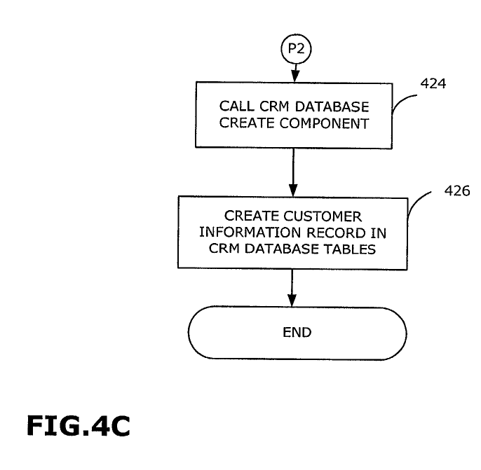

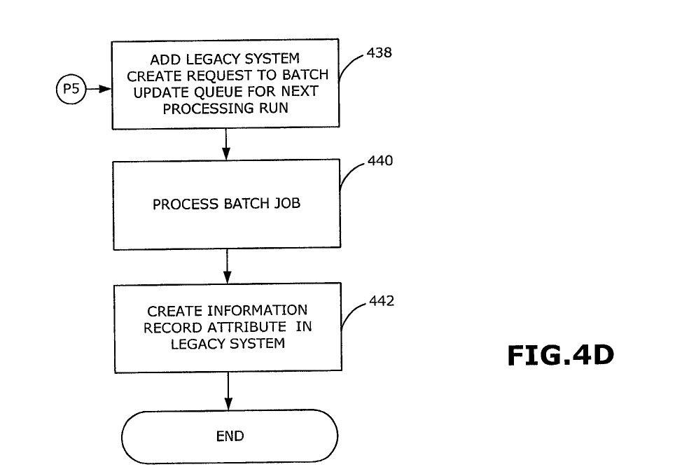

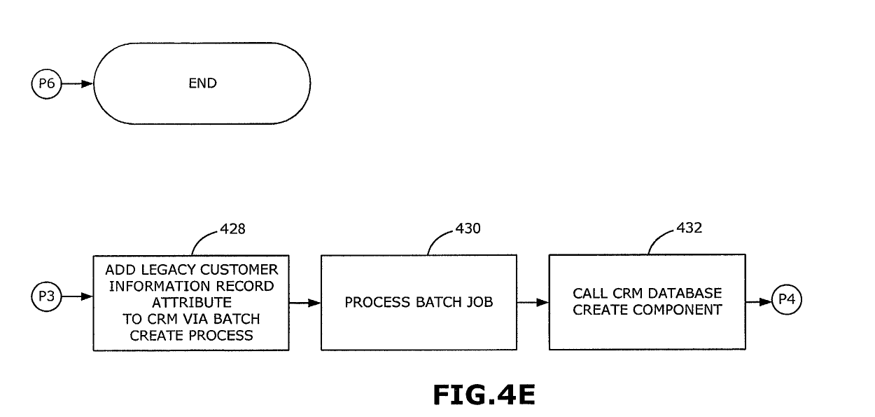

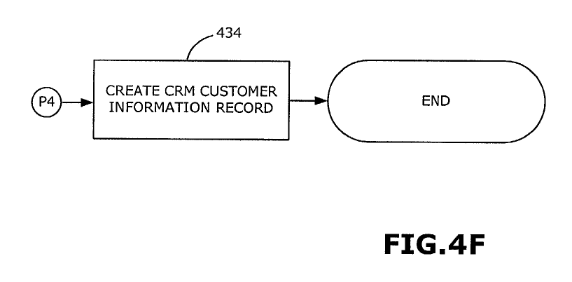

The reason for such a bottleneck is apparent in FIGS. 4A-4F, which illustrate the steps a conventional CRM-based customer information and transaction management infrastructure typically performs in order to create a new customer information record. First, in step 402, using a CRM interface, a user selects a function to create a new customer information record. In step 404, the system determines whether the CRM is the system of record for the customer information. If the CRM is the system of record, then a call is made to the CRM database create component, step 406. Then, at step 408, the record is created in the CRM database, and processing ends. If, at step 404, the CRM is not the system of record, then a call is made at step[ 412 to a CRM legacy system integration component. The CRM legacy system integration component determines, at step 414, whether the record can be created in the legacy system in real time. If real time record creation is allowed, the record is created in the legacy system at step 416. Processing then continues at step 418, shown in FIG. 4B, by way of flow chart connector P1.

In step 418, the system determines whether the record just created in the legacy system is readable from the CRM. If the answer is no, then processing ends by way of flow chart connector P6, as shown in FIG. 4E. If the just-created record is readable from the CRM, processing continues at step 420, where it is determined whether the legacy system customer information record is readable in the CRM immediately. If it is readable immediately, then at step 422 a CRM integration component is called. Then, in step 424, shown in FIG. 4C by way of flow chart connector P2, the CRM database create component is called to create a new record in the database. Next, in step 426, the CRM database component creates the new record in the CRM database tables, and processing ends.

Returning now to step 420 in FIG. 4B, if the legacy customer information record is not immediately readable by the CRM, then processing continues at step 428, shown in FIG. 4E by way of flow chart connector P3, where a “batch create” process is used to add the legacy system record to the CRM. Next, in step 430, the batch process is invoked. At step 432, a call is made to the CRM database to create the new record. In step 434, the CRM customer information record is created, (shown in FIG. 4F by way of flow chart connector P4), and processing ends.

Returning now to step 414 (FIG. 4A), if the record cannot be created in the legacy system in real time, a request to create the record in the appropriate legacy system is added to the batch process or update queue for the next processing run, step 438, shown in FIG. 4D by way of flow chart connector P5. In step 440, the batch process job is executed. Finally, in step 442, the record is created in the legacy system and processing ends.

Very few large enterprises can afford to replace their legacy customer information stores all at once or have them intentionally or unintentionally interrupted or materially degraded for any sustained period of time while a new customer information store is brought online. As a general rule, new customer information stores need to be installed, and legacy customer information needs to be migrated to the new stores, without adversely affecting the enterprise's ongoing information and transaction processing activities. In many cases, the data housed in the legacy customer information stores (the old systems of record) must be consolidated and migrated to the integrated customer information store (the new system of record) without causing a noticeable impact on the enterprise's transaction processing activities. For example, in the context of a bank, this consolidation and migration would need to occur without any noticeable delay in transactions like cash withdrawals from ATMs (which customers now expect to happen essentially instantaneously, 24 hours a day, seven days a week).

Even if these problems are adequately addressed, enterprises with very large customer information stores confront the further challenge of achieving acceptable data retrieval speeds while using conventional data retrieval architectures and infrastructures. Large enterprises that have customer information databases for tens of millions of customers must sometimes store and be able to access tens of terabytes (1×10¹² bytes) of data at rates of at least hundreds of requests or inquiries per second, and often approaching or exceeding 10,000 requests or inquiries per second. Conventional infrastructures typically are not designed to provide—and typically cannot provide—access to all customer information at acceptable speeds across essentially all points of customer contact, for all products and essentially all business channels for such a large enterprise.

According to the present invention, and in contrast to conventional architectures and systems, an integrated customer information store is not structured as an essentially standalone application. It is instead structured as a service of the infrastructure, and in embodiments provides a browser interface fabric with access to legacy data, transactions and extended customer information in an ICIS. In embodiments, an ICIS is structured in a logical legacy-system layer of a CIMI according to the present invention. In such embodiments, while the ICIS may not be a legacy system in the conventional sense, its configuration in a logical legacy-system layer along with conventional legacy systems enables embodiments of the CIMI of the present invention readily to accommodate new services or applications using essentially the same structures and interfaces used for conventional legacy systems.

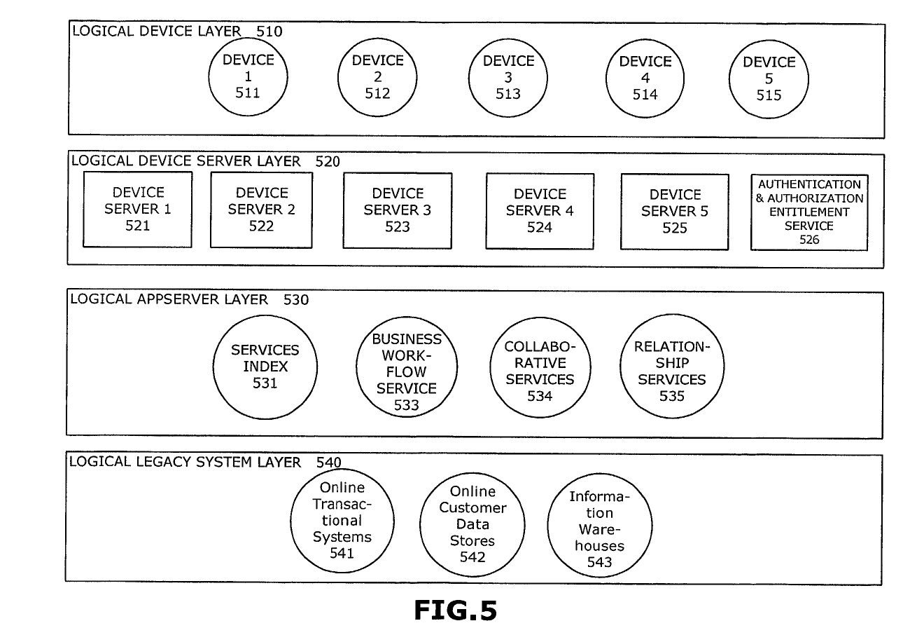

FIG. 5 shows a block diagram illustrating the logical layers of a CIMI configured in accordance with an embodiment of the present invention. Logical device layer 510 contains logical groupings of physical interface devices 511-515 (e.g., computers, phones, faxes, web browsers, wireless personal digital assistants, etc.) used to make service requests, for example, to request transactions such as “transfer money” or “buy stock using checking” or to request that customer information records such as credit card or checking account balances be read, updated, created or deleted. As discussed above, used in this specification in connection with the present invention, the term “service request” encompasses any function available and presented to any user of the infrastructure. In the context of a bank institution, for example, service requests can encompass transactions, information requests or reports, instructions to read or change a customer's information set in the customer information store, and requests for specific operations, such as printing checks or canceling a credit card, and any other interaction between a user and the bank. These physical interface devices allow for user-device interactions such as inserting a card into an ATM, pressing buttons, displaying information, or playing a recorded message or other means for obtaining information from or providing information to a user.

In an embodiment of the invention, devices 511-515 can be customized based on need, depending on the enterprise's lines of business (LOBs), geographic locations and customer segments. For example, in the context of a bank, an ATM will have a different keyboard and screen size and will present and request information differently from a computer keyboard or a telephone. Logical Device Server Layer 520, connected with Logical Device Layer 510 using means for transmitting electronic, optical radio or other signals apparent to one of skill in the art in light of this specification, provides an integrated service layer that supports the different devices 511-515 used by the different channels or lines of business. In a preferred embodiment, Logical Device Server Layer 520 includes one or more Logical Device Servers 521-525 configured to respond to user service requests initiated by Devices 511-515 of the Logical Device Layer 510.

In the embodiment depicted in FIG. 5, Logical Appserver Layer 530, connected with Logical Device Server Layer 520 using means for transmitting electronic, optical radio or other signals apparent to one of skill in the art in light of this specification, allows an enterprise to define a set of business functions and processes that apply, for example, across different LOBs and different Devices 511-515. If the infrastructure of the present invention is used by a bank, for example, where the Logical Device Layer 510 contains a physical interface that allows access to and execution of transaction against checking accounts, for example, and another physical interface that allows access to and execution of transactions against investments, as another example, Logical Appserver Layer 530 makes it possible to define a function such as “buy stock using funds from my checking account,” which could require accessing and processing information from a legacy checking account system and a legacy investment system.

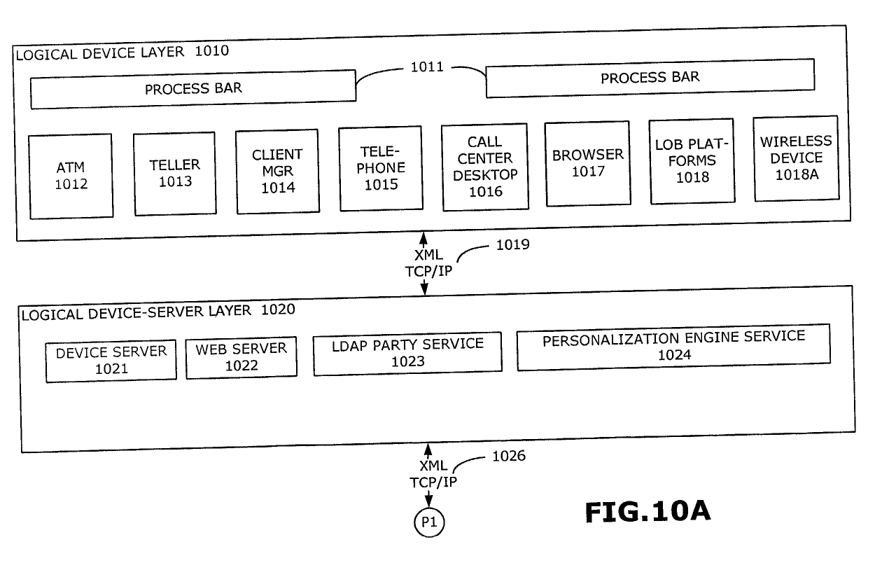

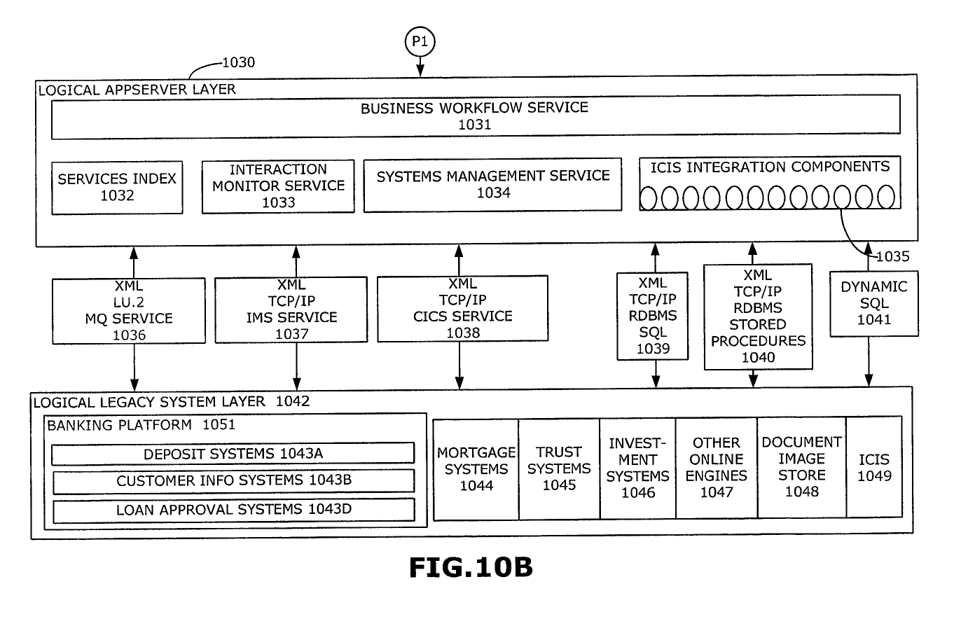

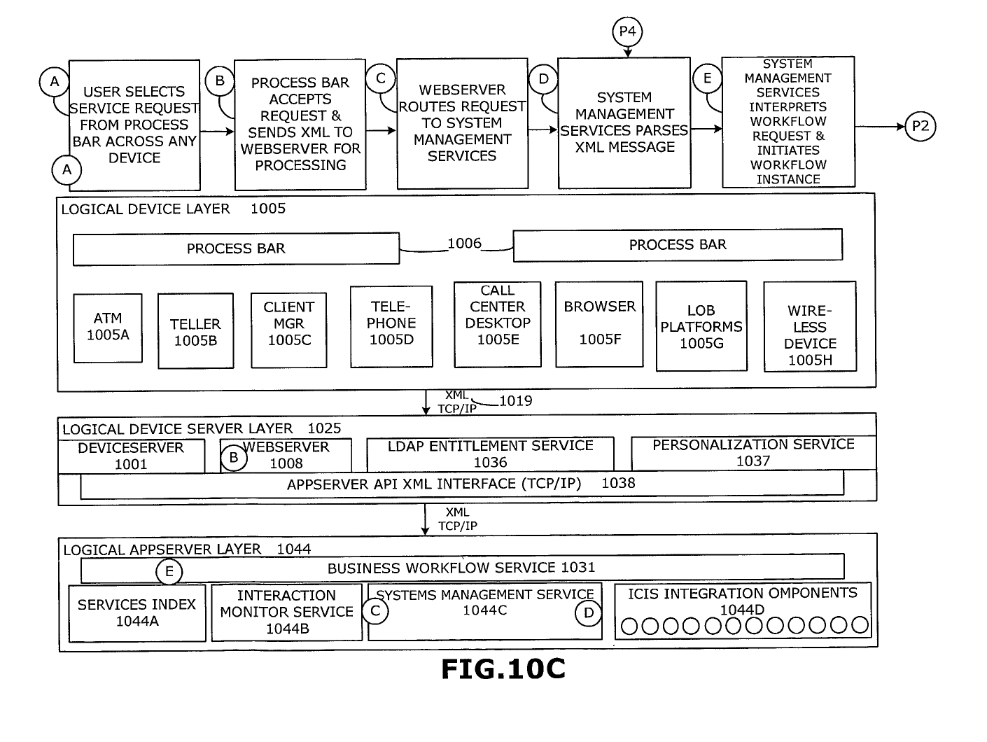

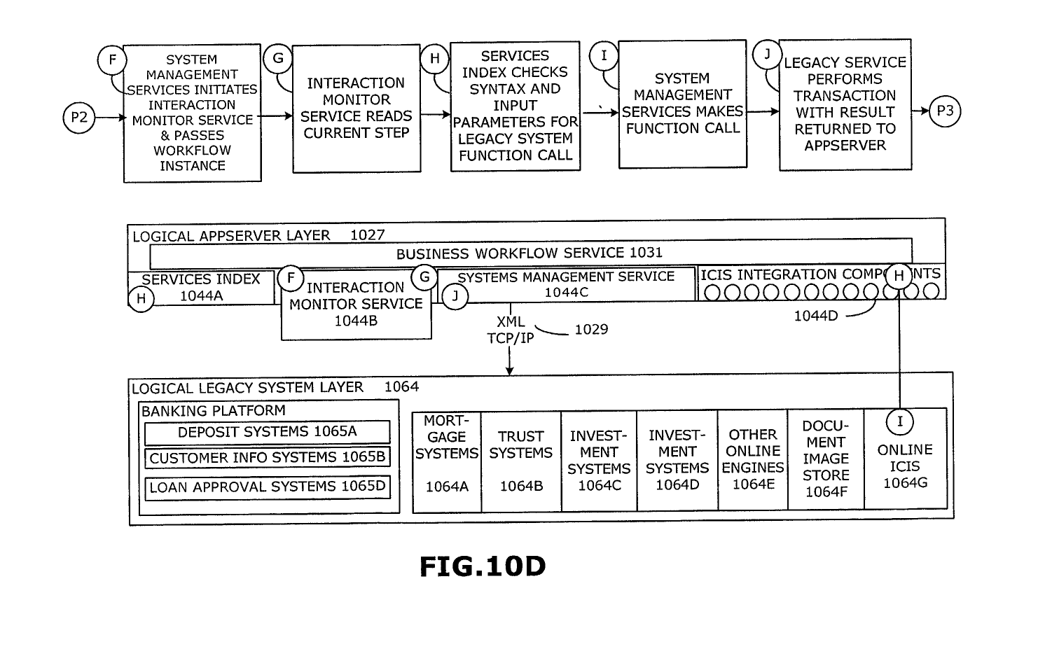

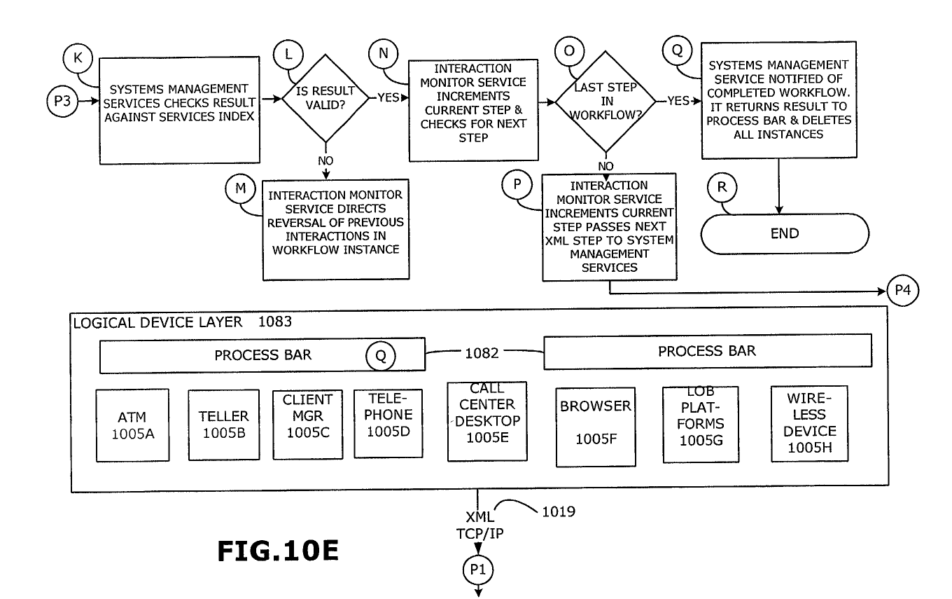

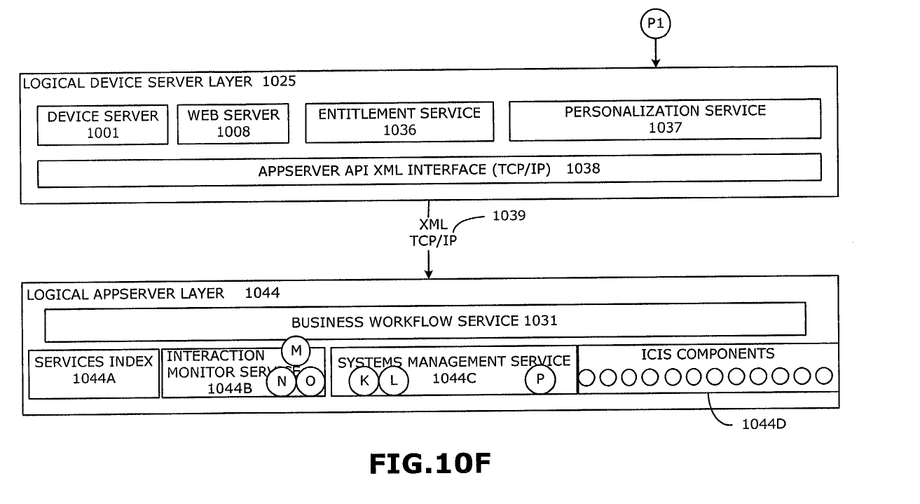

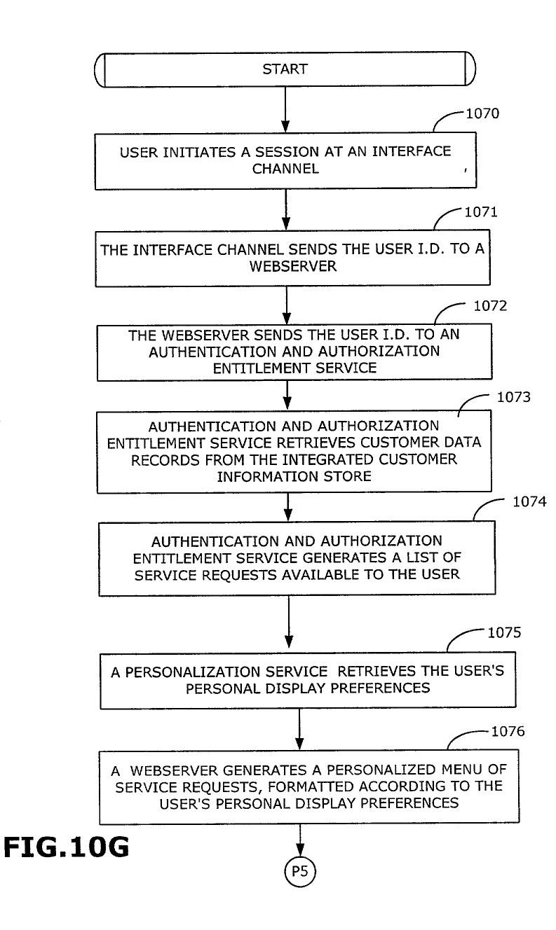

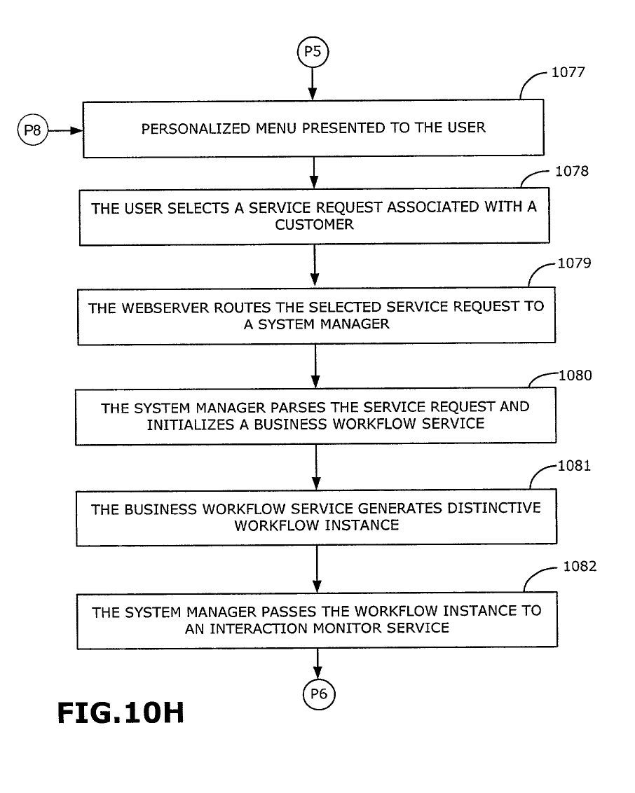

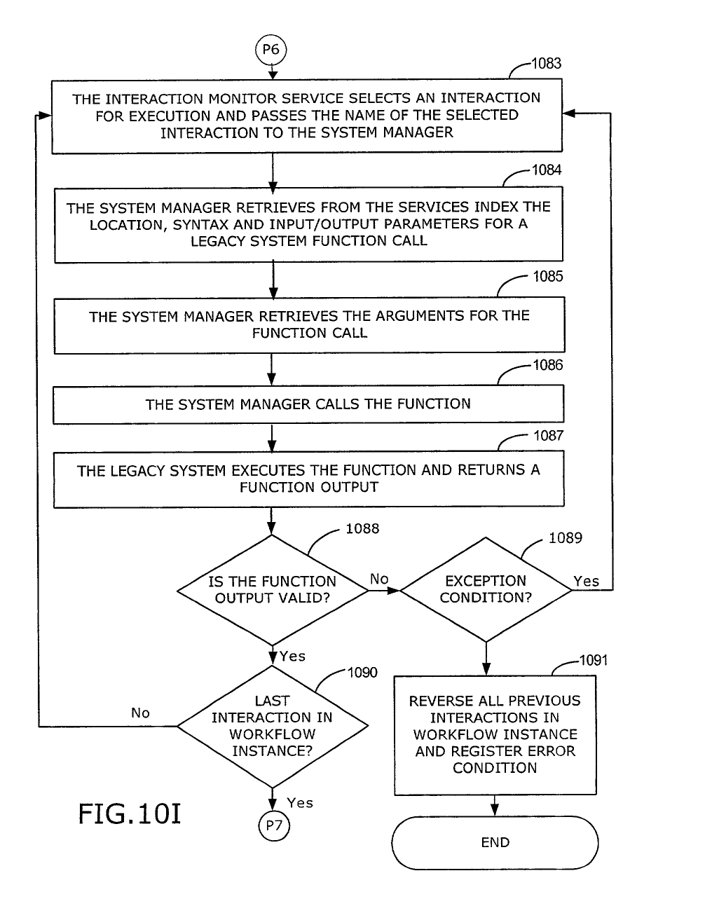

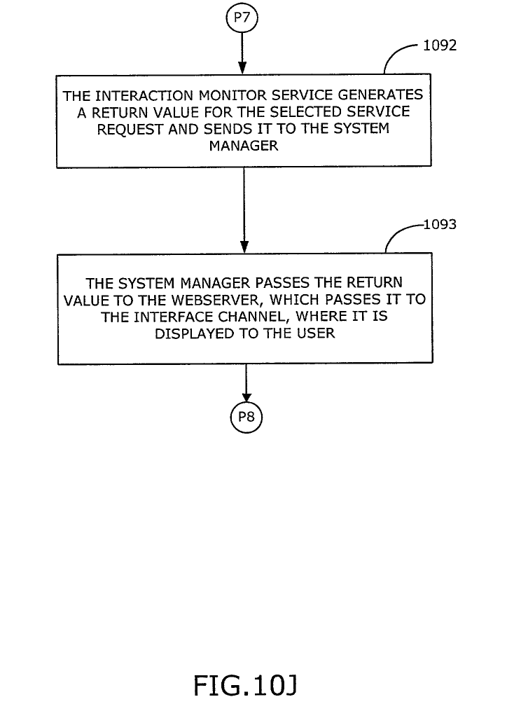

In an embodiment, Logical Appserver Layer 530 includes a Services Index 531, an Authentication and Authorization Entitlement Service 532, a Business Workflow Service 533, Collaborative Services 534 and Relationship Services 535, which are described in more detail below with reference to FIGS. 10A and 10B. In the embodiment depicted in FIG. 5, Logical Legacy System Layer 540, connected with Logical Appserver Layer 530 using means for transmitting electronic, optical, radio or other signals apparent to one of skill in the art in light of this specification, contains the transaction processing systems and customer information systems of record for the enterprise. In FIG. 5, these systems are depicted as Online Transaction Systems 541, Online Customer Data Stores 542, and Information Warehouses 543. In a banking environment, for instance, Logical Legacy System Layer 540 would house the transaction processing applications, including customer information stores for banking activities, such as deposit, loan, investment and advice transactions and interactions.

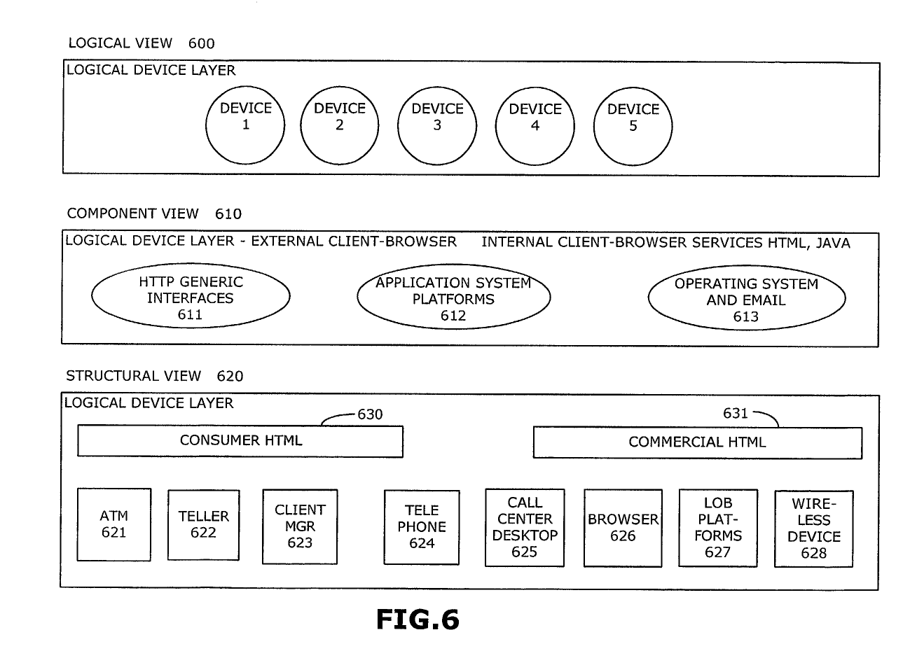

FIG. 6 is a block diagram illustrating the relationship between the Logical View 600, Component View 610, and Structural View 620, of a logical device layer of an embodiment of a CIMI of the present invention. While configurations of the infrastructure of the present invention can take many different forms, FIG. 6 illustrates an embodiment that could be used to manage customer information and transactions in a large bank. This is evident by the depiction, in FIG. 6, of banking interface Devices 621-628 in the Structural View 620 of the logical device layer. As depicted in FIG. 6, the logical device layer includes an ATM 621, a Teller 622, a Client Manager 623, a Telephone 624, a Call Center Desktop 625, a Browser 626, an LOB Platform 627 and a Wireless Device 628, all of which are physical embodiments of the logical devices shown in Logical View 600.

Component View 610 shows a functional component breakdown of the logical device layer. From a functional perspective, the logical device layer includes HTTP Generic Interfaces 611, Application System Platforms 612, and Operating System and Email 613. In the embodiment depicted in FIG. 6, ATM 621, Teller 622, and Browser 626 are examples of physical devices that perform the functions of the components depicted as HTTP Generic Interfaces 611 in Component View 610. Client Manager 623, Call Center Desktop 625, and LOB Platforms 627 are examples of Application System Platforms 612. In an embodiment, ATM 621, Teller 622, Browser 626, Client Manager 623, Call Center Desktop 625, and LOB Platforms 627 support Consumer HTML 630 or Commercial HTML 631.

More generally, the devices depicted in FIG. 6, or other appropriate devices, could be used by sales representatives, service representatives, fulfillment representatives, telemarketers or any other users needing to access and use an infrastructure of the present invention.

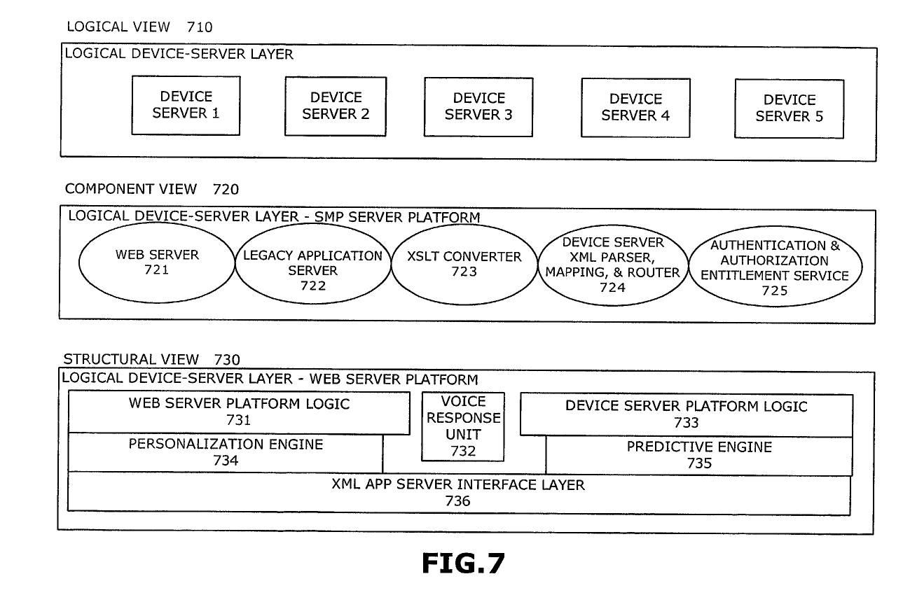

FIG. 7 is a block diagram illustrating the relationship in an embodiment of the present invention between the Logical View 710, the Component View 720, and the Structural View 730 of a logical device-server layer in the infrastructure. Component View 720 illustrates the functional components that would be present in the logical device-server layer of a CIMI configured according to an embodiment of the present invention. From a functional perspective, the logical device-server layer in an embodiment would include a Web Server 721, Legacy Application Server 722, XSLT (extendable style sheet transformation) Converter 723, an Device Server XML Parser Mapping and Router Component 724, and Authentication and Authorization Entitlement Service 725. Web server 721 acts as a common webserver, receiving HTTP (hyper-text transport protocol) and XML (extended markup language) signals, and displaying web pages on the interfaces in the logical legacy system layer.

As depicted in FIG. 7, Legacy Application Server 722 receives service requests from specific device presentation applications, translates those requests into messages for delivery via Web Server 721 to existing transactional legacy systems for processing, interface retrieval and display. XSLT Converter 723 provides the ability to show web pages on legacy devices. It receives XML messages, converts them and presents them as HTML pages on a browser. XSLT Converter 723 also provides the proper display on other user interface devices, such as handheld personal digital assistants (PDAs). Device Server XML Parser Mapping and Router Component 724 receives XML messages from HTTP devices or platforms, parses the messages into component pieces, and routes the pieces to and from browsers and legacy transaction systems and customer information stores.

Authentication and Authorization Entitlement Service 725 comprises a directory that specifies the services and functions that are available to users of the infrastructure. In an embodiment of the present invention, Authentication and Authorization Entitlement Service 725 specifies which service requests a particular user is entitled to make, and only those service requests are presented to the user. In an embodiment, those service requests are presented as web published services. In other embodiments, the presentation of the service requests specified by Authentication and Authorization Entitlement Service 725 depends on the channel used for the service requests. In such embodiments, this presentation could be different if the user is using an ATM, a telephone, a handheld personal digital assistant (“PDA”) or a computer, for example.

In another embodiment, the Authentication and Authorization Entitlement Service 725 links a user to one or more roles, which in turn are linked to one or more functions or service requests that users having those roles are entitled to perform or make. Thus, adding services to a role may increase the number of service requests available to all users who have been assigned that role. In this embodiment, users who have been defined to have a “client manager” role, for example, would be allowed, according to Authentication and Authorization Entitlement Service 725, to perform certain authoritative operations on the customer information stores, such as “delete a customer” or “show all customers of a certain net worth,” for instance. In such an embodiment, a user who has only been assigned the role of “customer” would only be able to perform operations that affect that particular user, such as “show my account balance” or “withdraw cash from my checking account.” Thus, in embodiments, users who have a “customer” role would not be able to perform the same operations or access as much data as users with roles such as “client manager,” “teller” or “bank president” or user administered roles with delegated authority such as “corporate treasurer.” More generally, each of a large number of users could have different user roles or different sets of service requests that would be available to them.

In an embodiment of the invention, the service requests available to the user, in combination with customer information from an ICIS about the customer that is the subject of the service requests, determine the interactions between the user and the device used for the request as well as the interactions among infrastructure components to execute the service request. For example, if the user is a customer, then her corresponding customer information set in the ICIS—including for example personal, demographic, financial, historical, predictive, relationship or any other information about the customer that a bank wishes to store and use in its infrastructure—can be used to determine not only the service requests available to her, but how they are displayed on an ATM or other device, and how they are executed by the components of the infrastructure.

In embodiments, if the user has a “client manager” or other non-customer role, there is an information set stored in the ICIS corresponding to the user which is used by Authentication and Authorization Service 725 to determine the service requests available to the user or the types of customers whose records the user can read, update, create or delete. More generally, the ICIS can store and make available to the components and services of the infrastructure an information set corresponding to each individual that has a past, present or prospective relationship with the enterprise using or operating the infrastructure. In embodiments of the present invention, the user's role may be selected by the user himself, or by an administrator.

Structural View 730 shows examples of physical embodiments of the logical device server layer components depicted in Logical View 710 and Component View 720. In the embodiment depicted in FIG. 7, the logical device server layer comprises Web/Device Server Platform Logic 731, VRU (Voice Response Unit) 732, Web/Device Server Platform Logic 733, Personalization Engine 734, Predictive Engine 735 and XML Appserver Interface Layer 736. Web Server Platform Logic 731 is an executable program that allows for manipulation and presentation of business logic by both a web server and a legacy application server. Personalization Engine 734 provides the ability to tailor the presentation on each device based on the user's personal preferences. In embodiments, the display may be altered to display marketing material response to the preferences of the user or customer or other party as well as the strategy of the enterprise for responding to or otherwise treating the user, customer or party. Predictive Engine 735 anticipates what a customer will want to do based on, for example, the customer's profile and personal preferences stored in the ICIS, and product and service requests previously made by the customer, or product and service requests selected by other similarly-situated customers.

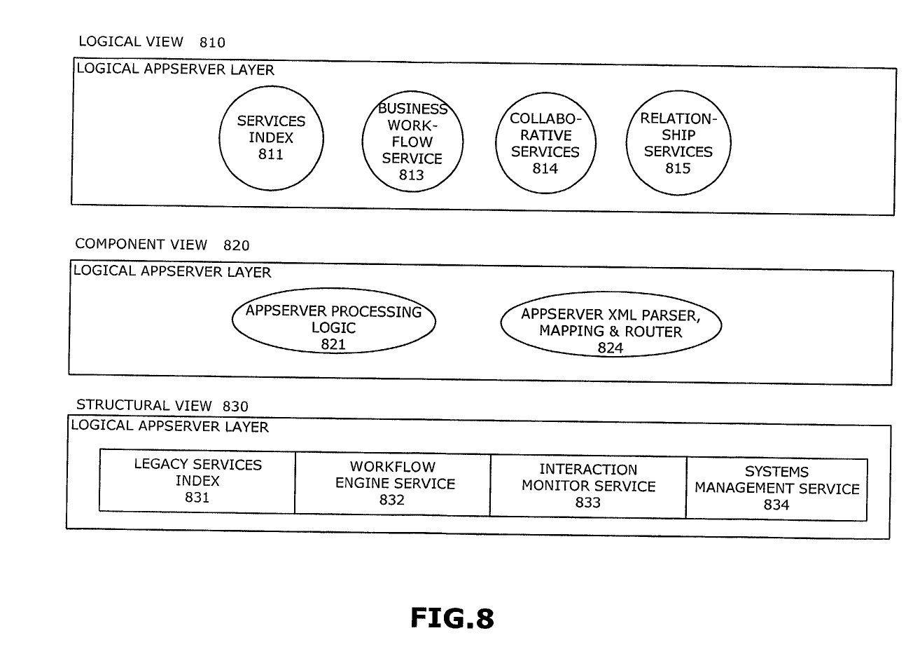

FIG. 8 is a block diagram illustrating the relationship between the Logical View 810, the Component View 820 and the Structural View 830 of the logical appserver layer in an infrastructure configured according to an embodiment of the present invention. Logical View 810 is comprised of Services Index 811, Business Workflow Service 813, Collaborative Services 814, and Relationship Services 815.

Services Index 811 comprises a directory of information needed to communicate with one or more (up to all) services that are available within the infrastructure. In an embodiment, the set of infrastructure components interactions required to execute a service request includes at least one legacy system function call, and Services Index 811 stores information related to the legacy system function calls. Services Index 811 may store and provide, for example, an address associated with the function call, the programming syntax, and input and output parameter information required for a high-level device server application (such as an Internet banking server) to interact with one or more “back-end” legacy transaction platforms (such as relational database management systems, hierarchical flat file database systems and transactional processing systems). Thus, if the infrastructure has a legacy back-end function for moving money, another legacy back-end function for buying stock, and another legacy back-end function for checking account balances, Service Index 811 would contain three entries (check balance, move money and buy stock) that specify the information (such as an address, input and output parameters and data formats) for accessing (or calling) those three functions.

Service Index 811 makes it possible, in an embodiment of the present invention, for high-level applications to communicate service requests (such as “show me my checking account balance,” or “move money from savings to checking”) to the legacy transaction systems, without hard-coding the function calls for those requests within the high-level applications themselves. Instead, any program or process in the infrastructure can dynamically determine the information needed to make the function calls by looking up the information in Services Index 811. In an embodiment, Services Index 811 stores and provides syntax information about every function or service that the bank wanted the ability to call in the infrastructure, which would be published throughout the enterprise so that other programs and processes in the infrastructure can call those functions or services. Although Services Index 811 is depicted in FIG. 8 as a separate functional component, the functions of Services Index 811 alternatively may be incorporated inside other programs or processes that reside in the infrastructure without departing from the scope of the present invention.

In the embodiment of the present invention depicted in FIG. 8, Business Workflow Service 813 contains the logic that orchestrates the execution of one or more legacy system function calls included in the set of infrastructure-component interactions required to execute a service request pertaining to one of the multiplicity of customers. For example, if a user wishes to “buy stock using funds from checking account,” the service request may require completing a number of distinct functions or infrastructure-component interactions in a specific order. Such a transaction might require the following functions, for example: (1) retrieve a checking account balance for the customer, (2) determine whether the balance is greater than or equal to the amount to be withdrawn to pay for the stock, (3) move the appropriate amount of money out of checking into a brokerage account, and (4) buy the stock using the funds in the brokerage account. In an embodiment, the first, third and fourth of these functions would each have a separate entry in Services Index 811; and Business Workflow Service 813 would direct the execution and confirmation of all four functions in the proper order. In an embodiment, the second function (determining whether the balance is greater than or equal to the amount required to buy the stock) could be implemented in the logic of Business Workflow Service 813, or it could have its own entry in Services Index 811.

In an embodiment, Business Workflow Service 813, as well as the function “buy stock using funds from checking account,” would have their own entries in Services Index 811. In this way, Business Workflow Service 813 would constitute a callable function of the infrastructure, just like every other service registered in Services Index 811. Thus, in an embodiment, there would be an entry in Services Index 811 for the “buy stock using funds from checking account” function, which contains an instruction to call another function, known as Business Workflow Service 813, which in turn contains instructions to call other functions (i.e., “retrieve checking balance,” “determine whether balance is sufficient,” “move money from checking to brokerage account,” and “buy stock using funds in brokerage account”).

In an embodiment, Business Workflow Service 813, in combination with customer information corresponding to the customer that is the subject of a service request, determines the set of interactions among components of the infrastructure required to execute the service request. For example, the customer information set corresponding to Customer A could identify her as a Maryland resident whose checking account transactions are accomplished without automatic overdraft protection on a system in Virginia, while the customer information set corresponding to Customer B could identify him as a California resident whose checking account transactions are accomplished with overdraft protection up to $25,000 on a system in California. In an embodiment, Business Workflow Service 813 would determine a different set of infrastructure-component interactions for a withdrawal request for $1000 at an ATM: for Customer A, the set of interactions would include function calls to the Virginia system and an instruction to terminate the request if the checking account balance was under $1000; and for Customer B, the set of interactions would include function calls to the California system, and could include instructions to advance funds from a line of credit if the checking account balance was below $1000. As another example, Customer C could be a college student whose parents are longstanding creditworthy customers of a bank, while Customer D could be a college student whose parents are not known to the bank. When Customer C applies for a credit card, Business Workflow Service 813 could include steps to consider his parents' net worth, but would not include those steps for Customer D.

As also depicted in FIG. 8, Collaborative Services 814 comprises programs, such as email, shared calendars and shared “to-do” lists, that allow users of the infrastructure to communicate and coordinate with each other. Relationship Services 815 comprises a directory that indicates the location of customer information for particular customers. This directory may be indexed, for example, by customer name, customer address, interface or business channel, or may be indexed according to the relationships the customers have with the enterprise.

In the embodiment depicted in FIG. 8, Component View 820 illustrates the functional components of the logical appserver layer configured according to an embodiment of the present invention. Component View 820 comprises Appserver Processing Logic 821 and Appserver XML Parser Mapping & Routing Component 824. Appserver Processing Logic 821 comprises the services shown in Logical View 810, e.g., Services Index 811, Business Workflow Service 813, Collaborative Services 814 or Relationship Services 815, as discussed above. IBM's Websphere and BEA Systems' Weblogic are both examples of appserver layer suites suitable for implementing the Appserver Processing Logic 821 in an embodiment of the present invention. Appserver XML Parser, Mapping & Router Component 824 receives messages directed to the logical appserver layer and sends the messages to the appropriate appserver layer processing platform. Appserver XML Parser, Mapping & Router Component 824 also maps messages to the appropriate server in the logical device server layer.

As depicted in FIG. 8, Structural View 830 illustrates how a logical appserver layer in one embodiment of the present invention would be configured. From a structural perspective, the logical appserver layer comprises Services Index Service 831, Work Flow Engine Service 832, Interaction Monitor Service 833 and Systems Management Service 834, which are physical embodiments of the logical elements and functional components depicted in the Logical View 810 and Component View 820 of the appserver layer. In an embodiment, Workflow Engine Service 832 provides the functions depicted in the Component View 820 as Business Workflow Service 813, and Interaction Monitor Service 833 monitors the steps performed in each transaction.

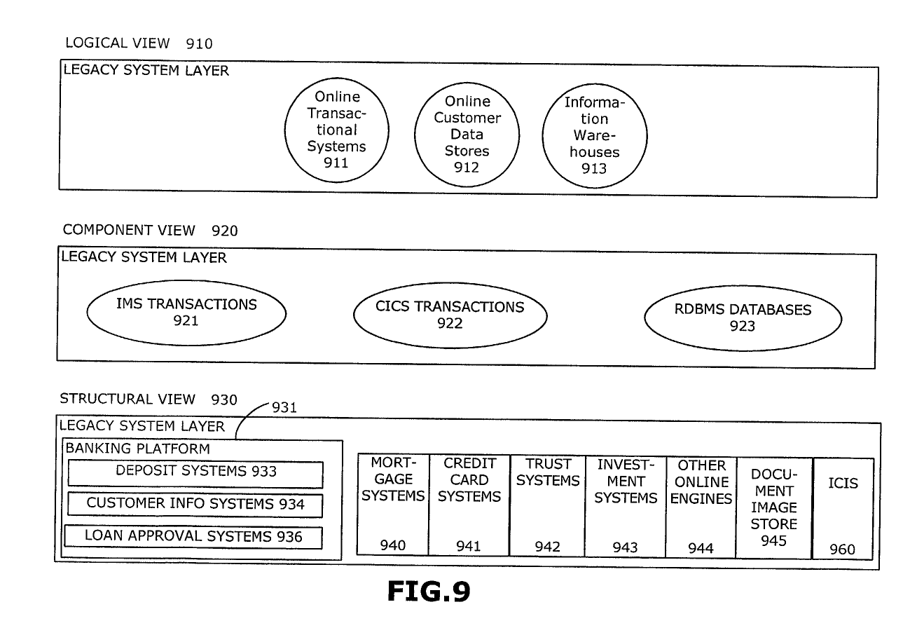

In the embodiment depicted in FIG. 8, Systems Management Service 834 monitors the state of the appserver layer throughout the entire workflow and application programming interface (API) process and provides control of legacy processing in the legacy system layer (described below with reference to FIG. 9) based on current workloads in the appserver layer. In another embodiment, Systems Management Service 834 directs execution of the interactions among components of the infrastructure. These structures are also described detail below with reference to FIGS. 10A and 10B.

In an embodiment, Interaction Monitor Service 833 monitors execution of one or more of the infrastructure-component interactions (including information inquiries and transactions) required to execute each of the multiplicity of service requests by users of the infrastructure of the present invention. For example Interaction Monitor Service 833 may monitor each of the infrastructure-component interactions required to execute each of those requests. In embodiments, when a sequence of infrastructure-component interactions is required to execute a service request, Interaction Monitor Service 833 monitors execution of each interaction in sequence and, if it detects a failure of one of the interactions, directs a reversal of each of the interactions in the sequence executed prior to the reversal. For example, a service request to “buy stock using funds from checking account” could entail a number of infrastructure-component interactions, including retrieving a checking account balance, ascertaining whether the balance was sufficient for the proposed purchase, moving money from the customer's checking account to the bank's brokerage account, and buying the stock using the funds in the brokerage account. If for some reason the appropriate legacy system could not record the ownership change, it would send an error message to Interaction Monitor Service 833, which would, among other steps, direct a reversal of the previous transfer of funds to the brokerage account.

FIG. 9 is a block diagram illustrating the relationship between the Logical View 910, Component View 920 and Structural View 930 of the logical legacy system layer of an embodiment of a CIMI according to the present invention. From a logical perspective, and as depicted by Logical View 910, the logical legacy system layer comprises components such as Online Transactional Systems 911, On-line Customer Data 912, and Information Warehouses 913. Online Transactional Systems 911 provides real-time business functionality across different business channels. Examples of online transactional systems that would be present in the legacy system layer are illustrated in Structural View 930. These would include for example, Deposit Systems 933, Customer Information Systems 934 and Loan Approval Systems 936. Other on-line transactional systems may include, for example, Mortgage Systems 940, which for instance executes transactions mortgages held or serviced by a bank; Credit Card Systems 941, which for instance executes credit card transactions using cards issued by the bank; Trust Systems 942, which for example administers trust accounts and investments held in trust by the bank; Investment Systems 943, which for instance executes investment transactions for bank customers and the bank's own account; and Other On-Line Engines 944, which handle other on-line services offered by the bank, such as debit cards. As illustrated by Structural View 930, the logical legacy system layer may also include a Document Image Store 945 (for example a check image store), and an ICIS 960. Each of these structures is also described in detail below with reference to FIGS. 10A and 10B.

As depicted in FIG. 9, Online Customer Data Stores 912 are customer information repositories that provide and receive customer information during online transaction processing. Information Warehouses 913 are systems that, in a preferred embodiment, are subjugated to one or more legacy online transaction systems and configured to receive time-phased data drops from those legacy online transaction systems. Information Warehouses 913 provide the ability to perform online queries based on particular customers or particular transactions. The legacy system layer programs (Online Transactional Systems 911, Online Customer Data Stores 912 and Information Warehouses 913) may be implemented using business transaction processing environments such as IMS, CICS (Customer Information Control System), DB2 and other relational database management systems, hierarchical flat file systems and/or transaction processing systems, as appropriate. Examples of these business transaction processing environments are depicted by Component View 920, which comprises IMS Transactions 921, CICS Transactions 922, and Databases 923.

CICS is an online transaction processing program (OLTP) available from IBM that, together with the COBOL programming language, has become over the past several decades one of the most common tools for building customer transaction applications in large-enterprise mainframe computing environments. A great number of legacy applications in use today are CICS/COBOL applications. Using the application programming interface (API) provided by CICS, a programmer can write programs that communicate with online users and read from or write to customer and other records (orders, inventory figures, customer data, and so forth) in a database (usually referred to as “data sets”). Like other transaction or interaction managers such as IMS, CICS can ensure that transactions or other interactions are completed and, if not, undo partially completed transactions so that the integrity of data records is maintained.

In the embodiment depicted in FIG. 9, Structural View 930 illustrates several examples of physical structures of the logical legacy system layer, as it might be implemented by a large bank or other financial services institution. Accordingly, Structural View 930 illustrates a logical legacy system layer that includes a number of banking and financial institution transaction processing systems, including Deposit Systems 933, Customer Information Systems 934, Loan Approval Systems 936, Mortgage Systems 940, Credit Card Systems 941, Trust Systems 942, Investment Systems 943, Other Online Engines 944, Document Image Store 945 and an Integrated Customer Information Store (ICIS) 960, which are all physical embodiments of the logical systems depicted in the Logical View 910. For example, Customer Information Systems 934 is a physical embodiment of the Online Customer Data Store 912 shown in Logical View 910. Deposit Systems 933, and Loan Approval Systems 936 are both physical embodiments of the Online Transactional Systems 911 shown in Logical View 910. The ICIS 960 may contain a multiplicity of customer information sets, each of which is associated with or corresponds to one of a multiplicity of customers. In a large organization, the number of data sets and corresponding customers could range from about 10,000 to greater than 50,000,000, depending upon the size of the organization and the needs of its customers.

FIGS. 10A and 10B provide block diagrams illustrating four logical layers and various components of an embodiment of a CIMI according to the present invention. FIGS. 10A and 10B also illustrate an embodiment which might be used by a bank, as can be seen by reference to physical devices 1012-1018A. Together, FIGS. 10A and 10B illustrate four logical layers and functional components of a CIMI of an embodiment of the present invention suitable for a bank or other financial institution. FIG. 10A illustrates the top two logical layers (the logical device layer and the logical device server layer), and FIG. 10B illustrates the bottom two logical layers (the logical appserver layer and the logical legacy system layer). Similar to the logical legacy system layer depicted in FIG. 9, the logical legacy system layer depicted in FIG. 10B (Logical Legacy System Layer 1042) comprises a Banking Platform 1051, Mortgage Systems 1044, Trust Systems 1045, Investment Systems 1046, Other Online Engines 1047, a Document Image Store 1048 and an ICIS 1049.

In the embodiment shown in FIG. 10B, Logical Legacy System Layer 1042 communicates with Logical Appserver Layer 1030 via service protocols, such as XML/LU2/MQ Service 1036, XML/TCP/IP IMS Service 1037, XML/TCP/IP CICS Service 1038, XML/TCP/IP RDBMS/SQL 1039, XML/TCP/IP RDBMS Stored Procedures 1040 and Dynamic SQL 1041. This is done using the transmission, reception or other propagation of electronic, radio or optical signals between the logical layers and the infrastructure components comprising those layers. In other embodiments, appropriate protocols would be used depending on the database management and other systems used in Logical Appserver Layer 1030 and Logical Legacy System Layer 1043. In the embodiment depicted in FIG. 10B, LU2/MQ Service 1036 provides the infrastructure with a means of interfacing with asynchronous application systems calls. XML/TCP/IP IMS Service 1037 provides communications for IMS-based transactions via direct, real-time socket connections. XML/TCP/IP CICS Service 1038 provides communications for CICS transactions, also via direct, real-time sockets. XML/TCP/IP RDBMS/SQL 1039, XML/TCP/IP RDBMS Stored Procedures 1040 and Dynamic SQL 1041 provides the infrastructure with the means to make SQL calls to ICIS 1049 via stored procedures. In this embodiment, online processing occurs using standardized application programming interfaces that connect to ICIS 1049, legacy transaction applications and business engines using XML (extended markup language).

As shown in FIG. 10B, services from the Logical Legacy System Layer 1042 are “published” to the Logical Appserver Layer 1030. In other words, in this embodiment, each service in Logical Appserver Layer 1030 has available to it sufficient information to enable it to access (subject to appropriate authorization) services and systems in Logical Legacy System Layer 1042. In such an embodiment, Logical Appserver Layer 1030 is comprised of Business Workflow Service 1031, Services Index 1032, Interaction Monitor Service 1033, Systems Management Service 1034 and ICIS Integration Components 1035. Business Workflow Service 1031 allows developers to construct programmatic links, during development, between several legacy API calls for sequential and parallel operation during runtime. Business Workflow Service 1031 also contains the logic that orchestrates the execution of one or more function calls to legacy systems required to execute a service request pertaining to one of the customers, and corresponds to Business Workflow Service 813 depicted in FIG. 8. As shown in FIG. 10B, Services Index 1032 provides the infrastructure with a road map to services residing in Logical Legacy Systems Layer 1042, and comprises a directory of information needed to communicate with one or more services that are available within Logical Device Server Layer 1020, Logical Appserver Layer 1030 and Logical Legacy System Layer 1042. As depicted in FIG 10B, Services Index 1032 corresponds to Services Index 811 as depicted in FIG. 8.

In the embodiment depicted in FIG. 10B, Interaction Monitor Service 1033 monitors interaction flows and provides programmatic backward compatibility based on application calls to existing back-out transaction codes residing in Logical Legacy System Layer 1042. For example, if a particular banking transaction requires the successful completion of three substeps (one of which could be, for example, to move money from one account to another as the predicate to buying stock), Interaction Monitor Service 1033 would monitor the completion of each step. If a first step succeeded and a subsequent step failed, Interaction Monitor Service 1033 would direct the appropriate legacy system to “reverse” or “undo” the first step. For example, a step might move the money to a brokerage account to buy stock, but a subsequent step might find that there were not enough shares to complete the transaction at the specified price, requiring that the money be “moved back” to the originating account. Interaction Monitor Service 1033 corresponds to Interaction Monitor Service 833, as depicted in FIG. 8.

In the embodiment depicted in FIG. 10B, Systems Management Service 1034 monitors the state of the Appserver Layer 1030 throughout the entire workflow and API process and allows for management of legacy processing in the Logical Legacy System Layer 1042 based on current workloads in Logical Appserver Layer 1030. System Management Service 1034 also directs execution of the interactions among components of the infrastructure, and corresponds to System Management Service 834 of FIG. 8. IBM's Websphere,™ BEA System, Inc.'s Weblogic™ and Microsoft's Net programs are examples of appserver suites that could be configured to perform the functions of Interaction Monitor Service 1033 and Systems Management Service 1034 of Logical Appserver Layer 1030.

In an embodiment of the present invention, ICIS 1049 is based on a DB2 “know the customer” (KTC) customer information file, available from Siebel Systems, Inc., of San Mateo, Calif. The Siebel Systems customer relationship management system has been implemented for purposes of the present invention in such a manner that, using its basic data file structure, it can serve as an ICIS of the present invention. In this embodiment, after appropriate data migration, ICIS 1049 becomes the system of record and stores, a customer information set corresponding to each of the multiplicity of customers with relationships with the enterprise, including essentially all customer information, including, but not limited to, the customer's name, address, online profile, online preferences, and accounts and relationships (including with bank officers, employees and with other customers). ICIS Integration Components 1035, which in the embodiment depicted in FIG. 10B, reside in Logical Appserver Layer 1030, coordinate the integration of all customer information across their entire range of customer relationships. Thus, in this embodiment, any and all customer information in ICIS 1049 is accessible via a single call to ICIS Integration Components 1035.

In the embodiment depicted in FIGS. 10A and 10B, Logical Device Server Layer 1020 (shown in FIG. 10A) is comprised of at least one Device Server 1021, a Webserver 1022, an LDAP (lightweight directory access protocol) Party Service 1023, and a Personalization Engine Service 1024. LDAP Party Service 1023 includes a directory (not shown) that provides a single-point authorization-and-authentication-entitlement service across multiple business channels. Corresponding to Authentication and Authorization Entitlement Service 725 of FIG. 7, LDAP Party Service 1023 of FIG. 10 allows for role-based determinations of service requests available to each user, and presentations of those service requests based on interface channels and user roles (e.g., customer, teller, client manager, bank president or prospect.) Personalization Engine Service 1024 provides personalized interactions for all parties across all bank devices and channels.

In the embodiment depicted n FIGS. 10A and 10B, XML and TCP/IP protocols are used for communications between services components, devices and systems in Logical Device Layer 1010, Logical Device-Server Layer 1020, and Logical Appserver Layer 1030. In embodiments when the device is Telephone 1015, the corresponding Device Server 1021 is an interactive voice response unit (not depicted in FIG. 10A) and associated systems and operations communicating with Telephone 1015 using voice telecommunications techniques, technologies and protocols (not depicted). These communications may be effectuated using electronic, radio, optical or other signals propagated between the particular services, companies, devices or systems required to execute and monitor a service request.

FIGS. 10C-10F present flow and block diagrams illustrating in more detail the steps (see steps A-R in FIGS. 10C-10E) performed by an embodiment of the present invention, such as the embodiments depicted in FIGS. 10A, 10B, 19 and 20, in order for the infrastructure of the present invention to process a service request. FIGS. 10C-10F also illustrate the infrastructure interactions between the various components of the infrastructure. The flow diagrams toward the top of FIGS. 10C-10E show the steps performed and the block diagrams toward the bottom of FIGS. 10C-10F illustrate where those steps are executed in the logical layers of an infrastructure according to the present invention. Other embodiments may be implemented using other database management systems and protocols and other devices and structures.

Beginning with step A of FIG. 10C, a user selects a service request from a Process Bar 1006 from any device in Logical Device Layer 1005. As depicted in FIG. 10C, Process Bar 1006 is an embodiment of a module and display that allows a wide variety of device operating systems and platforms to present a consistent view, across platforms and devices, of any business process. In one embodiment of the present invention, the infrastructure may receive a large number of such service requests, nearly simultaneously. When the present invention is implemented in a large organization, the infrastructure could store information on tens of millions of customers, and service requests could be received by the infrastructure at a rate of about 10 per second to greater than about 500 per second.

In step B, Process Bar 1006 accepts the service request and sends an XML message to Webserver 1008 for processing. In step C, Webserver 1008 routes the request to System Management Services 1044C, which, in step D, parses the XML message. In step E, Business Workflow Service 1031 generates or determines a distinctive workflow instance comprising a sequence of one or more interactions, potentially including one or more transaction or information inquiries, involving a legacy system located in the logical legacy system layer of the infrastructure, which System Management Services 1044C interprets and initiates.

Processing then continues at step F of FIG. 10D by way of flowchart connector P2, where System Management Services 1044C initiates Interaction Monitor Service 1044B and passes the workflow instance to Interaction Monitor Service 1044B. In step G, Interaction Monitor Service 1044B reads the current processing step. Then, in steps H and I, Services Index 1044A performs a lookup of the appropriate legacy or online ICIS function calls (See 1044D and 1064G) and System Management Services 1044C makes the function call. If the appropriate function call is to a legacy system, then, in step J, the legacy system performs the function, returns the results, and notifies Systems Management Service 1044C. Notably, the execution of the function call by the legacy system, or the return of the results from the function call, may or may not occur while the user-initiated session is still active. In some embodiments, the execution of the function call and the return of the results may occur after (and some times substantially after) the user's session has ended.

Processing then continues at steps K and L of FIG. 10E by way of flowchart connector P3, where Systems Management Service 1044C (shown in FIG. 10F) checks the function results against the Services Index 1044A (also shown in FIG. 10F). If the results are not valid, processing continues at step M, where Interaction Monitor Service 1044B (shown in FIG. 10F) directs a reversal of interactions in the workflow instance that may have been completed prior to the return of invalid results from the current interaction.

Returning now to step L, if the results are valid, processing continues at step N of FIG. 10E, where Interaction Monitor Service 1044B increments the current step and checks for the next step in processing the service request. Then, in step 0, the system determines whether the last step in processing the service request has been accomplished. If not, then, in step P, Interaction Monitor Service 1044B increments the current step and processing returns to step D of FIG. 10C by way of flowchart connector P4. If, on the other hand, the last step in processing the service request has been accomplished, then processing continues at step Q of FIG. 110E, where System Management Services 1044C is notified of the completed workflow, the results are returned to Process Bar 1006, and all workflow instances are deleted. At this point, processing ends at Step R.

FIGS. 10G-10J illustrate the steps performed by an embodiment of the present invention in order to process a user-initiated service request. Beginning with step 1070 of FIG. 10G, a user initiates a session by, for example, logging onto a device at an interface channel located in the logical device layer, and by providing a User I.D. The device may be an automated teller machine (ATM), a telephone, a desktop computer terminal used by a bank employee or by a customer, or any other interface device in the logical device layer of the infrastructure, including for example any of the devices depicted in FIG. 10A (designated by reference numerals 1012-1018). In embodiments of the present invention, a device and its connection to the infrastructure, such as a telephone connection or an Internet connection, comprise a business channel or interface channel.

As used in this specification, a “session” is any activity in which a user activates, operates or interacts with an interface channel. A session could be initiated when a user telephones a live operator or an automatic call processing system in order to obtain a credit card balance, for example. A session may be initiated, as another example, when a user inserts an access card into an ATM in order to withdraw cash or transfer funds from one account to another. A session could be initiated when a user logs into an online banking website over an Internet connection and provides, as is typically required for accessing such websites, a user I.D. and password. A session might also be initiated when a bank employee (such as a teller, a call center operator, a client manager, or an officer of the bank) operates a desktop computer terminal coupled to the infrastructure as part of his daily job responsibilities in order to execute transactions on behalf of customers, or for the purpose of reading, updating, creating or deleting customer information records. In such cases, the bank employee may himself be the bank customer for which the transaction is being executed or the data records are being changed.

In the embodiment depicted in FIG. 10G, in step 1071, the interface channel sends the User I.D. to a webserver located in the logical device server layer. In embodiments, this information is transmitted using high speed or other telecommunications means using TCP/IP protected or other telecommunications techniques, technologies, and protocols appropriate to the devices transmitting and receiving the information. In step 1072, the Authentication and Authorization Service invokes a function call to populate a customer information data structure with the contents of the customer information set, from the customer information store, corresponding to the customer that is the subject of the service request. At this point, any device, program process or function in the infrastructure that is authorized to do so may retrieve (read) information about the customer by accessing the customer information data structure. In an embodiment, authorized processes in the infrastructure may also create, update, modify or delete elements of the customer's data record in the customer information store by creating, updating, modifying or deleting elements in the customer information data structure.

Based on the User I.D. and, in an embodiment, the contents of a record in the integrated customer information store, in step 1074, the Authentication and Authorization Entitlement Service (shown as LDAP Party Service 1023 in the embodiment shown in FIG. 10A and LDAP Entitlement Service 1036 in the embodiment shown in FIG. 10C) generates a list of service requests available to the user based on, for example, predefined user roles as described above. Next, in step 1075, a Personalization Service provides personal display preferences for the user based on the User I.D. and, in embodiments, the interface channel and the device being used by the user. Then, in step 1076, the webserver generates and sends to the interface channel a personalized menu, formatted according to the user's personal display preferences, containing the list of service requests available to the user for presentation on the device being used by the user. In embodiments this information is transmitted using high speed or other telecommunications means using TCP/IP protocol or other telecommunications techniques, technologies and protocols appropriate to the devices transmitting and receiving the information. In a preferred embodiment, the infrastructure is configured to display the same personalized menu for a user, regardless of the interface channel, and across all interface channels.

Processing then continues at step 1077 of FIG. 10H by way of flowchart connector P5, where the device presents (displays) the personalized menu of available service requests to the user. For an ATM or a computer, this presentation could be on a screen; for a telephone, this presentation could be a verbal menu. At this point, in step 1078, the user selects a service request associated with a customer (which can be the user) from the personalized menu of available service requests.

Continuing with the flowchart of FIG. 10H, in step 1079, the webserver routes the selected service request to a system manager located in the logical appserver layer of the infrastructure of the present invention. In embodiments involving ATMs or computers, for example, this information could be transmitted using electronic data communications technologies and techniques using TCP/IP or another protocol. In embodiments using telephones, this information could be transmitted using voice telephony technology or telephone keypad signaling in response to automated voice prompts, for example. Next, in step 1080, the system manager parses the service request and initializes a business workflow service. Based on the contents of the customer information data structure, in step 1081, the Business Workflow Service 1031 (shown in FIGS. 10C, 10D and 10F), generates or determines a distinctive workflow instance comprising a sequence of one or more interactions, potentially including one or more transactions or information inquiries, involving at least one legacy system located in the logical legacy system layer of the infrastructure. In an embodiment of the present invention, the integrated customer information store may, for processing speed or other efficiency reasons, be distributed among several physically separate machines or nodes. In such an arrangement, the data associated with a customer who lives in one region or territory, such as the West Coast, may physically reside on a node that is located in or near that region or territory. Consequently, accessing the data associated with a West Coast customer may require that the system invoke a different set of interactions or function calls, or a different set of network addresses, than the interactions, functions calls or addresses used to access the data associated with an East Coast customer. Thus, the sequence of interactions in a workflow instance for a service request involving a West Coast customer would be different from the sequence of interactions in a workflow instance for a service request involving an East Coast customer.

Continuing with FIG. 10H, in step 1082, the system manager then passes the workflow instance to an interaction monitor service, which monitors the performance of each interaction in the workflow instance. In the embodiment depicted in FIGS. 10C-10F, processing then continues at step 1083 of FIG. 101 by way of flowchart connector P6, where the interaction monitor service selects an interaction from the workflow instance for execution and passes the name of the selected interaction to the system manager. The system manager retrieves, from a services index, the location, syntax and input and output parameters for the interaction. When the interaction is a function call to execute the selected interaction on a legacy system located in the logical legacy system layer, the system manager in step 1084 retrieves the location, syntax and input and output parameters to execute the legacy system function call. In the next step, step 1085 of FIG. 101, the system manager retrieves the actual arguments (data values) needed to make the function call. In an embodiment, some of the actual arguments may be retrieved from the customer information data structure, from other legacy systems, or both. Next, in step 1086, the system manager calls the function which, in step 1087, the legacy system executes and returns a function output. In embodiments, the steps of calling the function and returning the result involve the transmission of electronic, radio or optical signals encoding the appropriate information, using TCP/IP or other data communications protocols.

In the embodiment depicted in FIGS. 10C-10F, the function output is then tested (at step 1088 of FIG. 101) to determine whether it is valid. If the function output is invalid, the system in step 1089 then determines whether an exception condition exists. If an exception condition exists, the infrastructure could be configured, as depicted in FIG. 101, to ignore the invalid function output and continue processing at step 1083, where the interaction monitor service selects another interaction for execution. Alternatively, the infrastructure could be configured to terminate or execute one or more other steps (not depicted in FIG. 101) when the function output is determined to be invalid and there is an exception condition.

The invalid function output and exception condition situation could occur, for example, in a scenario where a service request available to a bank customer is “buy stock using funds from checking account.” For such a service request, the first interaction in a workflow instance might comprise a function call to retrieve the balance of the customer's checking account. If there is an insufficient amount of money to purchase the amount of stock requested, this function call would in many cases return an invalid function output. The customer that is the subject of the service request may, however, have status or relationship with the bank such that he can engage in certain transactions even when there are not enough funds in his checking account to cover the transactions. This could be the case, for example, if the customer had established a line of credit or “overdraft protection” with the bank or, as another example, the customer owned a business that was itself a creditworthy customer of the bank. In an embodiment, such a customer status or relationship could be designated as an exception condition, which would allow processing of the service request to proceed despite the invalid function output caused by an insufficiency of funds in the customer's checking account.

In an embodiment where the workflow instance involves a sequence of interactions, the infrastructure of the present invention may, as shown in step 1091 of FIG. 101, be configured to reverse all previous interactions in the workflow instance and register an error condition if the function output is invalid and no exception condition exists. In an embodiment, the interaction monitor service directs this reversal where it detects an invalid function output in the absence of an overriding exception condition.

Returning now to step 1088 of the embodiment depicted in FIGS. 10G-10J, if the function output is valid, control passes to step 1090, where the interaction monitor service determines whether the just-executed interaction was the last interaction in the workflow instance. If the just-executed interaction was not the last interaction in the workflow instance, then control returns to step 1083 of FIG. 101, where the interaction monitor service selects another interaction from the workflow instance for execution. If, however, the just-executed interaction was the last interaction in the workflow instance, then control passes to step 1092 of FIG. 10J by way of flowchart connector P7, where, based on the function outputs of the interactions in the workflow instance, the interaction monitor service generates a return value for the selected service request and sends it to the system manager. Then, in step 1093, the system manager passes the return value to the webserver in the logical device server layer, which passes it to the interface channel in the logical device layer, where it is displayed to the user (step 1093). The passing of information between devices and components in the device server layer and the logical device layer is, in embodiments, accomplished using electronic data transmission techniques and technologies using TCP/IP or other data communications protocols. From there, control returns to step 1075 of FIG. 10H by way of flowchart connector P8, where, in the embodiment depicted in FIGS. 10G-10J, the interface channel again displays to the user a personalized menu of service requests available for the user.

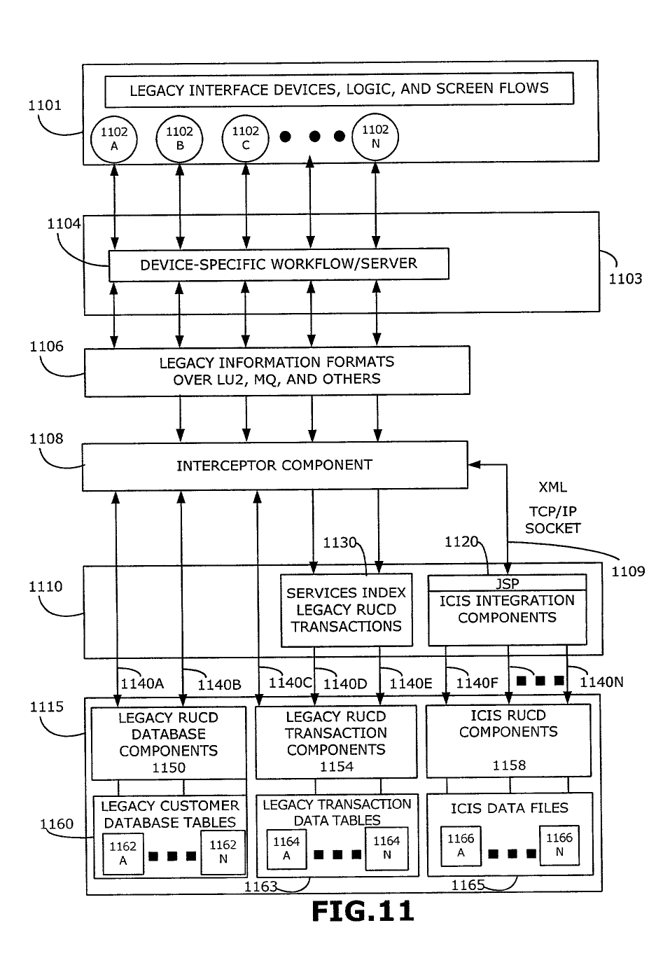

FIG. 11 shows an embodiment of the present invention including a customer information management infrastructure with an Interceptor Component 1108 to facilitate the migration of customer data from legacy systems serving as individual systems of record to an ICIS as the system of record thereby also facilitating on-line, real-time access to customer information and on-line, real-time creation, updating and deletion of customer information. In the embodiment shown in FIG. 11, Logical Legacy System Layer 1115 comprises Legacy RUCD Database Components 1150, Legacy RUCD Transaction Components 1154, ICIS RUCD Components 1158, Legacy Customer Database Tables 1162A-1162N, Legacy Transaction Data Tables 1164A-1164N, and ICIS Data Files 1166A-1166N. Logical Appserver Layer 1110 comprises Services Index 1130 for legacy RUCD transactions, and ICIS Integration Components 1120.

In the embodiment illustrated in FIG. 11, when an instruction to read, create, update or delete customer information flows down from the Logical Device Server Layer 1103 via Legacy Information Formats 1106, Interceptor Component 1108 intercepts the instruction before it reaches Logical Appserver Layer 1110, and determines whether the system of record for the request or instruction resides in the Legacy Customer Database Tables 1162A-1162N or the ICIS Data Files 1166A-1166N. If the system of record is one of the Legacy Customer Database Tables 1162A-1162N, then Interceptor Component 1108 routes the instruction to the legacy RUCD database components for further processing. If, on the other hand, Interceptor Component 1108 determines that the system of record for the instruction is the ICIS, then Interceptor Component 1108 converts the instruction to XML and routes the instruction to ICIS Integration Components 1120 via TCP/IP Connection 1109. ICIS Integration Components 1120, in turn, routes the instruction to ICIS RUCD Components 1158, which include program logic or instructions to perform operations, such as reading, updating creating and deleting customer information records against the data contained in the ICIS data files 1166A-1166N.

In an embodiment, ICIS Integration Components 1120 comprises high-level customer data manipulation functions, such as “get_customer_info( ),” which returns in one function call the information about a particular customer stored in the ICIS Data Files 1166A-1166N. In such an embodiment, ICIS RUCD Component 1158, on the other hand, is comprised of low-level functions, such as “change my profile” or “change my address.” Integration Component 1120 “integrates” the low-level read, update, create and delete components into higher-level business functions so that a user only has to initiate the high-level function call once, thereby preferably retrieving into a fast caching area the information about a particular customer, and avoiding the necessity of invoking multiple low-level function calls such as “get_cust_profile( ),” “get_cust_preferences( )” and “get_cust_addresses( ).”

In an embodiment, there is a real-time or batch process connection (not shown in FIG. 11) which synchronizes modifications to the data in Legacy Customer Database Tables 1162A-1162N with the data in ICIS Data Files 1166A-1166N. In an embodiment, the synchronizations would occur until ICIS Data Files 1166A-1166N becomes the system of record for all customer information data.

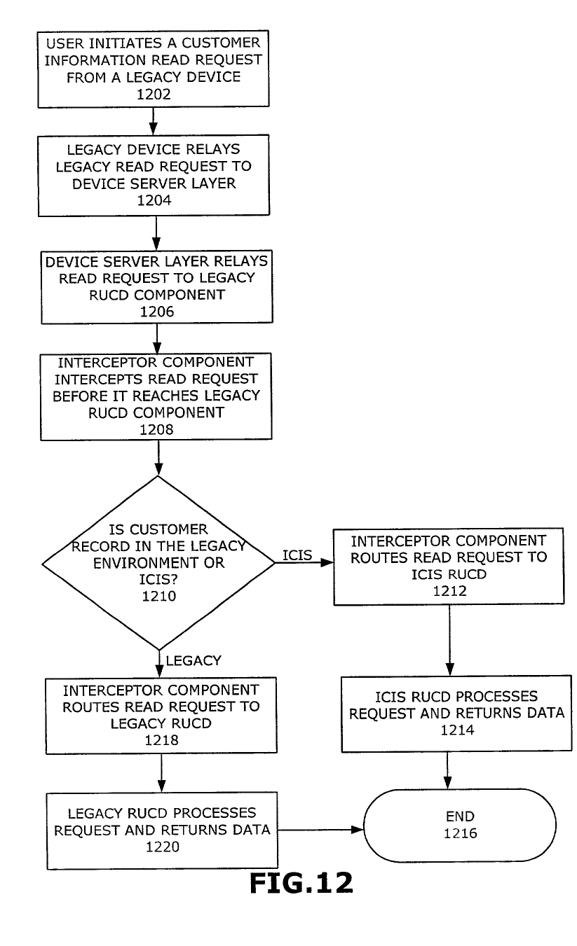

FIG. 12 is a data flow diagram illustrating the steps performed by a CIMI according to an embodiment of the present invention in response to a request or instruction to read a customer record. First, in step 1202, the user initiates a customer information read request from a legacy device. In step 1204, the legacy device relays the read request to the logical device server layer. The logical device server layer relays the read request to the legacy read, update, create and delete component, step 1206. Next, in step 1208, the interceptor component intercepts the read request before it reaches the legacy RUCD component. Then, in step 1210, the interceptor component determines whether the customer record is in the legacy environment or the integrated customer information store (ICIS). If the customer record is in the ICIS environment, processing continues at step 1212, where the interceptor component routes the read request to the ICIS RUCD. The ICIS RUCD then processes the request and in step 1214, returns the data, and processing ends at step 1216. Returning now to step 1210, if the system of record for the customer information is in the legacy environment, then processing continues at step 1218, where the interceptor component routes the read request to the legacy RUCD. Then in step 1220, the legacy RUCD processes the request and returns the data up through the infrastructure. From there processing ends at step 1216.

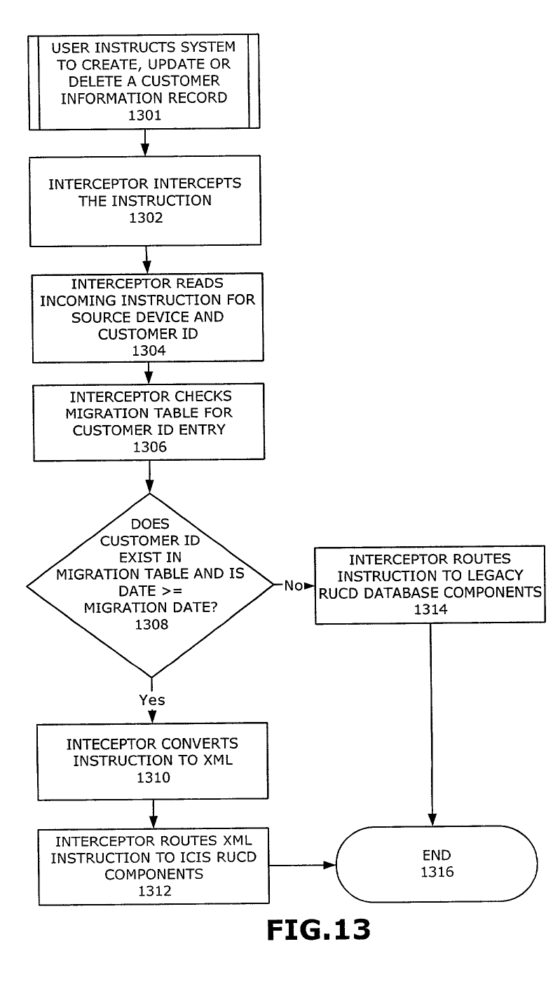

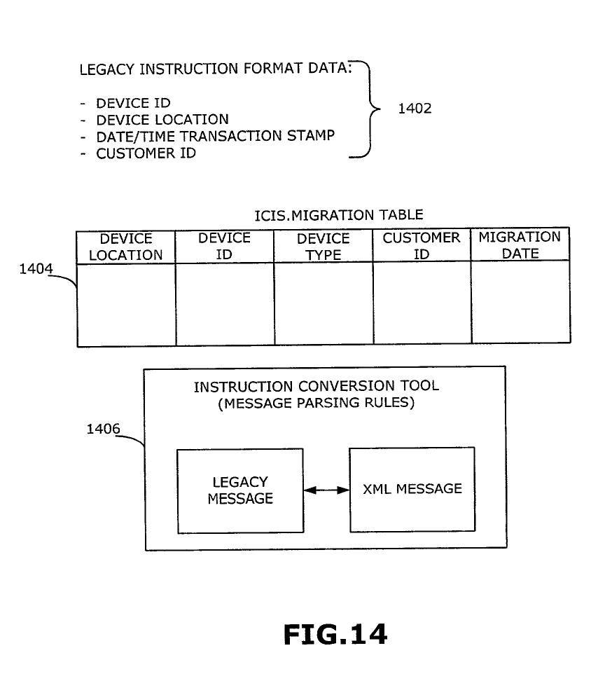

FIG. 13 is a data flow diagram illustrating the steps performed by a CIMI according to an embodiment of the present invention in response to a request or instruction to create, update or delete a customer information record. First, in step 1301, the user instructs the system to create, update or delete a customer information record or otherwise initiates a function or activity that requires creating, updating or deleting a customer information record. Such a function or activity might be needed, for example, when a user helps a customer open a new account or change the mailing address on an existing account. As the instruction is sent down through the infrastructure, the interceptor component intercepts the instruction, step 1302. Next, in step 1304, the interceptor component reads the incoming instruction for the source device and customer I.D. information. At step 1306, the interceptor component checks a migration table (described in more detail with reference to FIG. 14 below) for the customer I.D. entry. The system then determines, at step 1308, whether the customer I.D. exists in the migration table and whether the transaction date is later than the migration date for the ICIS system or the customer. If the migration date has passed, then the interceptor, at step 1312 converts the instruction to an XML instruction, and routes the XML instruction to the ICIS RUCD components. Then processing ends at step 1316. If the migration date has not passed, then processing goes from step 1308 to step 1314, where the interceptor routes the instruction to the legacy RUCD database components. Then processing ends at step 1316. In other embodiments, the determination of whether a legacy system or an ICIS is the system of record may also depend on the type of transaction or interaction.

FIG. 14 depicts an example of a migration table data structure that might be used (as in step 1308 of FIG. 13, for example) to determine whether to create, update or delete in the legacy customer information store or the ICIS in an infrastructure configured according to the present invention. In an embodiment, the migration table data structure would include fields for the device I.D., the device location, the date, time and transaction stamp and a customer I.D. (see 1402 and 1404 in FIG. 14). In an embodiment, an Instruction Conversion Tool 1406 is used to convert legacy messages to XML messages, and vice-versa. In other embodiments the migration table would also include fields for the transaction or interaction type.

For large enterprises, even before the ICIS becomes the system of record for all customer information, the challenges of reading, updating, creating and deleting information stored in the ICIS can be significant. As discussed above, enterprises may be interested in storing and retrieving a large number of types of information about each customer or potential customer. In the context of a bank or other financial services institution, this may include, in addition to name, address and account information, demographic information, information about the customer's relationships with other customers, and information about the customer's relationships with the institution's officers and employees. In an embodiment of the present invention, the ICIS may store up to 5,000 data elements or more in connection with each customer.

Large enterprises, again such as banks or financial institutions, may also be interested in storing and using each of these data elements for each existing or potential customer. A nationwide retail bank, for instance, could have more than 100 million customers and business prospects. Thus, if each data element is 30 characters long, for example, then the amount of data the enterprise would need to store and make available to all users across the entire enterprise for reading, updating and deleting could exceed tens of terabytes.

Some enterprises also need to read, update, create and delete customer information in essentially real time. Large retail banks, for example, can encounter transactions requiring access to customer information at rates of approximately 500 transactions per second up to and exceeding 10,000 transactions per second. Such transactions can include ATM transactions, credit card purchases, on-line balance inquiries and funds transfers, marketing presentations, investment transactions using funds in the same or other banks, mortgage loan approvals and payments, and many other types of transactions.

Moreover, if the bank or other enterprise has customers and offices and other facilities nationwide, the requests to read, update, create and delete customer information can be expected to come from widely distributed sources. In the context of a bank, for example, a customer who normally lives and banks in North Carolina may need to use an ATM or otherwise deal with a bank branch in another location, such as California. The customer may well expect the California location to respond to her inquiries and handle transactions in much the same ways, and within the same processing times, as her “home” North Carolina locations.

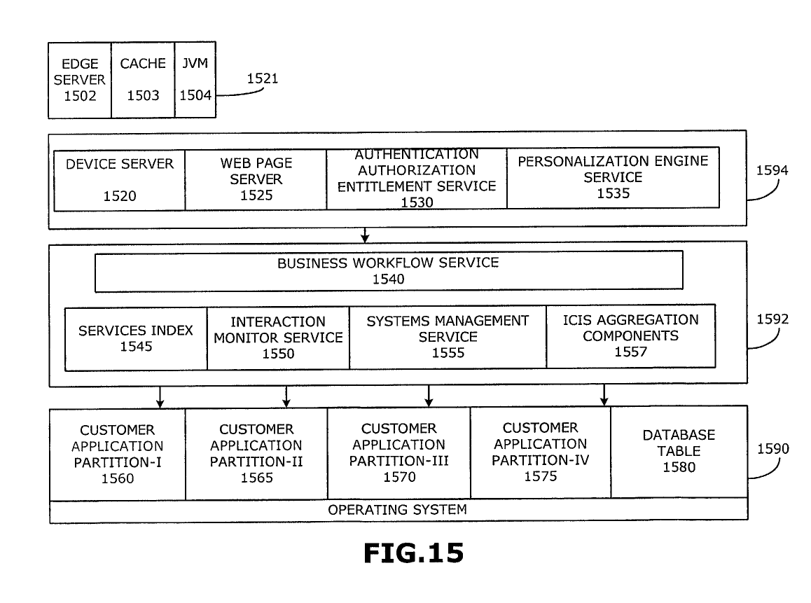

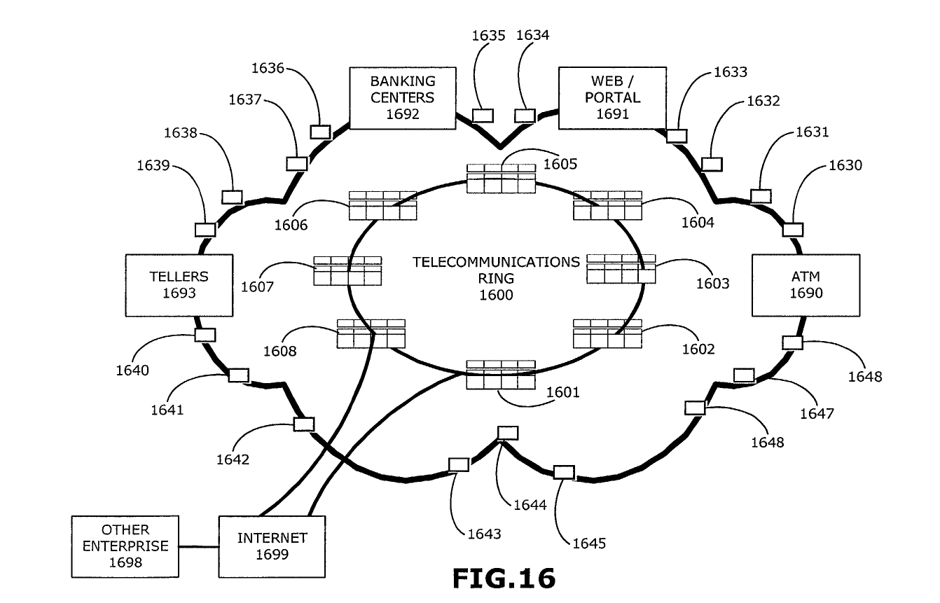

FIGS. 15 and 16 depict an embodiment of a method and system for providing essentially real time access to a large-scale ICIS or other data store. In the embodiment depicted in FIGS. 15 and 16, the ICIS or other large-scale data store is comprised of a large number of customer information files, each including a large number of data elements, and each corresponding to a customer. In an embodiment, there may be a file for each of 100 million or more customers, with each file having up to 5,000 or more data elements. In other embodiments, there may be files for fewer or more customers, including fewer or more data elements.

FIG. 15 depicts an example of an embodiment for a retail bank of a logical structure for an ICIS. As depicted in FIG. 15, the customer information files of ICIS 1590 are stored in Database Table 1580, which may be implemented using DB2 or other database management system or an appropriate platform. In the embodiment depicted in FIG. 15, access to Database Table 1580 is provided through logical partitions operating under an operating system such as UNIX. In this embodiment, there are four such partitions—Customer Application Partition-I 1560, Customer Application Partition-II 1565, Customer Application Partition-III 1570 and Customer Application Partition-IV 1575. These partitions reflect different types or tiers of customers depending, for example, on the nature of the customer (e.g., individual or business) or the volume of the customer's present or potential business. Customers in different tiers may have access to different services and different types of information.

In an embodiment of the present invention, ICIS 1590 depicted in FIG. 15 is an example of and corresponds to ICIS 1049 depicted in and described with reference to FIG. 10B. This correspondence also illustrates how, in the present invention, an ICIS or other new transaction service or database can be structured, accessed, updated and otherwise treated and handled in the same manner as conventional “legacy” systems and services.

In an embodiment of the present invention, the ICIS or other large data store is designed to be accessed from a variety of devices. For example, in the context of a bank or other financial institution, the ICIS is configured to be accessed from devices such as ATMs, computers and specialized teller machines, which may be used to read, update, create and delete customer information in the ICIS. In an embodiment of the invention depicted in FIG. 15, Logical Device Server Layer 1594, comprising Device Server 1520, Web Page Server 1525, Authentication/Authorization Entitlement Service 1530 and Personalization Engine Service 1535, provides this functionality. In an embodiment, these components and services provide Web Server functionality using conventional web servers. Thus, in such an embodiment, various devices are perceived and used by users to interact with the ICIS employing familiar web-based techniques and technologies. In an embodiment, Logical Device Server Layer 1594 and its constituent components and services correspond to Logical Device Server Layer 1020 and its constituent components depicted in and described with reference to FIG. 10A.

Enterprises seeking to use an ICIS or other large data store as the “official” or “system of record” for customer information may also employ specialized server infrastructures for various types of devices used historically to read, update and delete customer information records. For example, many banks historically have developed separate infrastructures to support devices such as ATMs, personal computers for on-line banking services and specialized teller machines, and their supporting networks. In an embodiment of the present invention in which ICIS 1590 constitutes the system of record for the customer information of an enterprise, Logical Device Server Layer 1594 and its services and systems replace those separate and specialized infrastructures.

In the embodiment depicted in FIG. 15, both Logical Device Server Layer 1594 and ICIS 1590 communicate with Logical AppServer Layer 1592, which includes Business Workflow Service 1540, Services Index 1545, Interaction Monitor Service 1550, Systems Management Service 1555 and ICIS Aggregation Components 1557. This communication can be implemented using electronic, radio, optical or other signal transmission techniques and technologies using data communication protocols, such as TCP/IP. As depicted in FIG. 15, Logical AppServer Layer 1592 and its component systems and services correspond to Logical AppServer Layer 1030 as depicted in and described with reference to FIG. 10B.

The embodiment depicted in FIG. 15 of Logical Device Server Layer 1594, Logical AppServer Layer 1592 and ICIS 1590 may thus be viewed as illustrating part of the CIMI depicted in FIGS. 10A and 10B. Correspondingly, in the embodiment depicted in FIG. 15, Logical Device Server Layer 1594, Logical AppServer Layer 1592 and ICIS 1590 communicate with and transfer data between each other in manners and protocols similar to those used for communication and data transfer between Logical Device Server Layer 1020, Logical AppServer Layer 1030 and Logical Legacy System Layer 1042 of FIGS. 10A and 10B.

In a large organization, it may not be feasible or economical to store and access very large amounts of information on a very large number of customers at a single physical location for an ICIS, while still providing acceptable speeds for reading, creating, updating and deleting customer information records. In an infrastructure of the present invention useful for a large bank or other large organization, customer information files may be segmented or distributed among a number of nodes in a network. In a large bank or other large organization with customers at widely distributed locations, the customer information files may be segmented and distributed based on the customer's home or business address, for example, so that files stored at a given node relate to customers from the same geographic area. Other methods and criteria for segmenting and distributing a large number of data files among nodes in a network suitable for use with the present invention may depend on factors such as the size and number of the files, the requirements for transferring and accessing the files, the distribution of users needing access to the files, and the configuration of the network.

FIG. 16 depicts an arrangement in which customer information files are distributed among nodes in a network arranged and connected in a ring structure, Telecommunications Ring 1600, including Nodes 1601-1608. In such an arrangement, customer files at a node could also be copied and distributed to an adjacent or other node or other location for redundancy and backup purposes. As depicted in FIG. 16, Nodes 1601-1608 are connected by telecommunications facilities, such as optic fiber network technology, which provides high speed connection and data telecommunications among the nodes. As depicted in FIG. 16, Nodes 1601-1608 are also connected by the telecommunications facilities to the Internet 1699; each of Nodes 1601-1608 is accessible to and from each other node, as well as other systems and devices on Internet 1699 according to conventional or standard Internet access, routing and telecommunications protocols. In the embodiment depicted in FIG. 16, Internet 1699 may also interconnection Other Enterprise 1698 with Telecommunications Ring 1600, providing access to and from an ICIS of Other Enterprise 1698. In other embodiments the ICIS of another enterprise may be operated as a node on Telecommunications Ring 1699. In other embodiments, the ICIS and published services of each of a number of organizations may be interconnected and available across organizations and enterprises using the infrastructure of the present invention.

As depicted in FIG. 16, each of Nodes 1601-1608 has substantially identical logical and functional capabilities. For example, each Node 1601-1608 could include a similarly configured ICIS 1590, Logical AppServer Layer 1592 and Logical Device Server Layer 1594 (as depicted in and described with reference to FIG. 15), with ICIS 1590 for each node including the segmented customer information files distributed to that node. In such configurations, each transaction service or information service could be viewed as if it were a web-based service, because each service is provided by web servers based on a URL or other comparable addressing scheme.

In the configurations depicted in FIGS. 15 and 16, requests by customers or other users for transactions or information can efficiently be directed to the locations appropriate for the particular request. For example, requests initiated at a device such as an ATM that is local to the node where the customer's information is stored would ordinarily be handled directly by that node. If the customer is away from her “home” node, and uses an ATM device “local” to a “remote” node, the configuration depicted in FIGS. 15 and 16 does not require a search of the data files at that “remote” node. Rather, Authentication/Authorization/Entitlement Service 1530 of the “remote” node would provide a URL address of the customer information service of the customer's “home” node, so that needed data would be provided efficiently.

In a very large organization that needs to read, update, create and delete records on tens of millions of customers at speeds of 500 or more times a second, or approaching or exceeding 10,000 times a second, additional efficiencies may be necessary or desirable. As depicted in FIGS. 15 and 16, for example, additional efficiencies are provided by Edge Servers 1630-1648, each of which operates as an extensible cache. When a device (such as ATM 1690, a computer at Banking Center 1692 a computer connected through Web/Portal 1691 or a device used by Teller 1693 in the context of a bank or other financial institution requests customer information, following the initial run-time load call to the ICIS, that information is stored in the closest available edge server to the requesting device (which more generally may be devices at a point of presence, an office or other location)). Thus, ICIS customer information is stored, during an interactive session, on distributed cache servers.

As depicted in FIG. 15, Edge Server platform 1521 includes Edge Server 1502, Cache 1503 and JVM 1504. Edge Server 1502 provides processing functionality for interactive transactions or sessions, as described above. Cache 1503 provides cache memory for storing customer information during transactions or interactive sessions, as described above. JVM 1504 depicts one or more Java Virtual Machines within the confines of Edge Server platform 1521. In the context of a bank transaction requiring processing of a relatively large file, such as a file holding the image of a check, use of JVM 1504 for example allows the bank to move the functionality for check image viewing into Edge Server platform 1521 as a set of stored functions, thereby reducing the time required to view check images.

The designation of an ICIS as the system to record for all or a designated set of information about each customer also presents at least two additional challenges. First, the requisite information on each customer needs to be collected in a timely fashion from the relevant legacy systems. Second, the enterprise needs to be assured that the “right” information is associated with each customer. This latter challenge may be particularly substantial given a likelihood, for example, that the same customer may be identified in different legacy systems by different names, or that there are individual customers who use more than one address and a number of different customers with the same name.

Many companies have tried to address these challenges by embarking on programs designed to produce a company-wide means of individually identifying their customers. This usually involves creating a unique identifier for every customer of the company and requiring that the unique identifier be used by every system within the company. This approach often necessitates changing legacy systems in order to access and use the new customer identifier, and changing customer set-up programs to retrieve the customer identifier from a central source location. The result of this process is that companies typically cannot accurately read, update, create, and delete customer information throughout their enterprise or provide a consistent, comprehensive view of the customer's information.

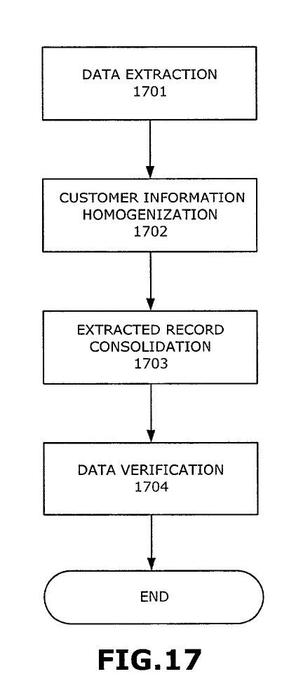

In an embodiment of the infrastructure of present invention, these difficulties are addressed by extracting customer information data from the legacy transaction systems and creating a consolidated customer information file, which is stored in an ICIS. FIG. 17 depicts an example of a process for extracting data from disparate legacy systems that possess customer information, and creating a consolidated customer information file under a single customer identifier. As depicted in FIG. 17, in step 1701, data, such as customer records from one or more legacy transaction and information systems, is extracted from those systems and placed on a data storage medium, such as data storage tape or other medium. Data may also be extracted from other information sources, such as customer information clearing houses, such as Acxiom, Inc., of Little Rock, Ark., or Harte-Hanks of San Antonio, Tex.

In many situations, step 1701 results in the extraction of large numbers of data records taken from numerous sources. In step 1702, information extracted from the legacy systems and other sources pertaining to each individual customer is homogenized, such that redundancies are eliminated and inconsistencies are resolved. Also as part of step 1702, a consistent customer identifier is assigned to the data records of each customer. Other methods and criteria for consolidating and homogenizing data from separate data files suitable for use with the present invention may depend on such factors as the number and size of the files, the differences and similarities in file structure and data format, the amount and format of the information to be added to information from legacy systems, the structure of the files resulting from the homogenization process, and the requirements for accessing those files.

As depicted in FIG. 17, following step 1702 is step 1703, in which all of the data records associated with a single customer identification number are consolidated to form a single customer information record for each unique customer identification number. In a customer information file, data from the disparate legacy systems and other sources is consolidated and stored under a unique customer identification for each customer. Thus, in an embodiment of the invention, a single file is created containing detailed information about customers that was previously spread over a wide variety of systems and data formats and environments.

As depicted in FIG. 17, in an embodiment of the invention, in step 1704, data contained in the consolidated customer information file is verified against an information clearing house, and between the legacy systems. This verification may also occur in other ways, such as by client representatives or the customers themselves in the course of using the customer information file.

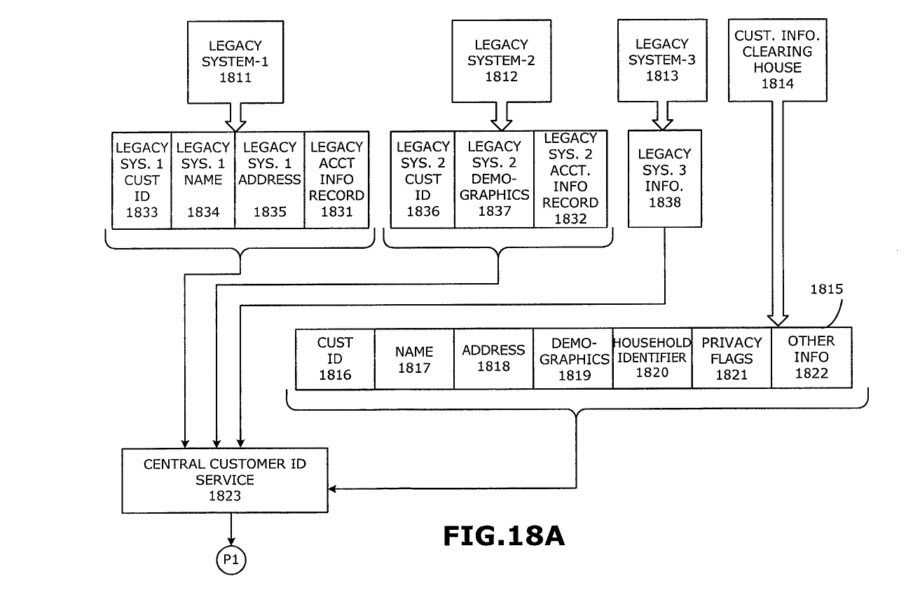

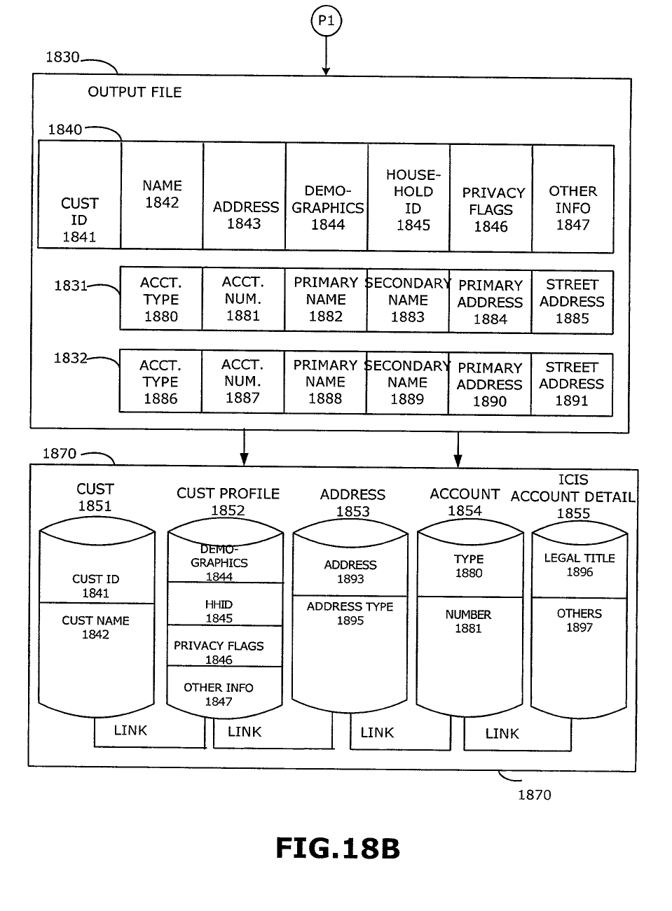

FIGS. 18A and 18B depict an embodiment of the process depicted in FIG. 17 and described above, providing additional detail regarding the structure and content of the data records involved. Thus, as depicted in step 1701 of FIG. 17, account information is extracted from various legacy systems, shown at 1811, 1812, and 1813. While the information extracted from the legacy systems will vary with the context in which the invention is implemented, in the context of a bank, for example, the information may include customer identification numbers, names, addresses, account numbers and the like. Thus, in an embodiment, the information extracted from Legacy System-1 (1811) includes Customer ID 1833, Name 1834, Address 1835, and Account Information Record 1831, the contents of which are described in more detail below. Similarly, information extracted from Legacy System-2 (1812) includes Customer ID 1836, Demographics 1837, and Account Information Record 1832. Further, Legacy System-3 (1813) may contain additional information 1838 that will be extracted as well. Large organizations may have many such legacy systems, from which data may be extracted.

In addition to legacy systems, data may be extracted from other sources, depicted as Customer Information Clearing House 1814. From Customer Information Clearing House 1814, Customer Information Record 1815 is extracted, which includes several data elements, such as Customer Identification Number 1816, Customer Name 1817, Customer Address 1818, Demographics 1819, Household Identifier 1820, Privacy Flags 1821, and Other Information 1822.

In the embodiment depicted in FIG. 18A, the extracted information is then passed through a Central Customer Identification Service 1823, in which the data is homogenized and consolidated according to a predetermined algorithm, as described in FIG. 17 with respect to steps 1702 and 1703. For example, a single customer may have a different customer identification number for his accounts in each legacy system. The homogenization algorithm may discard all but one of those customer identification numbers, and associate that single identification number with all information about that customer.

Furthermore, this algorithm may also homogenize the address information, for example. In the context of a bank, for example, different addresses may appear on different accounts for a single customer. In a trust account, for instance, the address record in the legacy system may be the trust-holder's address, such as an attorney, rather than the customer's address. Also, certain account records may include address information that is out of date. Thus, the homogenization algorithm may ensure that the trust-holder address is not confused with the customer address. Finally, the homogenization algorithm may discard out-of-date addresses.

In the embodiment depicted in FIGS. 18A and 18B, after the data is homogenized, the consolidation algorithm generates Output File 1830, which includes Account Information Records 1831 and 1832, as well and Homogenized Customer Information Record 1840. Account Information Record 1831, responsive to account information from Legacy System-1 (1811), as described above, includes data elements, such as Account Type 1880, Account Number 1881, Primary Name 1882, Secondary Name 1883, Primary Address 1884, and Street Address 1885. Account Information Record 1832, responsive to Legacy System-2 (1812) includes similar data elements. Homogenized Customer Information Record 1840 includes Customer Identification Number 1841, Customer Name 1842, Customer Address 1843, Demographics 1844, Household Identifier 1845, Privacy Flags 1846, and Other Information 1847. In an embodiment, the data found in Homogenized Customer Information Record 1840 is the homogenized information, described above. Additional account information or other customer records may be included in Output File 1830. For example, Household Identifier 1845 or other data structures may be used to identify and store relationships between customers, users, businesses or parties, for example in the context of a bank to identify a prospective customer as a child of an existing customer, or one company as a subsidiary or supplier of another company with a longstanding business relationship with the bank.

In an example of an ICIS used with an embodiment of the infrastructure of the present invention, data drawn from Output File 1830 is used to populate Customer Information File 1870, so that Customer Information File 1870 contains detailed homogenized customer information derived from the data contained in Legacy System-1 (1811), Legacy System-2 (1812) and Legacy System-3 (1813), as well as from the data from Customer Information Clearing House 1814. Thus, in such an example, each Customer Information File 1870 includes Customer Record 1851, Customer Profile Record 1852, Address Record 1853, Account Record 1854, and ICIS Account Detail Record 1855. Customer Record 1851 includes Customer Identification Number 1841 and Customer Name 1842. Customer Profile Record 1852 includes Demographics 1844, Household Identifier 1845, Privacy Flags 1846, and Other Information 1847. Address Record 1853 includes Address 1893 and Address Type 1895.

A given customer may have several addresses relevant to his accounts, such as home and business addresses. Furthermore, certain types of accounts, such as trusts, may require information regarding the addresses of others, such as the trust holder. Thus, in an embodiment, Address Table 1853 may contain numerous Addresses 1893, each identified with a predetermined Addresses Type 1895. Account Record 1854 includes Account Type 1880 and Account Number 1881, as well as other relevant data regarding the account (not shown). Information regarding numerous accounts may be stored in Account Table 1854. In addition, ICIS Account Detail Record 1855 includes detailed account information, such as Legal Title 1896 and Other Information 1897. Each Customer Record 1851, Customer Profile Record 1852, Address Record 1853, Account Record 1854, and ICIS Account Detail Record 1855 may be linked together.

The bulk transfer of customer data, such as the population of Customer Information File 1870 with data drawn from Output File 1830, poses additional difficulties, particularly when implemented in environments with a large transaction volume or high transaction speeds, or both. Because CRM products typically are expected to function as integrated desktop application systems, using CRM integration tools for very large data volumes does not result in overall system performance levels that will operate effectively in on-line environments in large organizations. As currently implemented, CRM products are typically not capable of bulk transferring large amounts of customer data in a timely fashion.

In an embodiment of an infrastructure of the present invention, bulk transferring of customer information files into an ICIS is accomplished by means of a “sniffer,” that parses SQL requests. The sniffer translates the SQL requests into one or more stored processes which operate much more quickly than SQL function calls, thereby allowing the data transfer to occur much more quickly than the using standard CRM routines.

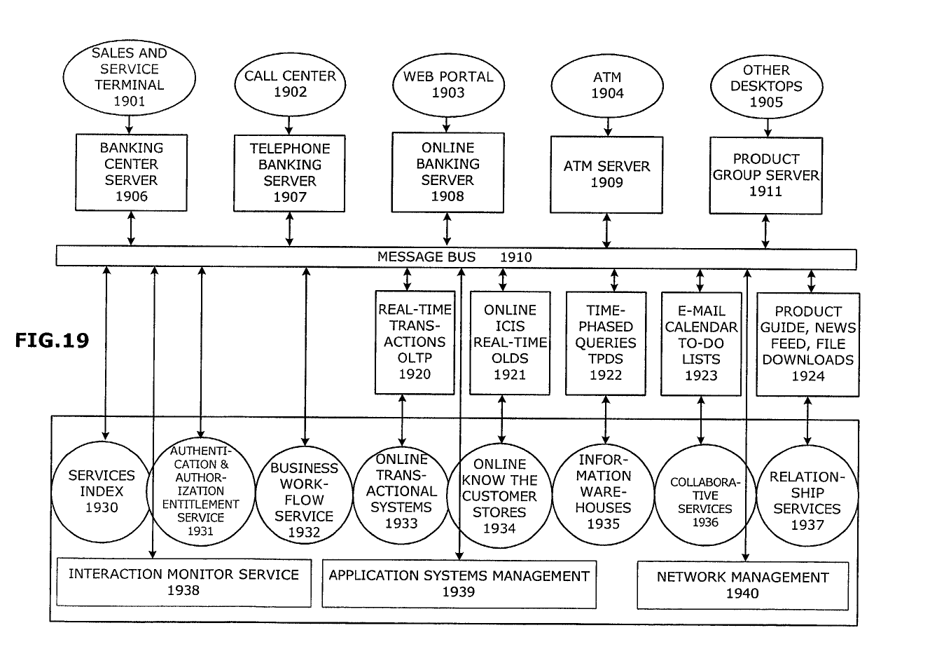

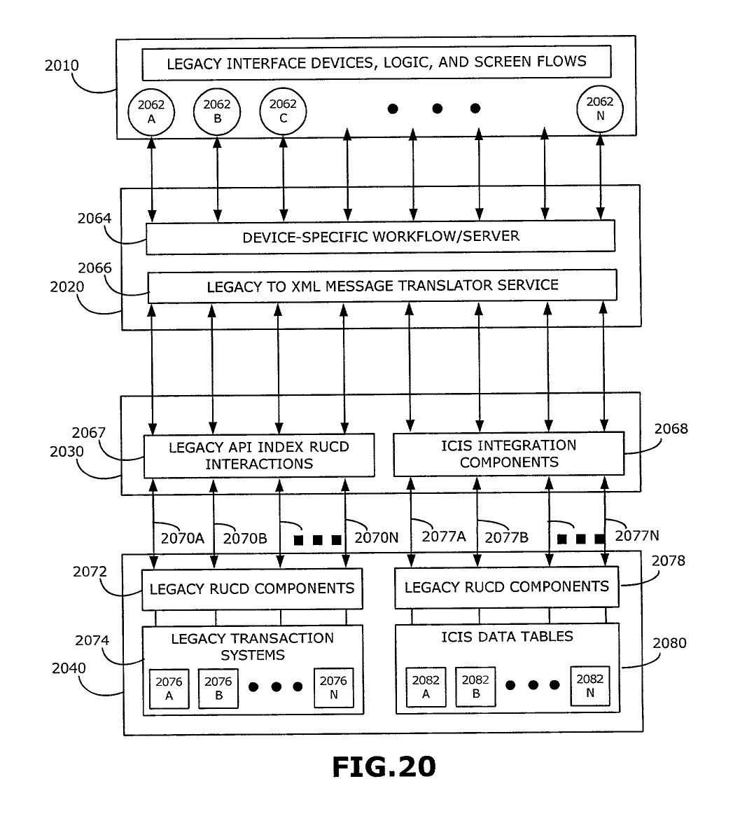

FIG. 19 shows the physical layout of an embodiment of an infrastructure of the present invention, such as the one depicted logically in FIGS. 10A, 10B and 20. As shown in FIG. 19, a number of physical interface devices (exemplified in FIG. 19 as Sales and Service Terminal 1901, Call Center 1902, Web Portal 1903, ATM 1904 and Other Desktops 1905) are connected to a number of servers (exemplified as Banking Center Server 1906, Telephone Banking Server 1907, Online Banking Server 1908, ATM Server 1909 and Product Group Server 1911). The servers are coupled to Message Bus 1910. Also coupled to Message Bus 1910 are a number of infrastructure services, including Services Index 1930, Authentication and Authorization Entitlement Service 1931 and Business Workflow Services 1932. A number of additional services, databases and online transaction systems, including Online Transactional Systems 1933, Online Know the Customer Store 1934, Information Warehouses 1935, Collaborative Services 1936 and Relationship Services 1937, are also coupled to Message Bus 1910 via a number of processes, including Real-Time Transaction OLTP (On-Line Transaction Processing) 1920, Online Real-Time OLDS (On-Line Decision Support) 1921, Time-Phased Queries TPDS (Time-Phased Decision Support) 1922, Email/Calendar/Todo Lists 1923 and Product Guide, News Feed, File Downloads 1924. In the embodiment depicted in FIG. 19, each server, each service, each database and each transaction processing system in the infrastructure communicates and exchanges information with each other server, service, database and transaction processing system in the infrastructure via Message Bus 1910, using electronic signals propagated, using the Message Bus, in an appropriate communications protocol for the sending and receiving servers, devices, databases and systems. In other embodiments, a broad range of devices, device servers, services, databases and transaction processing systems may be structured and interconnected using the infrastructure of the present invention.

With reference to FIG. 19, a service request initiated from any device in the infrastructure would be processed as follows: First, the device (e.g., ATM 1904) connects to Services Index 1930, which initiates Authentication and Authorization Entitlement Service 1931, Business Workflow Service 1932 and Interaction Monitor Service 1938. Authentication and Authorization Entitlement Service 1931 checks a profile identifier associated with the service request and verifies that the user (e.g., a customer, prospective customer, client manager or associate) who invoked the service request is entitled to and/or authorized to receive the requested service based on, for example, a predefined set of user “roles” as described above with reference to FIG. 7. Next, Business Workflow Service 1932, under the control of Interaction Monitor Service 1938, calls the appropriate service request (see 1920-1924 in FIG. 19). Finally, when the service component activities are complete, Business Workflow Services 1932 notifies Interaction Monitor Service 1938, which notifies the device. In embodiments, Interaction Monitor Service 1938, Applications Systems Management 1939 and Network Management 1940 also communicate with other programs, devices and processes in the infrastructure through Message Bus 1910.

FIG. 20 illustrates on one sheet all four logical layers of a CIMI in accordance with an embodiment of the present invention. In addition, the example shown in FIG. 20 illustrates an aspect of the invention that applies not only to banks and financial institutions, but to other types of businesses as well.

As depicted in FIG. 20, Logical Device Layer 2020 corresponds to Logical Device Layer 1010 of FIG. 10A, with devices 2062A-2062N of FIG. 20 corresponding to Process Bar 1011 and the other devices 1012-1018 of Logical Device Layer 1010 of FIG. 10A. Similarly, Logical Device-Server Layer 2020 of FIG. 20 corresponds to Logical Device-Server Layer 1020 of FIG. 10A, with Device-Specific Workflow/Server 2064 encompassing the functionality supported by Device Server 1021, LDAP Party Service 1023 and Personalization Engine Service 1024 of FIG. 10A, and Legacy to XML Message Translator Service 2066 providing the functionality supported by Web Server 1022 of FIG. 10A. As depicted in FIG. 20, Logical Appserver Layer 2030 corresponds to Logical Appserver Layer 1030 of FIG. 10B, with ICIS Integration Components 2068 corresponding to ICIS Integration Components 1035, and Legacy API Index RUCD Interactions 2067 supporting the functionality supported by Business Workflow Service 1031, Service Index 1032, Interaction Monitor Service 1033 and Systems Management Service 1034 of FIG. 10B. As further depicted in FIG. 20, Logical Legacy System Layer 2040 corresponds to Logical Legacy System Layer 1042 of FIG. 10B, with Legacy Transaction Systems 2074 (comprised of individual Systems 2076A-2076N) corresponding to Model Banking Platform 1051 and individual systems 1043A, 1043B, 1043D and 1044-1048 of FIG. 10B. In the embodiment depicted in FIG. 10B, Legacy RUCD Components 2072 are used to execute function calls called by Legacy API Index RUCD Interaction 2067 on individual legacy systems 2076A-2076N. In the embodiment in FIG. 20, Legacy RUCD Components 2078 are used to execute, read, update, create and delete instructions from ICIS Integration Components 2068 against ICIS Data Tables 2082A-2082N. In this embodiment, communication paths and protocols 2070A-2070N correspond to protocols and paths 1036-1038 of FIG. 10B, while communication paths and protocols 2077A-2077N correspond to paths and protocols 1039-1041 of FIG. 10B.

The depiction of FIG. 20 thus illustrates how a CIMI according to the present invention can also facilitate the implementation and distribution of new devices, systems and services. In the context of a bank, for example, and with reference to FIGS. 10A, 10B and 20, a new transaction service could readily be implemented in a Logical Legacy System Layer 2040 and integrated into the CIMI using the same interfaces and procedures used by legacy systems for interacting with the Appserver Layer 2030. The new service would thus have access to the same ICIS as legacy systems, under similar processes and procedures, and in at least some instances, the new service providers would not need to develop their own databases of customer information. In addition, to the extent that a CIMI according to the present invention provides “published” APIs and other techniques for interactions between Logical AppServer Layer 2030 and Logical Legacy System Layer 2040 a new system could take advantage of these “published” APIs and other techniques and could readily be located in Logical Legacy System Layer 2040. In this respect, the CIMI of the present invention changes the conventional concept of a legacy system to include any system—old or new—that is integrated into and operates with an ICIS system according to the CIMI architecture of the present invention.

The above-described preferred embodiments are intended to illustrate the principles of the invention, but not to limit its scope. Various other embodiments, modifications and equivalents to these preferred embodiments may occur to those skilled in the art upon reading the present disclosure or practicing the invention. Such variations, modifications and equivalents are intended to come within the scope of the invention.

What is claimed is:

1. A customer information management infrastructure, comprising:
an integrated customer information store comprising a multiplicity of customer information sets, each corresponding to one of a multiplicity of customers, wherein
responsive to each of a multiplicity of substantially simultaneous service requests, each service request pertaining to a selected customer of the multiplicity of customers, the customer information set corresponding to the selected customer determines, for each of a plurality of channels of the infrastructure,
a set of user-device interactions between a user and the infrastructure, and
a set of infrastructure-component interactions among a plurality of components of the infrastructure.

2. The infrastructure of claim 1, wherein the integrated customer information store is configured as a legacy system of the infrastructure.

3. The infrastructure of claim 1, wherein the multiplicity of customer information sets comprises more than about 10,000 customer information sets, and the multiplicity of customers comprises more than about 10,000 customers.

4. The infrastructure of claim 1, wherein the multiplicity of customer information sets comprises more than about 100,000 customer information sets, and the multiplicity of customers comprises more than about 100,000 customers.

5. The infrastructure of claim 1, wherein the multiplicity of customer information sets comprises more than about 1,000,000 customer information sets, and the multiplicity of customers comprises more than about 1,000,000 customers.

6. The infrastructure of claim 1, wherein the multiplicity of customer information sets comprises more than about 10,000,000 customer information sets, and the multiplicity of customers comprises more than about 10,000,000 customers.

7. The infrastructure of claim 1, wherein the multiplicity of customer information sets comprises more than about 50,000,000 customer information sets, and the multiplicity of customers comprises more than about 50,000,000 customers.

8. The infrastructure of claim 1, wherein the multiplicity of substantially simultaneous service requests comprises more than about 10 service requests per second.

9. The infrastructure of claim 1, wherein the multiplicity of substantially simultaneous service requests comprises more than about 100 service requests per second.

10. The infrastructure of claim 1, wherein the multiplicity of substantially simultaneous service requests comprises more than about 500 service requests per second.

11. The infrastructure of claim 1, wherein the integrated customer information store comprises one of a plurality of legacy systems in a logical legacy-system layer of the infrastructure.

12. The infrastructure of claim 1, wherein the plurality of components comprises a plurality of legacy systems, including the integrated customer information store, in a logical legacy-system layer of the infrastructure.

13. The infrastructure of claim 1, wherein the plurality of components comprises an authentication-and-authorization-entitlement service.

14. The infrastructure of claim 1, further comprising a logical device-server layer comprising an authentication-and-authorization-entitlement service.

15. The infrastructure of claim 13 or 14, wherein the authentication-and-authorization-entitlement service specifies a set of service requests available to the user.

16. The infrastructure of claim 15, wherein the set of service requests available to the user, in combination with the customer information set corresponding to the selected customer, determines the set of user-device interactions and the set of infrastructure-component interactions.

17. The infrastructure of claim 15, wherein presentation of the specified set of service requests is responsive to the channel of the infrastructure used for each service request pertaining to the selected customer.

18. The infrastructure of claim 13 or 14, wherein the authentication-and-authorization-entitlement service specifies a set of service requests available to the user responsive to a predetermined user role.

19. The infrastructure of claim 18, wherein the predetermined user role is selected by the user.

20. The infrastructure of claim 18, wherein the predetermined user role is selected by an administrator.

21. The infrastructure of claim 13 or 14, wherein the authentication-and-authorization-entitlement service specifies a set of service requests available to each of a multiplicity of users of the infrastructure.

22. The infrastructure of claim 21, wherein a different set of service requests is available to each of the multiplicity of users of the infrastructure.

23. The infrastructure of claim 21, wherein the set of service requests available to each of the multiplicity of users is presented to each of the multiplicity of users as web-published services.

24. The infrastructure of claim 1, further comprising a services index.

25. The infrastructure of claim 1, wherein one of the plurality of components comprises a services index.

26. The infrastructure of claim 1, further comprising a logical appserver layer comprising a services index.

27. The infrastructure of claim 24, 25, or 26, wherein
the set of infrastructure-component interactions comprises a legacy-system function call required to execute each service request pertaining to the selected customer, and
the services index stores information related to the legacy-system function call.

28. The infrastructure of claim 27, wherein the services index stores information, associated with the legacy-system function call, related to an address.

29. The infrastructure of claim 27, wherein the services index stores information, associated with the legacy-system function call, related to an input parameter for the legacy-system function call.

30. The infrastructure of claim 29, wherein the services index stores information related to a data format for the input parameter.

31. The infrastructure of claim 27, wherein the services index stores information, associated with the legacy-system function call, related to an output parameter of the legacy-system function call.

32. The infrastructure of claim 31, wherein the services index stores information related to a data format for the output parameter.

33. The infrastructure of claim 1, further comprising a business-workflow service.

34. The infrastructure of claim 1, wherein one of the plurality of components comprises a business-workflow service.

35. The infrastructure of claim 1, further comprising a logical appserver layer comprising a business-workflow service.

36. The infrastructure of claim 33, 34 or 35, wherein
the set of infrastructure-component interactions comprises a legacy-system function call required to execute each service request pertaining to the selected customer, and
the business-workflow service orchestrates execution of the legacy-system function call.

37. The infrastructure of claim 33, 34 or 35, wherein the business-workflow service, in combination with the customer information set corresponding to the selected customer, determines the set of infrastructure-component interactions.

38. The infrastructure of claim 36, wherein
the set of infrastructure-component interactions comprises a plurality of legacy-system function calls required to execute each service request pertaining to the selected customer, and
the business-workflow service orchestrates execution of the plurality of legacy-system function calls.

39. The infrastructure of claim 37, wherein the set of infrastructure component-interactions comprises a plurality of legacy-system function calls.

40. The infrastructure of claim 1, further comprising an interaction-monitor service.

41. The infrastructure of claim 1, wherein one of the plurality of components comprises an interaction-monitor service.

42. The infrastructure of claim 1, further comprising a logical appserver layer comprising an interaction-monitor service.

43. The infrastructure of claim 40, 41 or 42, wherein the interaction-monitor service monitors execution of at least one infrastructure-component interaction of the set of infrastructure-component interactions.

44. The infrastructure of claim 40, 41 or 42, wherein the interaction-monitor service monitors execution of each of the infrastructure-component interactions of the set of infrastructure-component interactions.

45. The infrastructure of claim 40, 41 or 42, wherein the set of infrastructure-component interactions requires execution of a logical legacy-system-layer interaction, and the interaction monitor service monitors performance of the logical legacy-system-layer interaction.

46. The infrastructure of claim 40, 41 or 42, wherein
the set of infrastructure-component interactions comprises a sequence of transactions,
the interaction-monitor service monitors execution of each of the sequence of transactions, and
responsive to a failure of one of the set of infrastructure-component interactions, the interaction-monitor service directs a reversal of each of the sequence of transactions executed prior to the failure.

47. The infrastructure of claim 46, wherein the sequence of infrastructure-component interactions comprises a sequence of logical legacy-system-layer interactions.

48. The infrastructure of claim 1, further comprising a system-management service.

49. The infrastructure of claim 1, wherein one of the components of the infrastructure comprises a system-management service.

50. The infrastructure of claim 1, further comprising a logical appserver layer comprising a system-management service.

51. The infrastructure of claim 48, 49, or 50, wherein the system-management service directs execution of at least one infrastructure-component interaction of the set of infrastructure-component interactions.

52. The infrastructure of claim 48, 49, or 50, wherein
the set of infrastructure-component interactions requires execution of a logical legacy-system-layer interaction, and
the system management service directs execution of the logical legacy-system-layer interaction.

53. The infrastructure of claim 48, 49, or 50, wherein
the set of infrastructure-component interactions requires execution of a plurality of logical legacy-system-layer interactions, and
the system management service directs execution of each of the plurality of logical legacy-system-layer interactions.

54. The infrastructure of claim 50, wherein
the logical appserver layer is configured to control execution of a plurality of logical legacy-system-layer interactions, and
the system management service is configured to manage, responsive to workload levels in the logical appserver layer, processing of the plurality of logical legacy-system-layer interactions.

55. A customer information management infrastructure, comprising
an integrated customer information store having a multiplicity of customer information sets, each customer information set corresponding to one customer of a multiplicity of customers;
a plurality of legacy systems;
a plurality of interface channels; and
a business-workflow service, configured to
receive a multiplicity of substantially simultaneous service requests, each service request made using one of the plurality of interface channels and each service request pertaining to a selected customer of the multiplicity of customers, and
create a distinct workflow instance responsive to each of the multiplicity of substantially simultaneous service requests, each distinct workflow instance based on the customer information set corresponding to the selected customer and comprising a sequence of interactions, at least one interaction in the sequence of interactions comprising a call to execute a function on one of the plurality of legacy systems.

56. The infrastructure of claim 55, wherein the customer information store is configured as one of the plurality of legacy systems of the infrastructure.

57. The infrastructure of claim 55, further comprising a logical appserver layer comprising the business-workflow service.

58. The infrastructure of claim 55, further comprising:
an interaction-monitor service configured
to monitor execution of the sequence of interactions, wherein the sequence of interactions comprises at least one transaction and
responsive to a failure of execution of one interaction of the sequence of interactions, to direct, in the absence of a predetermined exception condition, a reversal of each transaction of the sequence of interactions executed prior to the failure.

59. The infrastructure of claim 58, further comprising a logical appserver layer comprising the interaction-monitor service.

60. The infrastructure of claim 58, further comprising:
a services index configured to provide calling instructions for each interaction of the sequence of interactions.

61. The infrastructure of claim 58, further comprising a logical appserver layer comprising a services index configured to provide calling instructions for each interaction of the sequence of interactions.

62. The infrastructure of claim 60 or 61, wherein the calling instructions comprise at least one of the following:
a name associated with the interaction;
an address associated with the interaction;
a description of a set of calling parameters associated with the interaction; and
a language syntax for invoking the interaction.

63. The infrastructure of claim 55, wherein the multiplicity of customer information sets comprises more than about 10,000 customer information sets, and the multiplicity of customers comprises more than about 10,000 customers.

64. The infrastructure of claim 55, wherein the multiplicity of customer information sets comprises more than about 100,000 customer information sets, and the multiplicity of customers comprises more than about 100,000 customers.

65. The infrastructure of claim 55, wherein the multiplicity of customer information sets comprises more than about 1,000,000 customer information sets, and the multiplicity of customers comprises more than about 1,000,000 customers.

66. The infrastructure of claim 55, wherein the multiplicity of customer information sets comprises more than about 10,000,000 customer information sets, and the multiplicity of customers comprises more than about 10,000,000 customers.

67. The infrastructure of claim 55, wherein the multiplicity of customer information sets comprises more than about 50,000,000 customer information sets, and the multiplicity of customers comprises more than about 50,000,000 customers.

68. The infrastructure of claim 55, wherein the multiplicity of substantially simultaneous service requests comprises more than about 10 requests per second.

69. The infrastructure of claim 55, wherein the multiplicity of substantially simultaneous service requests comprises more than about 100 requests per second.

70. The infrastructure of claim 55, wherein the multiplicity of substantially simultaneous service requests comprises more than about 500 requests per second.

71. The infrastructure of claim 55, further comprising a logical legacy-system layer comprising at least one of the plurality of legacy systems, and wherein the integrated customer information store comprises one of the plurality of legacy systems of the logical legacy-system layer.

72. The infrastructure of claim 55, further comprising an authentication-and-authorization-entitlement service.

73. The infrastructure of claim 55, further comprising a logical device-server layer comprising an authentication-and-authorization-entitlement service.

74. The infrastructure of claim 72 or 73, wherein the authentication-and-authorization-entitlement service specifies a set of service requests available to the selected customer, responsive to the customer information set corresponding to the selected customer.

75. The infrastructure of claim 74, wherein presentation of the specified set of service requests is responsive to the one channel of the infrastructure used for the request pertaining to the selected customer.

76. The infrastructure of claim 72 or 73, wherein the authentication-and-authorization-entitlement service specifies a set of service requests available to a user of the infrastructure responsive to a predetermined user role.

77. The infrastructure of claim 76, wherein the predetermined user role is selected by the user.

78. The infrastructure of claim 76, wherein the predetermined user role is selected by an administrator.

79. The infrastructure of claim 72 or 73, wherein the authentication-and-authorization-entitlement service specifies a set of service requests available to each of a multiplicity of users of the infrastructure.

80. The infrastructure of claim 79, wherein a different set of service requests is available to each of the multiplicity of users of the infrastructure.

81. The infrastructure of claim 79, wherein the set of service requests available to each of the multiplicity of users is presented to each of multiplicity of users as web-published services.

82. The infrastructure of claim 55, further comprising a system-management service.

83. The infrastructure of claim 55, further comprising a logical appserver layer comprising a system-management service.

84. The infrastructure of claim 82 or 83, wherein the system-management service directs execution of at least one interaction of the sequence of interactions.

85. The infrastructure of claim 82 or 83, wherein
the sequence of interactions requires execution of a logical legacy-system-layer interaction, and
the system management service directs execution of the logical legacy-system-layer interaction.

86. The infrastructure of claim 82 or 83, wherein
the sequence of interactions requires execution of a plurality of logical legacy-system-layer interactions, and
the system management service directs execution of each of the plurality of logical legacy-system-layer interactions.

87. The infrastructure of claim 83, wherein
the logical appserver layer is configured to control execution of a plurality of logical legacy-system-layer interactions, and
the system management service is configured to manage, responsive to workload levels in the logical appserver layer, processing of the plurality of logical legacy-system-layer interactions.

88. A customer information management infrastructure comprising a plurality of components comprising:
an integrated customer information store configured as one of a plurality of legacy systems of the infrastructure and comprising a multiplicity of customer information sets, each customer information set corresponding to one of a multiplicity of customers;
an authentication-and-authorization-entitlement service;
a services index;
a business-workflow service;
a system-management service; and
an interaction-monitor service;
wherein, responsive to each of a multiplicity of substantially simultaneous sessions, each session pertaining to one of the multiplicity of customers,
the authentication-and-authorization-entitlement service specifies, for a user of the infrastructure, a set of service requests pertaining to the one customer;
the business workflow service determines, in combination with each of the set of service requests pertaining to the one customer and the customer information set corresponding to the one customer,
a set of user-device interactions between the user and the infrastructure, and
a set of infrastructure-component interactions, including at least one legacy-system function call, among a plurality of components of the infrastructure required to execute the service request;
the business-workflow service orchestrates execution of each legacy-system function call;
the services index stores information required to execute each legacy-system function call;
the system-management service directs execution of at least one infrastructure-component interaction of the set of infrastructure-component interactions; and
the interaction-monitor service monitors execution of each infrastructure-component interaction of the set of infrastructure-component interactions and, responsive to the presence of a transaction in the set of infrastructure-component interactions and a failure of one of the infrastructure-component interactions of the set of infrastructure-component interactions, directs a reversal of each transaction of the set of infrastructure-component interactions executed prior to the failure.

89. In a customer information management infrastructure comprising a plurality of logical-legacy-system-layer services and an integrated customer information store comprising a multiplicity of customer information sets, each customer information set corresponding to one of a multiplicity of customers, a method for processing one of a multiplicity of substantially simultaneous service requests, comprising the steps of:
receiving a user-identifier from a user;
generating, based on the user-identifier, a set of available service requests;
displaying the set of available service requests to the user;
accepting from the user a selected service request selected from the set of available service requests, the selected service request pertaining to a selected customer of the multiplicity of customers and comprising the one of the multiplicity of substantially simultaneous service requests;
determining, based on the selected service request and the customer information corresponding to the selected customer, a distinctive workflow instance comprising a sequence of interactions, at least one of the sequence of interactions in the sequence comprising a call to one of the plurality of logical-legacy-system-layer services to execute a function; and
executing each interaction in the sequence of interactions.

90. The method of claim 89, wherein the set of available service requests is displayed to the user according to a set of personal display preferences for the user.

91. The method of claim 90, wherein the set of personal display preferences for the user is determined by reference to the user-identifier.

92. The method of claim 89, further comprising the step of monitoring, using an interaction monitor service, execution of each interaction of the sequence of interactions in the distinctive workflow instance.

93. The method of claim 92, further comprising, if at least one of the sequence of interactions comprises a transaction, the step of directing a reversal of each previously-executed transaction in the sequence if one of the interactions in the sequence fails to execute in the absence of a predefined exception condition.

94. The method of claim 89, further comprising the step of using a services index specifying information required to make the call to execute the function.

95. The method of claim 94, wherein the information specified by the services index comprises an address required to make the call to execute the function

96. The method of claim 94, wherein the information specified by the services index comprises an input parameter required to make the call to execute the function.

97. The method of claim 96, wherein the information specified by the services index comprises a data format for the input parameter required to make the call to execute the function.

98. The method of claim 94, wherein the information specified by the services index comprises an output parameter required to make the call to execute the function.

99. The method of claim 98, wherein the information specified by the services index comprise a data format for the output parameter required to make the call to execute the function.

100. The method of claim 89, wherein the multiplicity of customer information sets comprises more than about 10,000 customer information sets, and the multiplicity of customers comprises more than about 10,000 customers.

101. The method of claim 89, wherein the multiplicity of customer information sets comprises more than about 100,000 customer information sets, and the multiplicity of customers comprises more than about 100,000 customers.

102. The method of claim 89, wherein the multiplicity of customer information sets comprises more than about 1,000,000 customer information sets, and the multiplicity of customers comprises more than about 1,000,000 customers.

103. The method of claim 89, wherein the multiplicity of customer information sets comprises more than about 10,000,000 customer information sets, and the multiplicity of customers comprises more than about 10,000,000 customers.

104. The method of claim 89, wherein the multiplicity of customer information sets comprises more than about 50,000,000 customer information sets, and the multiplicity of customers comprises more than about 50,000,000 customers.

105. The method of claim 89, wherein the step of displaying the set of available service requests is responsive to a channel of the infrastructure used to receive the user-identifier.

106. The method of claim 89, wherein the step of generating the set of available service requests is responsive to a predetermined user role.

107. The method of claim 106, wherein the predetermined user role is selected by the user.

108. The method of claim 106, wherein the predetermined user role is selected by an administrator.

109. The method of claim 89, further comprising the step of directing execution of at least one interaction of the sequence of interactions.

110. The method of claim 109, wherein the step of directing the execution of the at least one interaction is responsive to workload levels in a logical appserver layer of the infrastructure.

111. A customer information management infrastructure, comprising:
means for storing a multiplicity of customer information sets, each customer information set corresponding to one of a multiplicity of customers; and
means, for each of a plurality of channels of the infrastructure and, responsive to each of a multiplicity of substantially simultaneous service requests, each service request pertaining to a selected customer of the multiplicity of customers, for determining, based on the customer information set corresponding to the selected customer,
a set of user-device interactions between a user and the infrastructure, and
a set of infrastructure-component interactions among a plurality of components of the infrastructure.

112. The infrastructure of claim 111, wherein the means for storing the multiplicity of customer information sets is configured as a legacy system of the infrastructure.

113. The infrastructure of claim 111, wherein the multiplicity of customer information sets comprises more than about 10,000 customer information sets, and the multiplicity of customers comprises more than about 10,000 customers.

114. The infrastructure of claim 111, wherein the multiplicity of customer information sets comprises more than about 100,000 customer information sets, and the multiplicity of customers comprises more than about 100,000 customers.

115. The infrastructure of claim 111, wherein the multiplicity of customer information sets comprises more than about 1,000,000 customer information sets, and the multiplicity of customers comprises more than about 1,000,000 customers.

116. The infrastructure of claim 111, wherein the multiplicity of customer information sets comprises more than about 10,000,000 customer information sets, and the multiplicity of customers comprises more than about 10,000,000 customers.

117. The infrastructure of claim 111, wherein the multiplicity of customer information sets comprises more than about 50,000,000 customer information sets, and the multiplicity of customers comprises more than about 50,000,000 customers.

118. The infrastructure of claim 111, wherein the multiplicity of substantially simultaneous service requests comprises more than about 10 service requests per second.

119. The infrastructure of claim 111, wherein the multiplicity of substantially simultaneous service requests comprises more than about 100 service requests per second.

120. The infrastructure of claim 111, wherein the multiplicity of substantially simultaneous service requests comprises more than about 500 service requests per second.

121. The infrastructure of claim 111, wherein the means for storing the multiplicity of customer information sets comprises one of a plurality of computerized means for processing interactions located in a logical legacy-system layer of the infrastructure.

122. The infrastructure of claim 111, wherein the plurality of components comprises a plurality of computerized means for processing interactions, including the means for storing the multiplicity of customer information sets, in a logical legacy-system layer of the infrastructure.

123. The infrastructure of claim 111, wherein the plurality of components comprises a means for authenticating users and authorizing each service request.

124. The infrastructure of claim 111, further comprising a logical device-server layer comprising a means for authenticating users and authorizing each service request.

125. The infrastructure of claim 123 or 124, wherein the means for authenticating users and authorizing each service request specifies a set of service requests available to the user.

126. The infrastructure of claim 125, wherein the set of service requests available to the user, in combination with the customer information set corresponding to the selected customer, determines the set of user-device interactions and the set of infrastructure-component interactions.

127. The infrastructure of claim 125, wherein the infrastructure comprises a plurality of means for interfacing the user with the infrastructure, and presentation of the specified set of service requests is responsive to the interfacing means used for each service request pertaining to the selected customer.

128. The infrastructure of claim 123 or 124, wherein the means for authenticating users and authorizing each service request specifies a set of service requests available to the user responsive to a predetermined user role.

129. The infrastructure of claim 128, wherein the predetermined user role is selected by the user.

130. The infrastructure of claim 128, wherein the predetermined user role is selected by an administrator.

131. The infrastructure of claim 123 or 124, wherein the means for authenticating users and authorizing each service request specifies a set of service requests available to each of a multiplicity of users of the infrastructure.

132. The infrastructure of claim 131, wherein a different set of service requests is available to each of the multiplicity of users of the infrastructure.

133. The infrastructure of claim 131, wherein the set of service requests available to each of the multiplicity of users is presented to each of multiplicity of users as web-published services.

134. The infrastructure of claim 111, further comprising a means for indexing services.

135. The infrastructure of claim 111, wherein one of the plurality of components comprises a means for indexing services.

136. The infrastructure of claim 111, further comprising a logical appserver layer comprising a means for indexing services.

137. The infrastructure of claim 134, 135, or 136, wherein
the set of infrastructure-component interactions comprises a legacy-system function call required to execute each service request pertaining to the selected customer, and
the means for indexing services stores information related to the legacy-system function call.

138. The infrastructure of claim 137, wherein the means for indexing services stores information, associated with the legacy-system function call, related to an address.

139. The infrastructure of claim 137, wherein the means for indexing services stores information, associated with the legacy-system function call, related to an input parameter for the legacy-system function call.

140. The infrastructure of claim 139, wherein the means for indexing services stores information related to a data format for the input parameter.

141. The infrastructure of claim 137, wherein the means for indexing services stores information, associated with the legacy-system function call, related to an output parameter of the legacy-system function call.

142. The infrastructure of claim 141, wherein the means for indexing services stores information related to a data format for the output parameter.

143. The infrastructure of claim 111, further comprising means for determining a workflow instance.

144. The infrastructure of claim 111, wherein one of the plurality components comprises means for determining a workflow instance.

145. The infrastructure of claim 111, further comprising a logical appserver layer comprising means for determining a workflow instance.

146. The infrastructure of claim 143, 144 or 145, wherein
the set of infrastructure-component interactions comprises a legacy-system function call required to execute each service request pertaining to the selected customer, and
the means for determining a workflow instance orchestrates execution of the legacy-system function call.

147. The infrastructure of claim 143, 144 or 145, wherein the means for determining a workflow instance, in combination with the customer information set corresponding to the selected customer, determines the set of infrastructure-component interactions.

148. The infrastructure of claim 146, wherein
the set of infrastructure-component interactions comprises a plurality of legacy-system function calls required to execute each service request pertaining to the selected customer, and
the means for determining a workflow instance orchestrates execution of the plurality of legacy-system function calls.

149. The infrastructure of claim 147, wherein the set of infrastructure component-interactions comprises a plurality of legacy-system function calls.

150. The infrastructure of claim 111, further comprising means for monitoring interactions.

151. The infrastructure of claim 111, wherein one of the plurality of components comprises means for monitoring interactions.

152. The infrastructure of claim 111, further comprising a logical appserver layer comprising means for monitoring interactions.

153. The infrastructure of claim 150, 151 or 152, wherein the means for monitoring interactions monitors execution of at least one infrastructure-component interaction of the set of infrastructure-component interactions.

154. The infrastructure of claim 150, 151 or 152, wherein the means for monitoring interactions monitors execution of each of the infrastructure-component interactions of the set of infrastructure-component interactions.

155. The infrastructure of claim 150, 151 or 152, wherein the set of infrastructure-component interactions requires execution of a logical legacy-system-layer interaction, and means for monitoring interactions monitors performance of the logical legacy-system-layer interaction.

156. The infrastructure of claim 150, 151 or 152, wherein
the set of infrastructure-component interactions comprises a sequence of transactions,
the means for monitoring interactions monitors execution of each of the sequence of transactions, and
responsive to a failure of one of the set infrastructure-component interactions, the interaction-monitor service directs a reversal of each of the sequence of transactions executed prior to the failure.

157. The infrastructure of claim 156, wherein the sequence of infrastructure-component interactions comprises a sequence of logical legacy-system-layer interactions.

158. The infrastructure of claim 111, further comprising means for interaction-execution management.

159. The infrastructure of claim 111, wherein one of the components of the infrastructure comprises means for interaction-execution management.

160. The infrastructure of claim 111, further comprising a logical appserver layer comprising a means for interaction-execution management.

161. The infrastructure of claim 158, 159, or 160, wherein the means for interaction execution management directs execution of at least one infrastructure-component interaction of the set of infrastructure-component interactions.

162. The infrastructure of claim 158, 159, or 160, wherein
the set of infrastructure-component interactions requires execution of a logical legacy-system-layer interaction, and
the means for interaction-execution management directs execution of the logical legacy-system-layer interaction.

163. The infrastructure of claim 158, 159, or 160, wherein
the set of infrastructure-component interactions requires execution of a plurality of logical legacy-system-layer interactions, and
the means for interaction-execution management directs execution of each of the plurality of logical legacy-system-layer interactions.

164. The infrastructure of claim 160, wherein
the logical appserver layer is configured to control execution of a plurality of logical legacy-system-layer interactions, and
the means for interaction-execution management is configured to manage, responsive to workload levels in the logical appserver layer, processing of the plurality of logical legacy-system-layer interactions.

165. A customer information management infrastructure, comprising
means for storing a multiplicity of customer information sets, each customer information set corresponding to one customer of a multiplicity of customers;
a plurality of legacy systems;
a plurality of interface means for interfacing with the infrastructure; and
means for determining a workflow instance, configured to
receive a multiplicity of substantially simultaneous service requests, each service request made using one of the plurality of interface means and each pertaining to a selected customer of the multiplicity of customers, and
create a distinct workflow instance responsive to each of the multiplicity of service requests, each distinct workflow instance based on the customer information set corresponding to the selected customer and comprising a sequence of interactions, at least one interaction in the sequence of interactions comprising a call to execute a function on one of the plurality of legacy systems.

166. The infrastructure of claim 165, wherein the means for storing a multiplicity of customer information sets is configured as one of the plurality of legacy systems of the infrastructure.

167. The infrastructure of claim 165, further comprising a logical appserver layer comprising the means for determining the workflow instance.

168. The infrastructure of claim 165, further comprising:
means for monitoring interactions configured
to monitor execution of the sequence of interactions wherein the sequence of interactions comprises at least one transaction, and
responsive to a failure of execution of one interaction of the sequence, to direct, in the absence of a predetermined exception condition, a reversal of each transaction of the sequence of interactions executed prior to the failure.

169. The infrastructure of claim 168, further comprising a logical appserver layer comprising the means for monitoring interactions.

170. The infrastructure of claim 168, further comprising:
means for indexing services configured to provide calling instructions for each interaction of the sequence of interactions.

171. The infrastructure of claim 168, further comprising a logical appserver layer comprising a means for indexing services configured to provide calling instructions for each interaction of the sequence of interactions.

172. The infrastructure of claim 170 or 171, wherein the calling instructions comprise at least one of the following:
a name associated with the interaction;
an address associated with the interaction;
a description of a set of calling parameters associated with the interaction; and
a language syntax for invoking the interaction.

173. The infrastructure of claim 165, wherein the multiplicity of customer information sets comprises more than about 10,000 customer information sets, and the multiplicity of customers comprises more than about 10,000 customers.

174. The infrastructure of claim 165, wherein the multiplicity of customer information sets comprises more than about 100,000 customer information sets, and the multiplicity of customers comprises more than about 100,000 customers.

175. The infrastructure of claim 165, wherein the multiplicity of customer information sets comprises more than about 1,000,000 customer information sets, and the multiplicity of customers comprises more than about 1,000,000 customers.

176. The infrastructure of claim 165, wherein the multiplicity of customer information sets comprises more than about 10,000,000 customer information sets, and the multiplicity of customers comprises more than about 10,000,000 customers.

177. The infrastructure of claim 165, wherein the multiplicity of customer information sets comprises more than about 50,000,000 customer information sets, and the multiplicity of customers comprises more than about 50,000,000 customers.

178. The infrastructure of claim 165, wherein the multiplicity of substantially simultaneous service requests comprises more than about 10 requests per second.

179. The infrastructure of claim 165, wherein the multiplicity of substantially simultaneous service requests comprises more than about 100 requests per second.

180. The infrastructure of claim 165, wherein the multiplicity of substantially simultaneous service requests comprises more than about 500 requests per second.

181. The infrastructure of claim 165, further comprising a logical legacy-system layer comprising a plurality of computerized means for processing interactions, and wherein the means for storing a multiplicity of customer information sets comprises one of the plurality of computerized means for processing interaction of the logical legacy-system layer.

182. The infrastructure of claim 165, further comprising a means for authenticating users and authorizing each service request.

183. The infrastructure of claim 165, further comprising a logical device-server layer comprising a means for authenticating users and authorizing each service request.

184. The infrastructure of claim 182 or 183, wherein the means for authenticating users and authorizing each service request specifies a set of service requests available to the selected customer, responsive to the customer information set corresponding to the selected customer.

185. The infrastructure of claim 184, wherein presentation of the specified set of service requests is responsive to the one of the plurality of interface means used for the service request pertaining to the selected customer.

186. The infrastructure of claim 182 or 183, wherein the means for authenticating users and authorizing each service request specifies a set of service requests available to a user of the infrastructure responsive to a predetermined user role.

187. The infrastructure of claim 186, wherein the predetermined user role is selected by the user.

188. The infrastructure of claim 186, wherein the predetermined user role is selected by an administrator.

189. The infrastructure of claim 182 or 183, wherein the means for authenticating users and authorizing each service request specifies a set of service requests available to each of a multiplicity of users of the infrastructure.

190. The infrastructure of claim 189, wherein a different set of service requests is available to each of the multiplicity of users of the infrastructure.

191. The infrastructure of claim 189, wherein the set of service requests available to each of the multiplicity of users is presented to each of multiplicity of users as web-published services.

192. The infrastructure of claim 165, further comprising means for interaction execution management.

193. The infrastructure of claim 165, further comprising a logical appserver layer comprising means for interaction-execution management.

194. The infrastructure of claim 192 or 193, wherein the means for interaction-execution management directs execution of at least one interaction of the sequence of interactions.

195. The infrastructure of claim 192 or 193, wherein
the sequence of interactions requires execution of a logical legacy-system-layer interaction, and
the means for interaction-execution management directs execution of the logical legacy-system-layer interaction.

196. The infrastructure of claim 192 or 193, wherein
the sequence of interactions requires execution of a plurality of logical legacy-system-layer interactions, and
the means for interaction-execution management directs execution of each of the plurality of logical legacy-system-layer interactions.

197. The infrastructure of claim 193, wherein
the logical appserver layer controls execution of a plurality of logical legacy-system-layer interactions, and
the means for interaction-execution management manages, responsive to workload levels in the logical appserver layer, processing of the plurality of logical legacy-system-layer interactions.

198. A customer information management infrastructure comprising a plurality of components comprising:
means, configured as one of a plurality of legacy systems of the infrastructure, for storing a multiplicity of customer information sets, each customer information set corresponding to one of a multiplicity of customers;
means for authenticating users and authorizing service requests;
means for indexing services;
means for determining a workflow instance;
means for managing interactions; and
means for monitoring the execution of interactions;
wherein, responsive to each of a multiplicity of substantially simultaneous sessions, each session initiated by a user and pertaining to a selected customer of the multiplicity of customers,
the means for authenticating users and authorizing service requests specifies, for the user, a set of service requests pertaining to the selected customer;
the means for determining a workflow instance determines, in combination with each of the set of service requests and the customer information set corresponding to the selected customer,
a set of user-device interactions between the user and the infrastructure, and
a set of infrastructure-component interactions among the plurality of components of the infrastructure required to execute each of the set of service requests;
the means for determining a workflow instance orchestrates each legacy-system function call included in the set of infrastructure-component interactions;
the means for indexing services stores information required to execute each legacy-system function call included in the set of infrastructure-component interactions;
the means for managing interactions directs execution of at least one infrastructure-component interaction of the set of infrastructure-component interactions; and
the means for monitoring interactions monitors execution of each infrastructure-component interaction of the set of infrastructure-component interactions and, responsive to the presence of a transaction in the set of infrastructure component interactions and a failure of one infrastructure-component interactions of the set of infrastructure-component interactions, directs a reversal of each transaction of the set of infrastructure-component interactions executed prior to the failure.

199. In a customer information management infrastructure comprising a plurality of logical-legacy-system-layer services and an integrated customer information store comprising a multiplicity of customer information sets, each customer information set corresponding to one of a multiplicity of customers, a system for processing a service request, comprising:
means for receiving a user-identifier from a user;
means for generating, based on the user-identifier, a set of available service requests for the user;
means for displaying the set of available service requests to the user;
means for accepting from the user a selected service request from the set of available service requests, the selected service request pertaining to a selected customer of the multiplicity of customers;
means for determining, based on the selected service request and the customer information set corresponding to the selected customer, a distinctive workflow instance comprising a sequence of interactions, at least one interaction in the sequence of interactions comprising a call to one of the plurality of logical-legacy-system-layer services to execute a function; and
means for executing each interaction in the sequence of interactions.

200. The system of claim 199, wherein the set of available services requests is displayed to the user according to a set of personal display preferences for the user.

201. The system of claim 200, wherein the set of personal display preferences for the user is determined by reference to the user-identifier.

202. The system of claim 199, further comprising a means for monitoring execution of each interaction of the sequence of interactions in the distinctive workflow instance.

203. The system of claim 202, further comprising a means for directing a reversal of all previously-executed interactions if one of the interactions in the sequence of interactions fails to execute in the absence of a predefined exception condition.

204. The system of claim 199, further comprising a means for indexing services, wherein the means for indexing services specifies information required to make the call to execute the function.

205. The system of claim 204, wherein the information specified by the means for indexing services comprises an address for making the call to execute the function.

206. The system of claim 204, wherein the information specified by the means for indexing services comprises an input parameter for making the call to execute the function.

207. The system of claim 206, wherein the information specified by the means for indexing services comprises a data format for the input parameter for making to make the call to execute the function.

208. The system of claim 204, wherein the information specified by the means for indexing services comprises an output parameter for making the call to execute the function.

209. The system of claim 208, wherein the information specified by the means for indexing services includes a data format for the output parameter for making the call to execute the function.

210. The system of claim 199, wherein the multiplicity of customer information sets comprises more than about 10,000 customer information sets, and the multiplicity of customers comprises more than about 10,000 customers.

211. The system of claim 199, wherein the multiplicity of customer information sets comprises more than about 100,000 customer information sets, and the multiplicity of customers comprises more than about 100,000 customers.

212. The system of claim 199, wherein the multiplicity of customer information sets comprises more than about 1,000,000 customer information sets, and the multiplicity of customers comprises more than about 1,000,000 customers.

213. The system of claim 199, wherein the multiplicity of customer information sets comprises more than about 10,000,000 customer information sets, and the multiplicity of customers comprises more than about 10,000,000 customers.

214. The system of claim 199, wherein the multiplicity of customer information sets comprises more than about 50,000,000 customer information sets, and the multiplicity of customers comprises more than about 50,000,000 customers.

215. The system of claim 199, wherein means for displaying the set of available service requests is responsive to a channel of the infrastructure used to receive the user-identifier.

216. The system of claim 199, wherein the means for generating the set of available service requests is responsive to a predetermined user role.

217. The system of claim 216, wherein the predetermined user role is selected by the user.

218. The system of claim 216, wherein the predetermined user role is selected by an administrator.

219. The system of claim 199, further comprising system management service means for directing execution of at least one interaction of the sequence of interactions.

220. The system of claim 219, wherein the system management service means is responsive to workload levels in a logical appserver layer of the infrastructure.

221. An article of manufacture comprising an information storage medium encoded with machine-readable information adapted to display a set of service requests pertaining to a selected customer and available to a user of a customer information management infrastructure, the customer information management infrastructure comprising:
a customer information store storing a multiplicity of customer information sets, each customer information set corresponding to one of a multiplicity of customers;
a plurality of legacy systems;
an authentication and authorization entitlement service configured to determine, based on the customer information set corresponding to the selected customer, the set of service requests available to the user; and
a business-workflow service configured to determine, based on each service request of the set of service requests and the customer information set corresponding to the selected customer, a distinct workflow instance comprising a sequence of interactions, at least one of the interactions in the sequence comprising a call to execute a function on one of the plurality of legacy systems.

222. The article of manufacture of claim 221, wherein the customer information store is configured as a legacy system of the infrastructure.

223. The article of manufacture of claim 221, wherein the multiplicity of customer information sets comprises more than about 10,000 customer information sets, and the multiplicity of customers comprises more than about 10,000 customers.

224. The article of manufacture of claim 221, wherein the multiplicity of customer information sets comprises more than about 100,000 customer information sets, and the multiplicity of customers comprises more than about 100,000 customers.

225. The article of manufacture of claim 221, wherein the multiplicity of customer information sets comprises more than about 1,000,000 customer information sets, and the multiplicity of customers comprises more than about 1,000,000 customers.

226. The article of manufacture of claim 221, wherein the multiplicity of customer information sets comprises more than about 10,000,000 customer information sets, and the multiplicity of customers comprises more than about 10,000,000 customers.

227. The article of manufacture of claim 221, wherein the multiplicity of customer information sets comprises more than about 50,000,000 customer information sets, and the multiplicity of customers comprises more than about 50,000,000 customers.

228. The article of manufacture of claim 221, wherein the customer information store comprises one of a plurality of legacy systems in a logical legacy-system layer of the infrastructure.

229. The article of manufacture of claim 221, wherein the machine-readable information encoded in the storage medium is responsive to an interface channel of the infrastructure used to display the set of service requests.

230. The article of manufacture of claim 221, wherein the authentication-and-authorization-entitlement service determines the set of service requests available to the user responsive to a predetermined user role.

231. The article of manufacture of claim 230, wherein the predetermined user role is selected by the user.

232. The article of manufacture of claim 230, wherein the predetermined user role is selected by an administrator.

233. The article of manufacture of claim 230, wherein the authentication-and-authorization-entitlement service specifies a set of service requests available to each of a multiplicity of users of the infrastructure.

234. The article of manufacture of claim 230, wherein a different set of service requests is available to each of a multiplicity of users of the infrastructure.

235. The article of manufacture of claim 234, wherein the set of service requests available to each of the multiplicity of users is displayed to each of the multiplicity of users as web-published services.

236. The article of manufacture of claim 221, wherein the customer information management infrastructure further comprises a services index.

237. The article of manufacture of claim 221, wherein the customer information management infrastructure comprises a logical appserver layer comprising a services index.

238. The article of manufacture of claim 236 or 237, wherein the services index stores information related to the call to execute the function on one of the plurality of legacy systems.

239. The article of manufacture of claim 238, wherein the services index stores address information associated with the call to execute the function on one of the plurality of legacy systems.

240. The article of manufacture of claim 238, wherein the services index stores input-parameter information associated with the call to execute the function on one of the plurality of legacy systems.

241. The article of manufacture of claim 238, wherein the services index stores output-parameter information associated with the call to execute the function on one of the plurality of legacy systems.

242. The article of manufacture of claim 238, wherein the services index stores address information associated with the call to execute the function on one of the plurality of legacy systems.

243. The article of manufacture of claim 238, wherein the services index stores data-format information associated with the call to execute the function on one of the plurality of legacy systems.

244. The article of manufacture of claim 221, wherein the business-workflow service is located in a logical app server layer for the infrastructure.

245. The article of manufacture of claim 221, wherein the customer information management infrastructure further comprises an interaction-monitor service.

246. The article of manufacture of claim 221, wherein the interaction-monitor service is located in a logical appserver layer for the infrastructure.

247. The article of manufacture of claim 244, 245, or 246, wherein the interaction-monitor service monitors execution of at least one interaction in the sequence of interactions.

248. The article of manufacture of claim 244, 245 or 246, wherein
the interaction-monitor service monitors execution of each interaction in the sequence of interactions, and
responsive to the presence of a transaction in the sequence of interactions and a failure of one of the interactions in the sequence, the interaction-monitor service directs a reversal of each transaction in the sequence executed prior to the failure.

249. The article of manufacture of claim 248, wherein the sequence of interactions comprises a sequence of logical legacy-system-layer interactions.

250. The article of manufacture of claim 221, wherein the customer information management system further comprises a system-management service.

251. The article of manufacture of claim 221, wherein the system-management service is located in a logical appserver layer of the infrastructure.

252. The article of manufacture of claim 221, wherein the system-management service directs execution of at least one interaction of the sequence of interactions.

253. The article of manufacture of claim 250, 251 or 252, wherein
the sequence of interactions requires execution of a logical legacy-system-layer interaction, and
the system-management service directs execution of the logical legacy-system-layer interaction.

254. The article of manufacture of claim 250, 251 or 252, wherein
the sequence of interactions requires execution of a plurality of logical legacy-system-layer interactions, and
the system management service directs execution of each of the plurality of logical legacy-system-layer interactions.

255. The article of manufacture of claim 251, wherein
the logical appserver layer is configured to control execution of a plurality of logical legacy-system-layer interactions, and
the system management service is configured to manage, responsive to workload levels in the logical appserver layer, processing of the plurality of logical legacy-system-layer interactions.

256. The article of manufacture of claim 221, wherein the user is the selected customer.

257. A propagated signal adapted for communication between one of a plurality of user-devices and a customer information management infrastructure, the customer information management infrastructure comprising:
an integrated customer information store comprising a multiplicity of customer information sets, each customer information set corresponding to one customer of a multiplicity of customers;
wherein, responsive to each of a multiplicity of substantially simultaneous service requests, each service request pertaining to a selected customer of the multiplicity of customers, the customer information set corresponding to the selected customer determines, for each of the plurality user-devices,
a set of user-device interactions between a user and the infrastructure, and
a set of infrastructure-component interactions among a plurality of components of the infrastructure.

258. The propagated signal of claim 257, wherein the integrated customer information store is configured as a legacy system of the infrastructure.

259. The propagated signal of claim 257, wherein the multiplicity of customer information sets comprises more than about 10,000 customer information sets, and the multiplicity of customers comprises more than about 10,000 customers.

260. The propagated signal of claim 257, wherein the multiplicity of customer information sets comprises more than about 100,000 customer information sets, and the multiplicity of customers comprises more than about 100,000 customers.

261. The propagated signal of claim 257, wherein the multiplicity of customer information sets comprises more than about 1,000,000 customer information sets, and the multiplicity of customers comprises more than about 1,000,000 customers.

262. The propagated signal of claim 257, wherein the multiplicity of customer information sets comprises more than about 10,000,000 customer information sets, and the multiplicity of customers comprises more than about 10,000,000 customers.

263. The propagated signal of claim 257, wherein the multiplicity of customer information sets comprises more than about 50,000,000 customer information sets, and the multiplicity of customers comprises more than about 50,000,000 customers.

264. The propagated signal of claim 257, wherein the multiplicity of substantially simultaneous service requests comprises more than about 10 service requests per second.

265. The propagated signal of claim 257, wherein the multiplicity of substantially simultaneous service requests comprises more than about 100 service requests per second.

266. The propagated signal of claim 257, wherein the multiplicity of substantially simultaneous service requests comprises more than about 500 service requests per second.

267. The propagated signal of claim 257, wherein the integrated customer information store comprises one of a plurality of legacy systems in a logical legacy-system layer of the infrastructure.

268. The propagated signal of claim 257, wherein the plurality of components comprises a plurality of legacy systems, including the integrated customer information store, in a logical legacy-system layer of the infrastructure.

269. The propagated signal of claim 257, wherein the plurality of components comprises an authentication-and-authorization-entitlement service.

270. The propagated signal of claim 257, wherein the customer information management infrastructure further comprises a logical device-server layer comprising an authentication-and-authorization-entitlement service.

271. The propagated signal of claim 269 or 270, wherein the authentication-and-authorization-entitlement service specifies a set of service requests available to the user.

272. The propagated signal of claim 271, wherein the set of service requests available to the user, in combination with the customer information set corresponding to the selected customer, determines the set of user-device interactions and the set of infrastructure-component interactions.

273. The propagated signal of claim 271, wherein presentation of the specified set of service requests is responsive to the user-device.

274. The propagated signal of claim 269 or 270, wherein the authentication-and-authorization-entitlement service specifies a set of service requests available to the user responsive to a predetermined user role.

275. The propagated signal of claim 274, wherein the predetermined user role is selected by the user.

276. The propagated signal of claim 274, wherein the predetermined user role is selected by an administrator.

277. The propagated signal of claim 274, wherein the authentication-and-authorization-entitlement service specifies a set of service requests available to each of a multiplicity of users of the infrastructure.

278. The propagated signal of claim 274, wherein a different set of service requests is available to each of the multiplicity of users of the infrastructure.

279. The propagated signal of claim 274, wherein the set of service requests available to each of the multiplicity of users is presented to each of the multiplicity of users as web-published services.

280. The propagated signal of claim 257, wherein the customer information management infrastructure further comprises a services index.

281. The propagated signal of claim 257, wherein one of the plurality of components comprises a services index.

282. The propagated signal of claim 257, wherein the customer information management infrastructure further comprises a logical appserver layer comprising a services index.

283. The propagated signal of claim 280, 281 or 282, wherein the set of infrastructure-component interactions comprises a legacy-system function call required to execute each service request pertaining to the selected customer, and the services index stores information for making the call to execute the function on one of the plurality of the legacy-system.

284. The propagated signal of claim 283, wherein the services index stores address information associated with the call to execute the function on one of the plurality of legacy systems.

285. The propagated signal of claim 283, wherein the services index stores input-parameter information associated with the call to execute the function on one of the plurality of legacy systems.

286. The propagated signal of claim 285, wherein the services index stores information related to a data format for the input-parameter.

287. The propagated signal of claim 283, wherein the services index stores output-format information associated with the call to execute the function on one of the plurality of legacy systems.

288. The propagated signal of claim 287, wherein the services index stores information related to a data format for the output-parameter.

289. The propagated signal of claim 257, further comprising a business-workflow service.

290. The propagated signal of claim 257, wherein one of the plurality components comprises a business-workflow service.

291. The propagated signal of claim 257, wherein the customer information management infrastructure further comprises a logical appserver layer comprising a business-workflow service.

292. The propagated signal of claim 289, 290 or 291, wherein the set of infrastructure-component interactions comprises a legacy-system function call required to execute each service request pertaining to the selected customer, and the business-workflow service orchestrates execution of the legacy-system function call.

293. The propagated signal of claim 289, 290 or 291, wherein the business-workflow service, in combination with the customer information set corresponding to the selected customer, determines the set of infrastructure-component interactions.

294. The propagated signal of claim 292, wherein the set of infrastructure-component interactions comprises a plurality of legacy-system function calls required to execute each service request pertaining to the selected customer, and the business-workflow service orchestrates execution of the plurality of legacy-system function calls.

295. The propagated signal of claim 293, wherein the set of infrastructure component-interactions comprises a plurality of legacy-system function calls.

296. The propagated signal of claim 257, wherein the customer information management infrastructure further comprises an interaction-monitor service.

297. The propagated signal of claim 257, wherein one of the plurality of components comprises an interaction-monitor service.

298. The propagated signal of claim 257, further comprising a logical appserver layer comprising an interaction-monitor service.

299. The propagated signal of claim 296, 297 or 298, wherein the interaction-monitor service monitors execution of at least one infrastructure-component interaction of the set of infrastructure-component interactions.

300. The propagated signal of claim 296, 297 or 298, wherein the interaction-monitor service monitors execution of each of the infrastructure-component interactions of the set of infrastructure-component interactions.

301. The propagated signal of claim 296, 297 or 298, wherein the set of infrastructure-component interactions requires execution of a logical legacy-system-layer interaction, and the interaction monitor service monitors performance of the logical legacy-system-layer interaction.

302. The propagated signal of claim 296, 297 or 298, wherein the set of infrastructure-component interactions comprises a sequence of infrastructure-component interactions, the interaction-monitor service monitors execution of each of the sequence of infrastructure-component interactions, and responsive to the presence of a transaction in the sequence of infrastructure-component interactions and a failure of one of the sequence of infrastructure-component interactions, the interaction-monitor service directs a reversal of each transaction executed prior to the failure.

303. The propagated signal of claim 302, wherein the sequence of infrastructure-component interactions comprises a sequence of logical legacy-system-layer interactions.

304. The propagated signal of claim 257, wherein the customer information management infrastructure further comprises a system-management service.

305. The propagated signal of claim 257, wherein one of the plurality of components of the infrastructure comprises a system-management service.

306. The propagated signal of claim 257, wherein the customer information management infrastructure further comprises a logical appserver layer comprising a system-management service.

307. The propagated signal of claim 304, 305 or 306, wherein the system-management service directs execution of at least one infrastructure-component interaction of the set of infrastructure-component interactions.

308. The propagated signal of claim 304, 305 or 306, wherein the set of infrastructure-component interactions requires execution of a logical legacy-system-layer interaction, and the system management service directs execution of the logical legacy-system-layer interaction.

309. The propagated signal of claim 304, 305 or 306, wherein the set of infrastructure-component interactions requires execution of a plurality of logical legacy-system-layer interactions, and the system management service directs execution of each of the plurality of logical legacy-system-layer interactions.

310. The propagated signal of claim 306, wherein the logical appserver layer is configured to control execution of a plurality of logical legacy-system-layer interactions, and the system-management service is configured to manage, responsive to workload levels in the logical appserver layer, processing of the plurality of logical legacy-system-layer interactions.

311. An article of manufacture comprising a propagated signal adapted for communication between a user-device and a customer information management infrastructure, wherein the customer information management infrastructure:
receives a user-identifier from the user-device;
retrieves from an integrated customer information store storing a multiplicity of customer information sets, each customer information set corresponding to one of a multiplicity of customers, the customer information set corresponding to a selected customer;
generates, based on the user-identifier and the customer information set corresponding to the selected customer, a set of available service requests;
transmits to the user-device the set of available service requests;
receives the signal from the user-device, wherein the signal is encoded with machine-readable information identifying a selected service request selected from the set of available service requests;
determines, based on the signal and the customer information set corresponding to the selected customer, a distinctive workflow instance comprising a sequence of interactions, at least one interaction in the sequence comprising a call to execute a function on one of a plurality of legacy systems; and
executes each interaction in the sequence.

312. The article of manufacture of claim 311, wherein the user-identifier identifies the selected customer.

313. The article of manufacture of claim 311, wherein the integrated customer information store is configured as a legacy system of the infrastructure.

314. The article of manufacture of claim 311, wherein the multiplicity of customer information sets comprises more than about 10,000 customer information sets, and the multiplicity of customers comprises more than about 10,000 customers.

315. The article of manufacture of claim 311, wherein the multiplicity of customer information sets comprises more than about 100,000 customer information sets, and the multiplicity of customers comprises more than about 100,000 customers.

316. The article of manufacture of claim 311, wherein the multiplicity of customer information sets comprises more than about 1,000,000 customer information sets, and the multiplicity of customers comprises more than about 1,000,000 customers.

317. The article of manufacture of claim 311, wherein the multiplicity of customer information sets comprises more than about 10,000,000 customer information sets, and the multiplicity of customers comprises more than about 10,000,000 customers.

318. The article of manufacture of claim 311, wherein the multiplicity of customer information sets comprises more than about 50,000,000 customer information sets, and the multiplicity of customers comprises more than about 50,000,000 customers.

319. The article of manufacture of claim 311, wherein the customer information management infrastructure receives a multiplicity of substantially simultaneous service requests.

320. The article of manufacture of claim 319, wherein the multiplicity of substantially simultaneous service requests comprises more than about 10 service requests per second.

321. The article of manufacture of claim 319, wherein the multiplicity of substantially simultaneous service requests comprises more than about 100 service requests per second.

322. The article of manufacture of claim 319, wherein the multiplicity of substantially simultaneous service requests comprises more than about 500 service requests per second.

323. The article of manufacture of claim 311, wherein the integrated customer information store comprises one of a plurality of legacy systems in a logical legacy-system layer of the infrastructure.

324. The article of manufacture of claim 311, wherein the plurality of components comprises a plurality of legacy systems, including the integrated customer information store, in a logical legacy-system layer of the infrastructure.

325. The article of manufacture of claim 311, wherein the plurality of components comprises an authentication-and-authorization-entitlement service.

326. The article of manufacture of claim 311, wherein the customer information management infrastructure further comprises a logical device-server layer comprising an authentication-and-authorization-entitlement service.

327. The article of manufacture of claim 325 or 326, wherein the authentication-and-authorization-entitlement service specifies the set of available service requests.

328. The article of manufacture of claim 327, wherein the set of available service requests, in combination with the customer information set corresponding to the selected customer, determines the set of user-device interactions and the set of infrastructure-component interactions.

329. The article of manufacture of claim 327, wherein transmission of the specified set of available service requests is responsive to the one channel of the infrastructure used for making each service request pertaining to the selected customer.

330. The article of manufacture of claim 325 or 326, wherein the authentication-and-authorization-entitlement service specifies the set of available service requests responsive to a predetermined user role.

331. The article of manufacture of claim 330, wherein the predetermined user role is selected by the user.

332. The article of manufacture of claim 330, wherein the predetermined user role is selected by an administrator.

334. The article of manufacture of claim 330, wherein the authentication-and-authorization-entitlement service specifies a set of service requests available to each of a multiplicity of users of the infrastructure.

335. The article of manufacture of claim 334, wherein a different set of service requests is available to each of the multiplicity of users of the infrastructure.

336. The article of manufacture of claim 334, wherein the set of service requests available to each of the multiplicity of users is presented to each of the multiplicity of users as web-published services.

337. The article of manufacture of claim 311, wherein the customer information management infrastructure further comprises a services index.

338. The article of manufacture of claim 311, wherein the customer information management infrastructure further comprises a logical appserver layer comprising a services index.

339. The article of manufacture of claim 337 or 338, wherein the set of infrastructure-component interactions comprises a legacy-system function call required to execute each service request pertaining to the selected customer, and the services index stores information to make the call to execute the function on the legacy-system.

340. The article of manufacture of claim 339, wherein the services index stores address information associated with the call to execute the function on one of the plurality or legacy systems.

341. The article of manufacture of claim 339, wherein the services index stores input parameter information associated with the call to execute the function on one of the plurality of legacy systems.

342. The article of manufacture of claim 341, wherein the services index stores information related to a data format for the input parameter.

343. The article of manufacture of claim 339, wherein the services index stores output parameter information associated with the call to execute the function on one of the plurality of legacy systems.

344. The article of manufacture of claim 343, wherein the services index stores information related to a data format for the output parameter.

345. The article of manufacture of claim 311, further comprising a business-workflow service.

346. The article of manufacture of claim 311, wherein the customer information management infrastructure further comprises a logical appserver layer comprising a business-workflow service.

347. The article of manufacture of claim 345 or 346, wherein the set of infrastructure-component interactions comprises a legacy-system function call required to execute each service request pertaining to the selected customer, and the business-workflow service orchestrates execution of the legacy-system function call.

348. The article of manufacture of claim 345 or 346, wherein the business-workflow service, in combination with the customer information set corresponding to the selected customer, determines the distinctive workflow instance.

349. The article of manufacture of claim 347, wherein the sequence of interactions comprises a plurality of legacy-system function calls required to execute each service request pertaining to the selected customer, and the business-workflow service orchestrates execution of the plurality of legacy-system function calls.

350. The article of manufacture of claim 348, wherein the sequence of interactions comprises a plurality of legacy-system function calls.

351. The article of manufacture of claim 311, wherein the customer information management infrastructure further comprises an interaction-monitor service.

352. The article of manufacture of claim 311, further comprising a logical appserver layer comprising an interaction-monitor service.

353. The article of manufacture of claim 351 or 352, wherein the interaction-monitor service monitors execution of at least one interaction in the sequence of interactions.

354. The article of manufacture of claim 351 or 352, wherein the interaction-monitor service monitors execution of each of the interactions.

355. The article of manufacture of claim 351 or 352, wherein the sequence of interactions requires execution of a logical legacy-system-layer interaction, and the interaction monitor service monitors performance of the logical legacy-system-layer interaction.

356. The article of manufacture of claim 351 or 352, wherein the set of infrastructure-component interactions comprises a sequence of infrastructure-component interactions, the interaction-monitor service monitors execution of each of the sequence of infrastructure-component interactions, and responsive to the presence of a transaction in the sequence of infrastructure-component interactions and a failure of one of the sequence of infrastructure-component interactions, the interaction-monitor service directs a reversal of each transaction of the sequence of infrastructure-component interactions executed prior to the failure.

357. The article of manufacture of claim 356, wherein the sequence of infrastructure-component interactions comprises a sequence of logical legacy-system-layer interactions.

358. The article of manufacture of claim 311, wherein the customer information management infrastructure further comprises a system-management service.

359. The article of manufacture of claim 311, wherein the customer information management infrastructure further comprises a logical appserver layer comprising a system-management service.

360. The article of manufacture of claim 358 or 359, wherein the-system management service directs execution of at least one interaction of the sequence of interactions.

361. The article of manufacture of claim 358 or 359, wherein the sequence of interactions requires execution of a logical legacy-system-layer interaction, and the system management service directs execution of the logical legacy-system-layer interaction.

362. The article of manufacture of claim 358 or 359, wherein the set of infrastructure-component interactions requires execution of a plurality of logical legacy-system-layer interactions, and the system management service directs execution of each of the plurality of logical legacy-system-layer interactions.

363. The article of manufacture of claim 359, wherein the logical appserver layer is configured to control execution of a plurality of logical legacy-system-layer interactions, and the system management service is configured to manage, responsive to workload levels in the logical appserver layer, processing of the plurality of logical legacy-system-layer interactions.

364. A customer information management system, comprising:
a plurality of on-line customer information processing systems, including an integrated customer information store storing a multiplicity of customer information sets, each customer information set corresponding to one customer of a multiplicity of customers;
a plurality of device-servers configured to receive, substantially simultaneously, a multiplicity of service requests from a plurality of user-devices coupled to the customer information management system, each service request pertaining to one or more selected customers of the multiplicity of customers; and
an application-server configured to determine, based on the stored customer information set corresponding to each of the one or more selected customers, a distinct workflow instance for each of the multiplicity of service requests, each distinct work flow instance comprising a sequence of interactions, at least one interaction in the sequence of interactions comprising a call to execute a function on one of the plurality of on-line customer information processing systems.

365. The customer information management system of claim 364, wherein the integrated customer information store is configured as a legacy system of the infrastructure.

366. The customer information management system of claim 364, wherein the multiplicity of customer information sets comprises more than about 10,000 customer information sets, and the multiplicity of customers comprises more than about 10,000 customers.

367. The customer information management system of claim 364, wherein the multiplicity of customer information sets comprises more than about 100,000 customer information sets, and the multiplicity of customers comprises more than about 100,000 customers.

368. The customer information management system of claim 364, wherein the multiplicity of customer information sets comprises more than about 1,000,000 customer information sets, and the multiplicity of customers comprises more than about 1,000,000 customers.

369. The customer information management system of claim 364, wherein the multiplicity of customer information sets comprises more than about 10,000,000 customer information sets, and the multiplicity of customers comprises more than about 10,000,000 customers.

370. The customer information management system of claim 364, wherein the multiplicity of customer information sets comprises more than about 50,000,000 customer information sets, and the multiplicity of customers comprises more than about 50,000,000 customers.

371. The customer information management system of claim 364, wherein the multiplicity of substantially simultaneous service requests comprises more than about 10 service requests per second.

372. The customer information management system of claim 364, wherein the multiplicity of substantially simultaneous service requests comprises more than about 100 service requests per second.

373. The customer information management system of claim 364, wherein the multiplicity of substantially simultaneous service requests comprises more than about 500 service requests per second.

374. The customer information management system of claim 364, wherein the integrated customer information store comprises one of a plurality of legacy systems in a logical legacy-system layer of the infrastructure.

375. The customer information management system of claim 364, wherein an authentication-and-authorization-entitlement service specifies a set of available service requests responsive to a predetermined user role.

376. The customer information management system of claim 375, wherein the predetermined user role is selected by the user.

377. The customer information management system of claim 375, wherein the predetermined user role is selected by an administrator.

378. The customer information management system of claim 375, wherein the authentication-and-authorization-entitlement service specifies a set of available service requests available to each of a multiplicity of users of the infrastructure.

379. The customer information management system of claim 378, wherein a different set of available service requests is available to each of the multiplicity of users of the infrastructure.

380. The customer information management system of claim 378, wherein the set of available service requests available to each of the multiplicity of users is presented to each of the multiplicity of users as web-published services.

381. The customer information management system of claim 364, further comprising a services index.

382. The customer information management system of claim 364, further comprising a logical appserver layer comprising a services index.

383. The customer information management system of claim 381 or 382, wherein the set of infrastructure-component interactions comprises a function call to one of the plurality of online customer information processing systems required to execute each service request pertaining to the selected customer, and the services index stores information to make the function call.

384. The customer information management system of claim 383, wherein the services index stores address information associated with the function call.

385. The customer information management system of claim 383, wherein the services index stores input-parameter information associated with the function call.

386. The customer information management system of claim 385, wherein the services index stores information related to a data format for the input-parameter information.

387. The customer information management system of claim 385, wherein the services index stores output-parameter information associated with the function call.

388. The customer information management system of claim 387, wherein the services index stores information related to a data format for the output-parameter information.

389. The customer information management system of claim 364, further comprising a business-workflow service.

390. The customer information management system of claim 389, wherein the business-workflow service orchestrates execution of the function on one of the plurality of on-line customer information processing systems.

391. The customer information management system of claim 364, further comprising an interaction-monitor service.

392. The customer information management system of claim 391, wherein the interaction-monitor service monitors execution of at least one interaction in the sequence of interactions.

393. The customer information management system of claim 391, wherein the interaction-monitor service monitors execution of each of the interactions.

394. The customer information management system of claim 364, wherein the interaction-monitor service monitors execution of each of the interactions in the sequence of interactions, and responsive to the presence of a transaction in the sequence of interactions and a failure of one of the interactions in the sequence of interactions, the interaction-monitor service directs a reversal of each transaction in the sequence executed prior to the failure.

395. The customer information management system of claim 364, further comprising a system-management service.

396. The customer information management system of claim 395, wherein the-system management service directs execution of at least one interaction of the sequence of interactions.

397. The customer information management system of claim 364, wherein the system management service is configured to manage, responsive to workload levels in a logical appserver layer, the execution of functions in the plurality of on-line information processing systems.

398. A customer information management system, comprising:
a message bus coupling each of a plurality of device-servers with
each of a plurality of on-line customer information processing systems, including an integrated customer information store storing a multiplicity of customer information sets, each customer information set corresponding to one customer of a multiplicity of customers, and
a business-workflow processor configured to
receive, via the message bus, a multiplicity of substantially simultaneous service requests, each service request transmitted using one of the device-servers and each service request pertaining to a selected customer of the multiplicity of customers, and
determine a distinct workflow instance for each of the multiplicity of service requests, each distinct workflow instance based on the stored customer information set corresponding to the selected customer and comprising a sequence of interactions, at least one interaction in the sequence of interactions comprising a call to execute a function on one of the plurality of on-line customer information processing systems.

399. The customer information management system of claim 398, wherein the integrated customer information store is configured as a legacy system of the infrastructure.

400. The customer information management system of claim 398, wherein the multiplicity of customer information sets comprises more than about 10,000 customer information sets, and the multiplicity of customers comprises more than about 10,000 customers.

401. The customer information management system of claim 398, wherein the multiplicity of customer information sets comprises more than about 100,000 customer information sets, and the multiplicity of customers comprises more than about 100,000 customers.

402. The customer information management system of claim 398, wherein the multiplicity of customer information sets comprises more than about 1,000,000 customer information sets, and the multiplicity of customers comprises more than about 1,000,000 customers.

403. The customer information management system of claim 398, wherein the multiplicity of customer information sets comprises more than about 10,000,000 customer information sets, and the multiplicity of customers comprises more than about 10,000,000 customers.

404. The customer information management system of claim 398, wherein the multiplicity of customer information sets comprises more than about 50,000,000 customer information sets, and the multiplicity of customers comprises more than about 50,000,000 customers.

405. The customer information management system of claim 398, wherein the multiplicity of substantially simultaneous service requests comprises more than about 10 service requests per second.

406. The customer information management system of claim 398, wherein the multiplicity of substantially simultaneous service requests comprises more than about 100 service requests per second.

407. The customer information management system of claim 398, wherein the multiplicity of substantially simultaneous service requests comprises more than about 500 service requests per second.
